(19) United States
(12) Patent Application Publication
(10) Pub. No.: US 2014/0136342 A1
(43) Pub. Date: May 15, 2014

(54) Systems and Methods for Buying Viewable Ad Space Based On Synchronized User Information

(71) Applicant: Zenovia Digital Exchange Corporation, Douglasville, GA (US)

(72) Inventor: Dwight Ringdahl, Douglasville, GA (US)

(73) Assignee: ZENOVIA DIGITAL EXCHANGE CORPORATION, Douglasville, GA (US)

(21) Appl. No.: 14/145,417

(22) Filed: Dec. 31, 2013

Related U.S. Application Data
(63) Continuation of application No. 14/058,179, filed on Oct. 18, 2013.

(51) Int. Cl. G06Q 30/02

(52) U.S. Cl. CPC G06Q 30/0275
USPC 705/14.71

(57) ABSTRACT

Systems and methods presented herein may utilize multiple databases spaced geographically around the world to collect user information, the databases being in communication with one another to synchronize user information. At least in part by matching the synchronized user information to a user characteristic in a bid request, an exchange system may programmatically decide whether to purchase ad space for reselling once it becomes in view on a user's screen. The exchange system may provide a self-monitoring ad tag that may be executed by the user computing device to assist in determining the viewability of the ad space. This may allow an exchange to log known viewable ad space and user information, and later purchase that ad space for resale a higher price based on the viewability and user information.

This is a continuation application of U.S. patent application Ser. No. 14/058,179, filed Oct. 18, 2013, which is expressly incorporated herein by reference.

### DESCRIPTION OF THE EMBODIMENTS

1. Field of the Embodiments

The embodiments relate generally to systems and methods for real-time viewable advertising, and, more specifically, to systems and methods that programmatically identify which ad space to purchase and resell as viewable based on synchronized user information.

2. Background

Real-time bidding (RTB) is a recent development in programmatically buying and selling advertisements online. Typically, buyers of the ad space use a Demand Side Platform (DSP), such as a trading desk, sellers of the ad space use a Supply Side Platform (SSP), and these platforms may interact with a third entity called an exchange. The exchange hosts an exchange server that supports real-time bidding (RTB). In some instances, the exchange may also subsume the role of the SSP and/or DSP.

As an example, a webpage may contain a hard-coded tag that causes the SSP to sell ad space as the webpage loads. To sell the ad space, the SSP may alert the exchange of the user and/or webpage where the advertisement space is available. The exchange server supporting real-time-bidding (RTB) then begins an auction with multiple Demand Side Platforms (DSPs) and even other exchanges to determine which advertiser gets to serve the ad. The exchange server may communicate attributes of the user to the DSPs, which in turn determine whether the user has the desired attributes that the advertiser wants to target. Based on the perceived value of this user, each DSP places a bid on the ad impression (based on the advertisers associated with that DSP). The highest bidding advertiser is determined by the exchange, at which point the ad placement is delivered to the user.

However, roughly 70% of purchased ads may never be viewed at all. This is because when a webpage loads, the ads purchased on that page may be “below the fold” (i.e., off the screen), which requires the user to scroll down to see the ads. Nevertheless, under current RTB practices, DSPs and advertisers often pay the same amount for an ad regardless of its location on the webpage.

Clearly, a viewable ad is worth much more to an advertiser than an ad that is not yet in view and may never actually come into view. But exchanges have previously been unable to provide the appropriate context to allow DSPs and advertisers to more accurately bid on ad space based on viewability.

Until now, this problem has not been adequately addressed. For example, previous attempts to monitor viewability have involved pre-programming a website with ad tags that communicate with a server that monitors viewability. The monitoring server determines what should be done when the tag is viewable. But this approach has significant shortcomings. For example, it requires manually contracting with individual websites (e.g., with a sales team) to pre-place the ad tag, which is inefficient given the number of websites in existence. And on the massive scale required for RTB ad auctions, which may involve billions of ad impressions per day, it is not practical for servers to monitor ad tags on individual webpages. The processing power and server overhead to actively monitor billions of ad tags via servers would be astronomical and expensive.

As one example of a system containing this deficiency, application Ser. No. 13/731,742 describes a tag that links to a server-side application that is used for collecting data and deciding what action to take regarding the tag: “When a viewer requests the designated content page, the tag is activated and links to the system server-side application.” [0007]. This tag also must be manually added to a page by a publisher ahead of time. See [0009]-[0010]. And if the user does not reveal the ad tag location, the ad space is never sold, which cuts into the profit margins of the website hosting the tag.

Therefore, a need exists for systems and methods for self-monitoring ad tags that may be placed dynamically, monitor their own viewability, and place their own ad calls for advertisements based on viewability status, including systems and methods that programmatically identify which ad space will become viewable and making the identified ad space available for purchase.

### SUMMARY

Embodiments described herein include systems and methods for ad tags that monitor their own viewability and solicit bids for advertisements based on viewability status. In one embodiment, a server (e.g., an exchange server) receives a request for a first bid on ad space being sold by an entity holding a first real-time auction (e.g., a programmatic SSP auction. The ad space that is for sale may be located within content, such as a webpage, being delivered over the Internet to a user computing device that is located remotely relative to the server.

Upon receiving the bid request, the server may hold its own real-time auction (i.e., a second auction) for determining a bid to place in the first (e.g., SSP) auction (which in turn determines who purchases the ad space). During the second real-time auction, a processor associated with the server may perform steps to solicit bids on the ad space from multiple demand-side entities.

But unlike a normal auction, the server may decide to place its own self-bid in the second real-time auction (i.e., bidding in its own auction). If the self-bid is the highest bid, the server will send the self-bid for entry into the first auction in attempt to purchase the ad space.

When the highest bid is the server's (e.g., processor's) self-bid (e.g., the exchange's own bid), instead of supplying an ordinary advertisement, the processor may then supply a self-monitoring ad tag for placement in the content. The self-monitoring ad tag may contain code that is executed by the user computing device. This code may cause the user computing device to locally monitor user activities and/or the position of the location of the self-monitoring ad tag relative to viewable screen space, and upon determining that the ad space should be sold, make a call to the server (or another server) to resell the ad space at an optimal time.

When the user computing device attempts to resell the ad space, the server may receive a second bid request for the ad space from the computing device based on the code of the self-monitoring ad tag. In response, the server may hold a viewable-only real-time auction or otherwise sell the ad space as part of a default waterfall, and provide an advertisement from a purchasing demand-side entity to the user computing device for placement at the ad space location within the content.

Alternatively, if the self-bid does not win the server's own auction (i.e., the second auction), the server may provide the highest bid from a demand-side entity for placement in the first auction. If that demand-side entity wins, then the server may facilitate placement of the winning demand-side entity's advertisement at the user computing device.

The code of the self-monitoring ad tag that is provided to the user computing device may further include instructions that cause the user computing device to automatically communicate the second bid request in response to any one of the following conditions being met: (1) a portion of the self-monitoring ad tag location is within a viewable portion of the application screen space; (2) a time threshold has been exceeded with the tag location still not in view; and (3) user activity dictates reselling the ad space.

Additionally, in one embodiment, the server (e.g., processor) may programmatically select the timing threshold used with the code of the self-monitoring ad tag from amongst a plurality of different timing threshold options for reselling the ad space. This may allow, for example, the server to provide a tag with a lower time threshold (e.g., time-out period triggering resale) to a webpage and/or user that do not have an established track record of reselling the ad space with higher timing thresholds.

It is to be understood that both the foregoing general description and the following detailed description are exemplary and explanatory only and are not restrictive of the embodiments, as claimed.

### BRIEF DESCRIPTION OF THE DRAWINGS

The accompanying drawings, which are incorporated in and constitute a part of this disclosure, illustrate various embodiments and aspects of the present invention. In the

### DRAWINGS

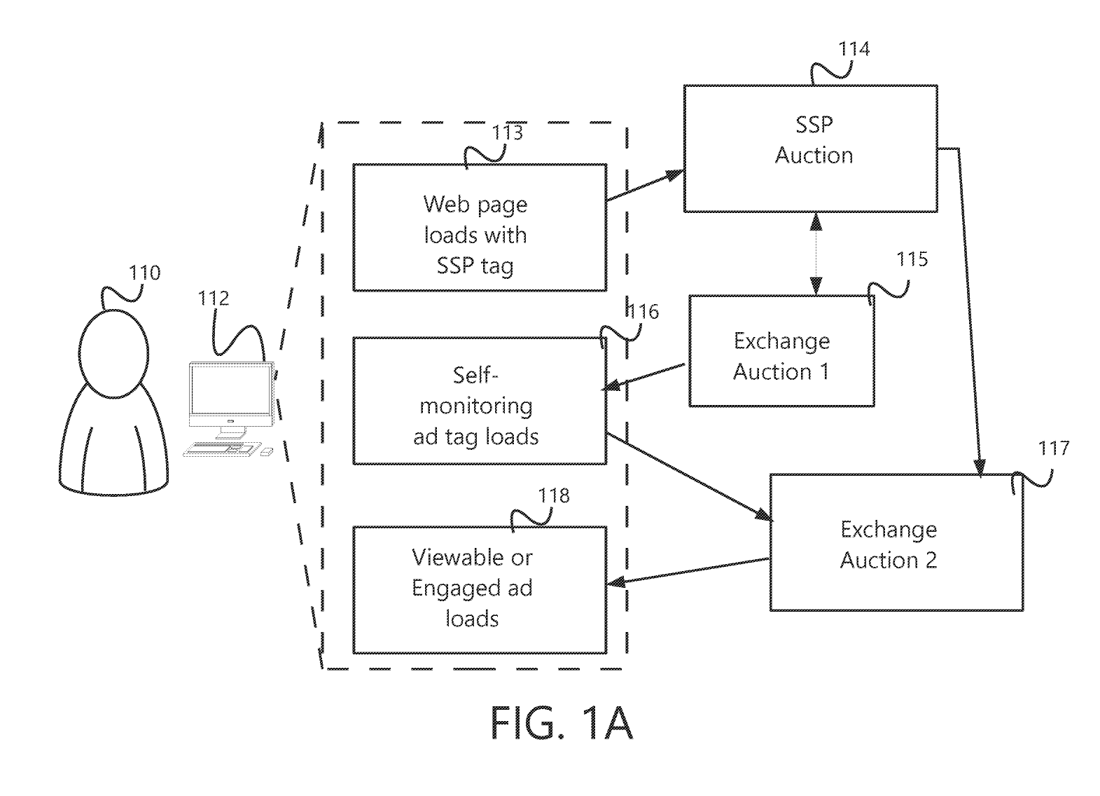

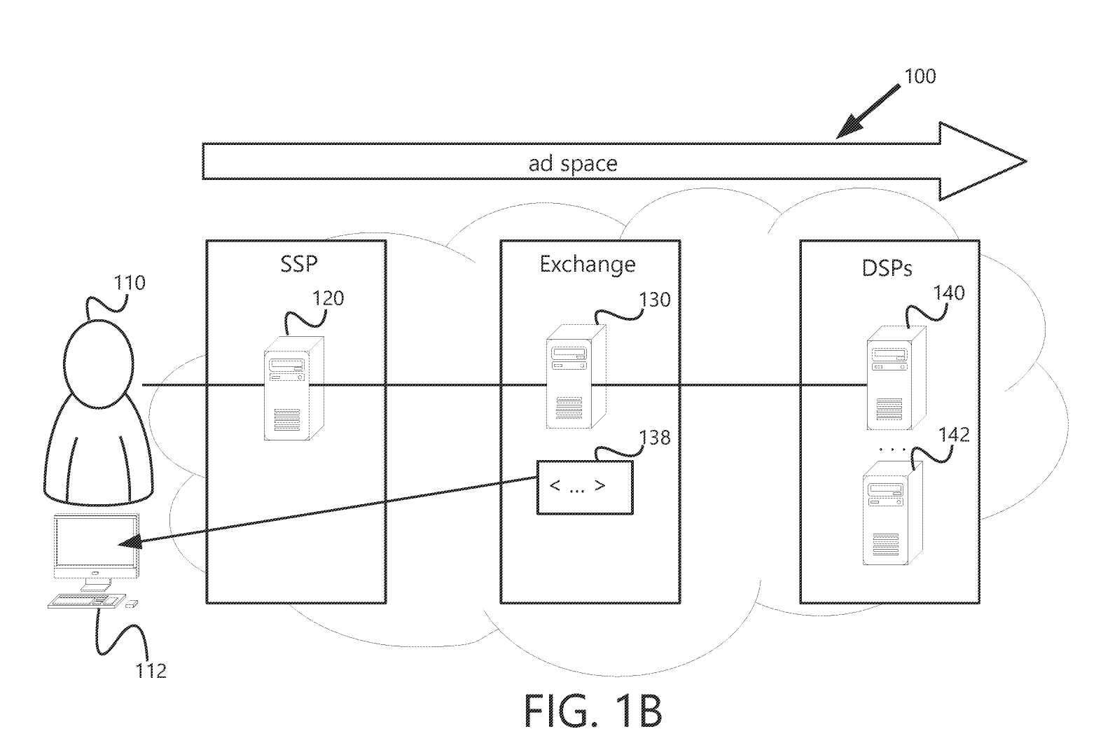

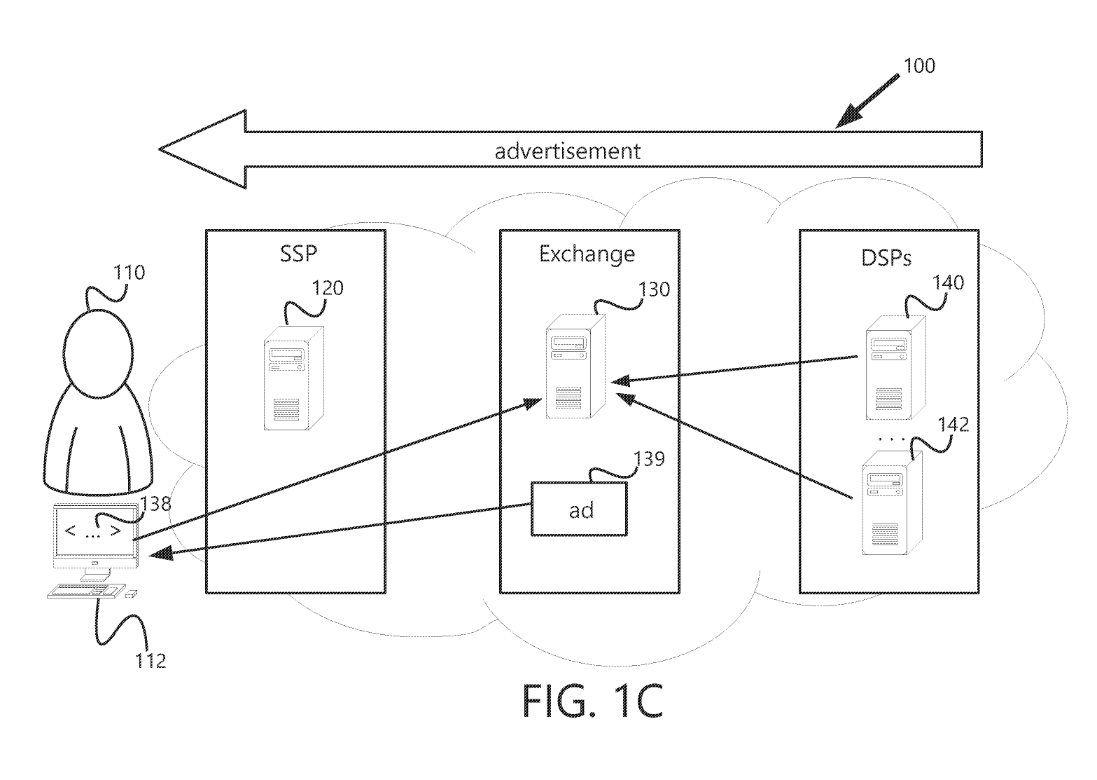

FIG. 1A is an exemplary illustration of a network of auction platforms for distributing self-monitoring ad tags that solicit real-time advertisement bids, in accordance with an embodiment;

FIG. 1B is an exemplary illustration of a system for distributing self-monitoring ad tags that solicit real-time advertisement bids, in accordance with an embodiment;

FIG. 1C is an exemplary illustration of a system for receiving resale requests from ad tags that monitor their viewability status, in accordance with an embodiment;

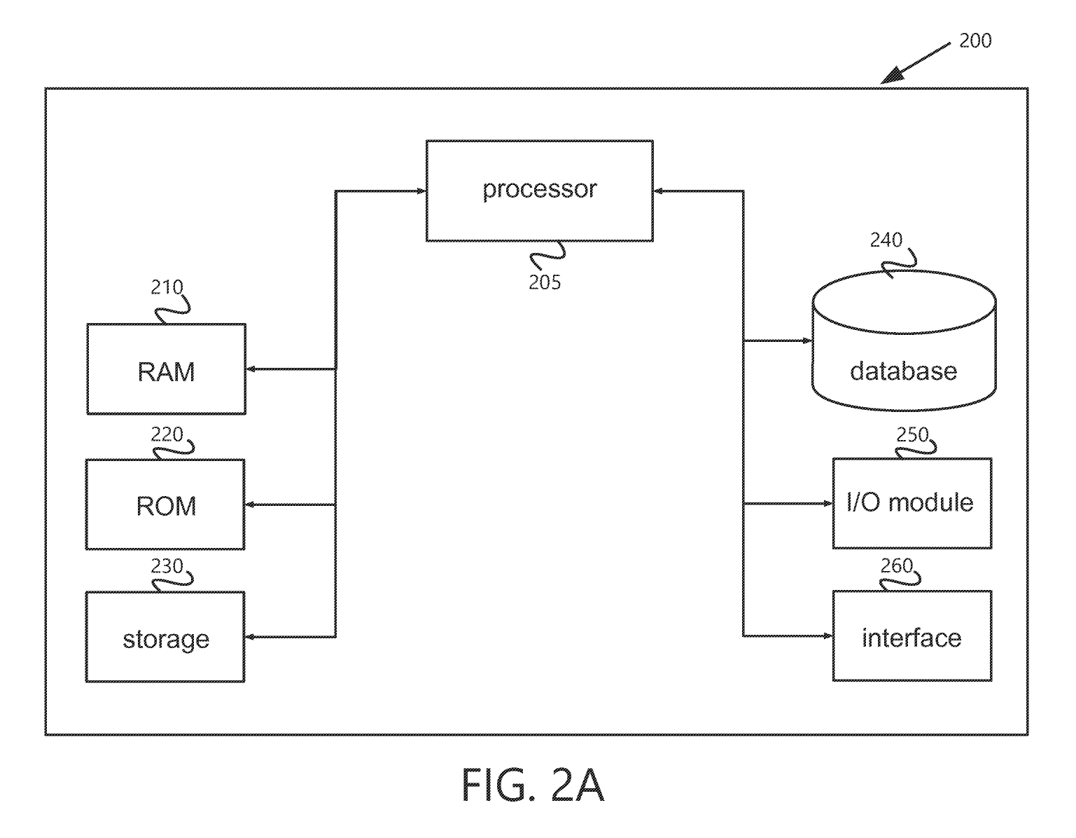

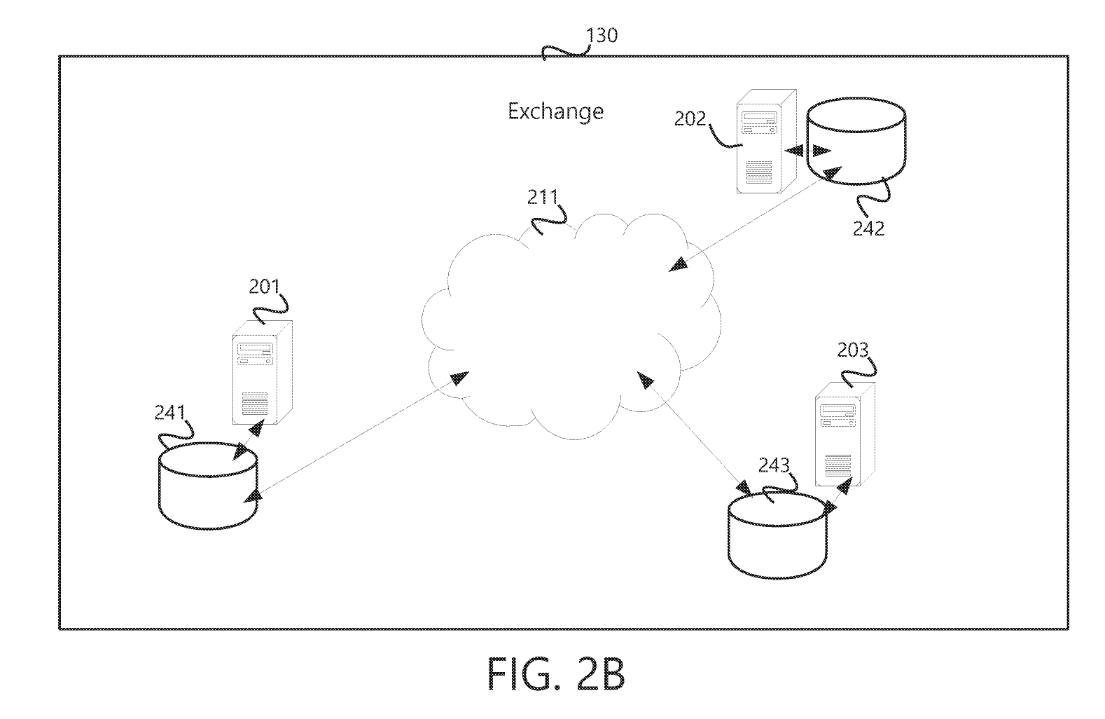

FIG. 2A is an exemplary illustration of components utilized by an exchange to provide a self-monitoring ad tag;

FIG. 2B is an exemplary illustration of an exchange comprised of multiple RTB servers and user databases;

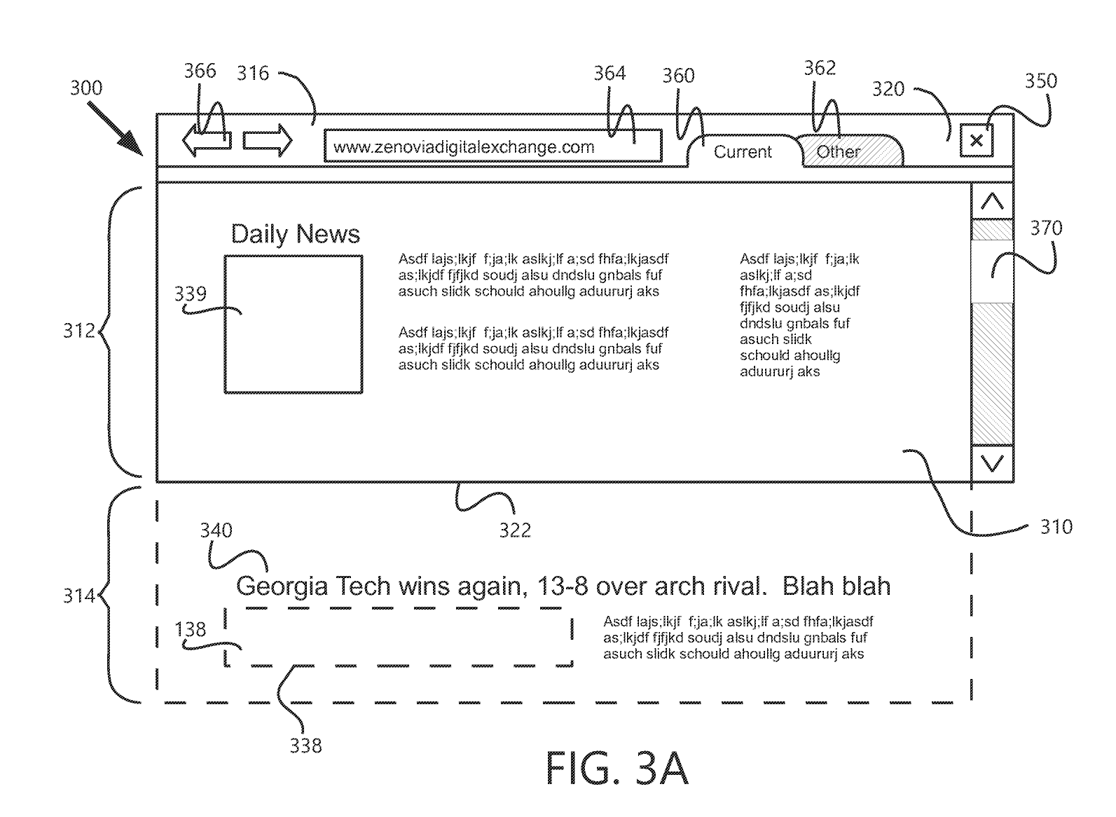

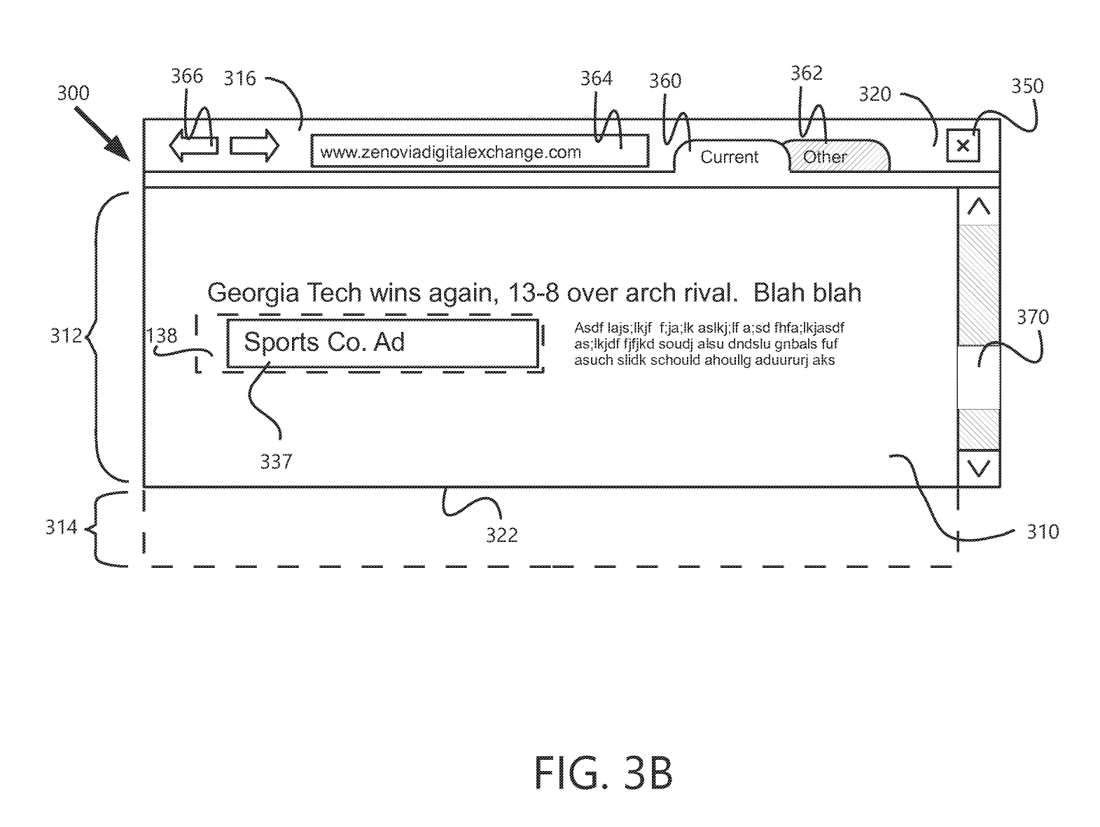

FIG. 3A is an exemplary illustration of a webpage utilizing a self-monitoring ad tag, in accordance with an embodiment;

FIG. 3B is a further exemplary illustration of a webpage utilizing a self-monitoring ad tag, in accordance with an embodiment;

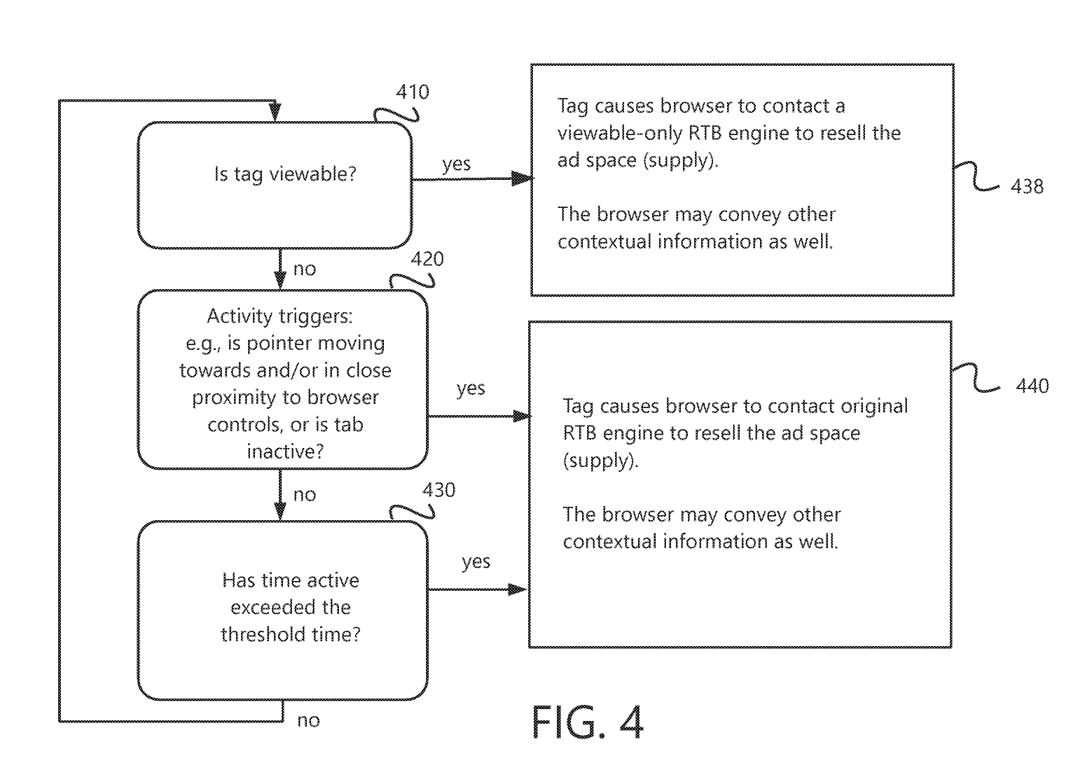

FIG. 4 is an exemplary flow chart with non-exhaustive listings of steps that may be performed by a processor executing the code of the self-monitoring ad tag, in accordance with an embodiment;

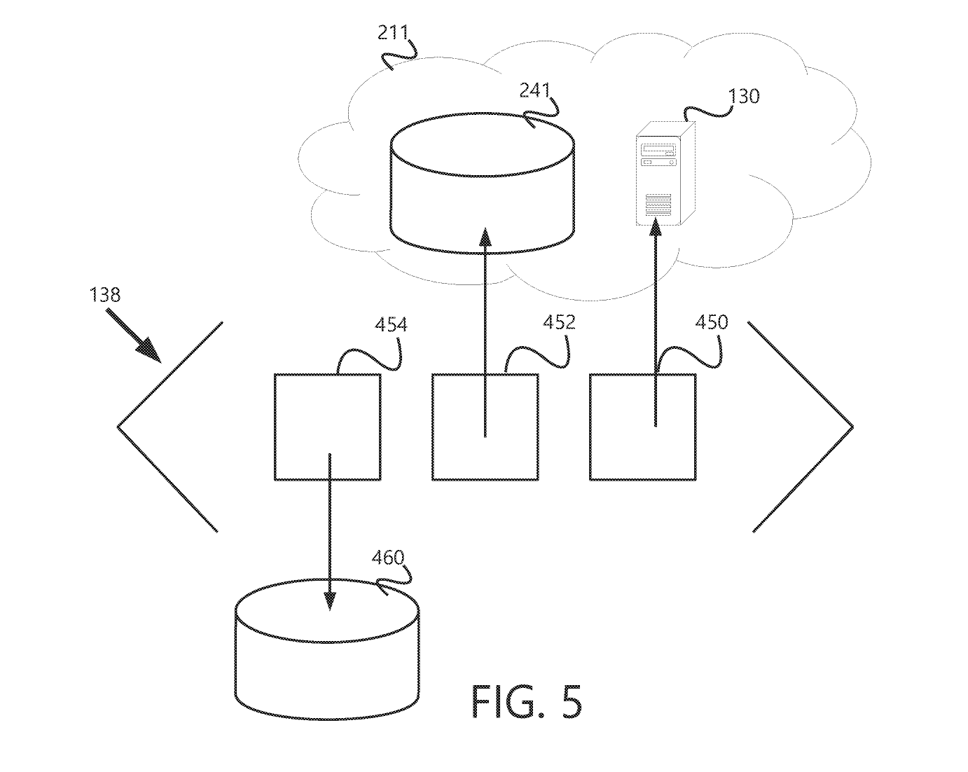

FIG. 5 is an exemplary illustration and block diagram of a self-monitoring ad tag containing embedded tags for communicating to databases;

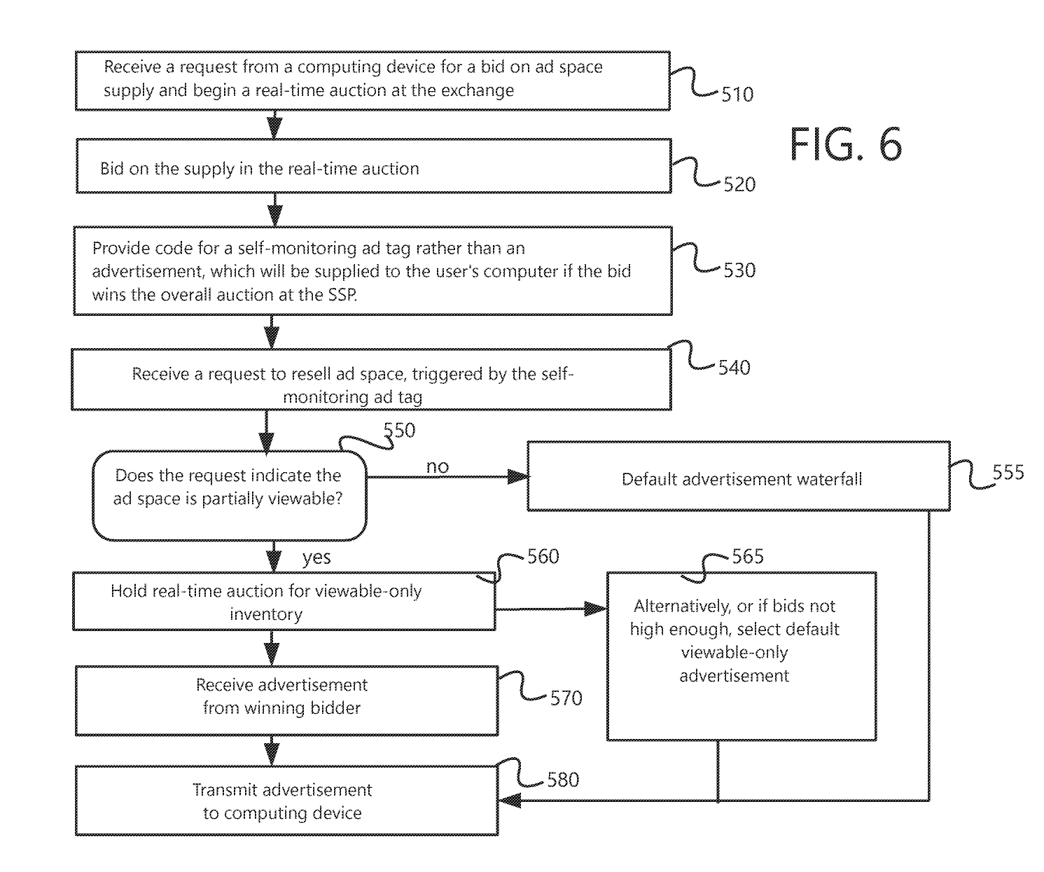

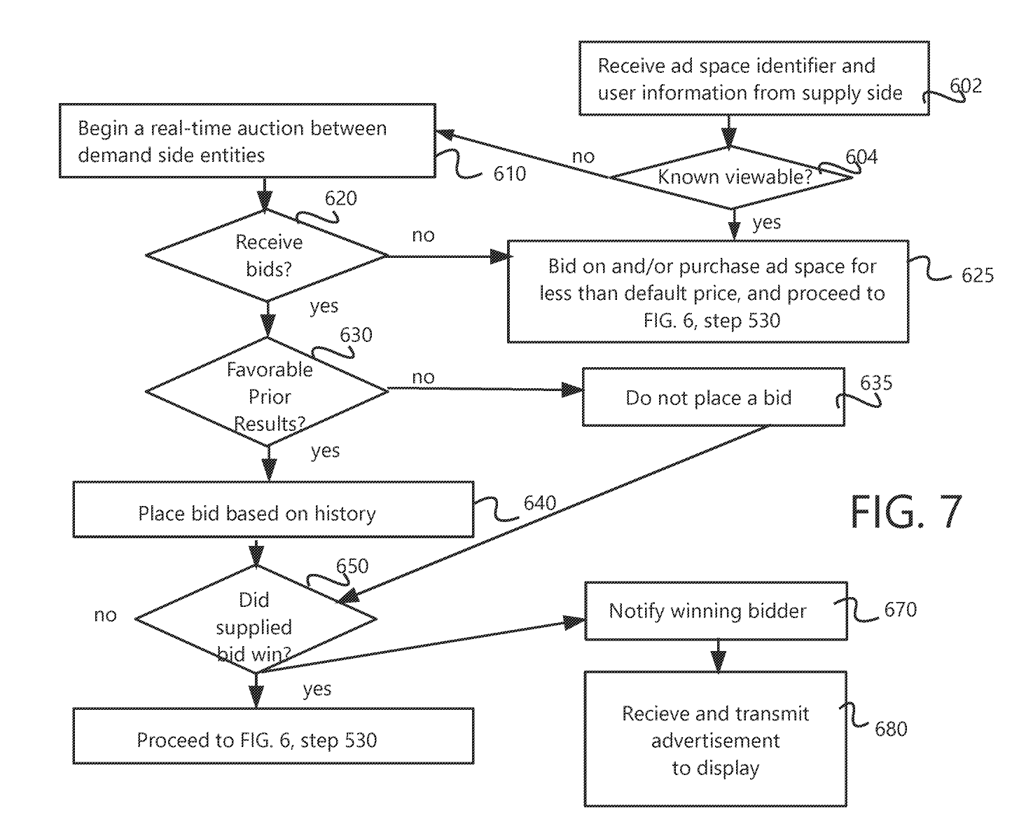

FIG. 6 is an exemplary flow chart with non-exhaustive listings of steps that may be performed by an ad exchange, in accordance with an embodiment;

FIG. 7 is an exemplary flow chart with non-exhaustive listings of steps that may be performed by an ad exchange, in accordance with an embodiment;

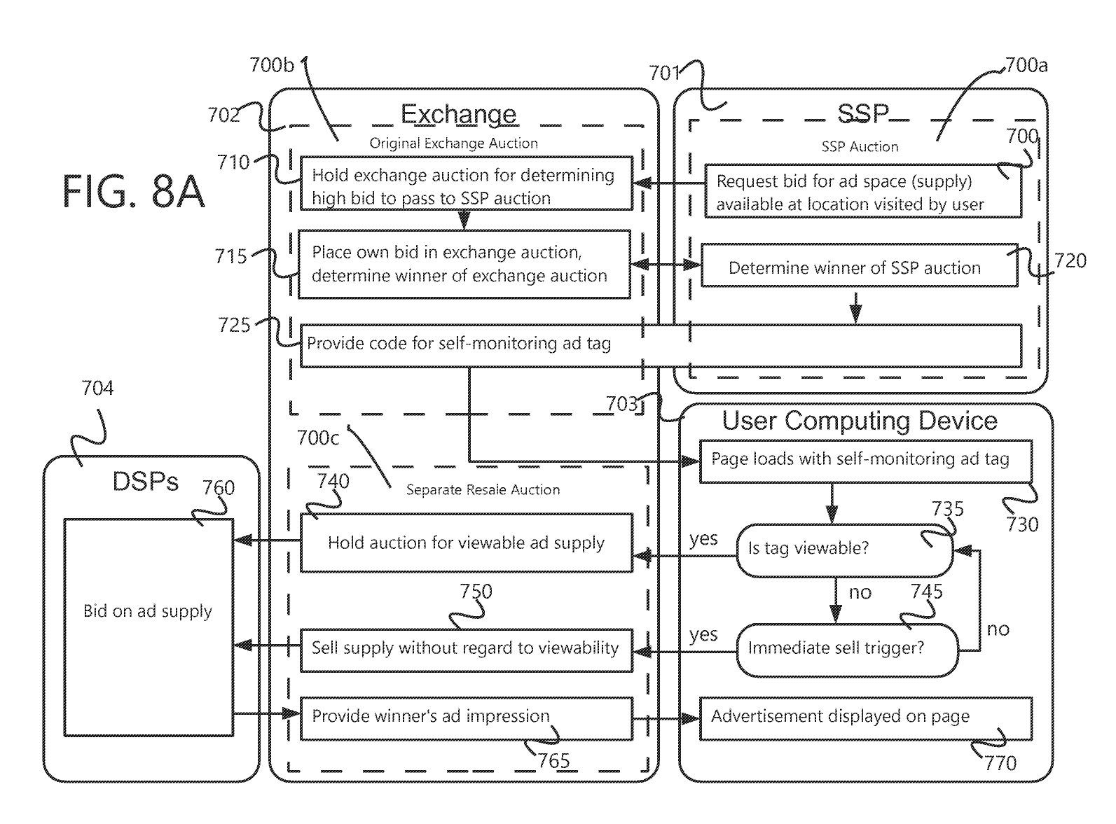

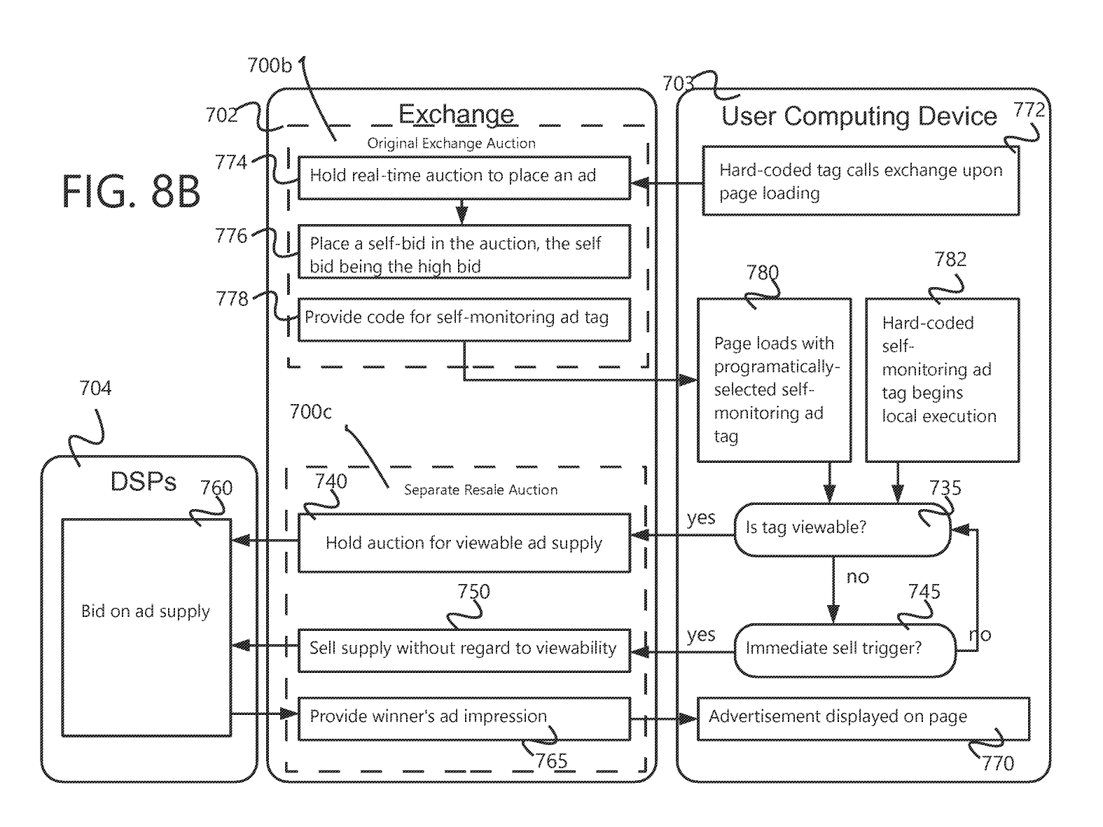

FIG. 8A is an exemplary flow chart with non-exhaustive listings of steps that may be performed between an Exchange, an SSP, DSPs, and a user computer, in accordance with an embodiment;

FIG. 8B is an exemplary flow chart with non-exhaustive listings of steps that may be performed between an Exchange, DSPs, and a user computer, in accordance with an embodiment;

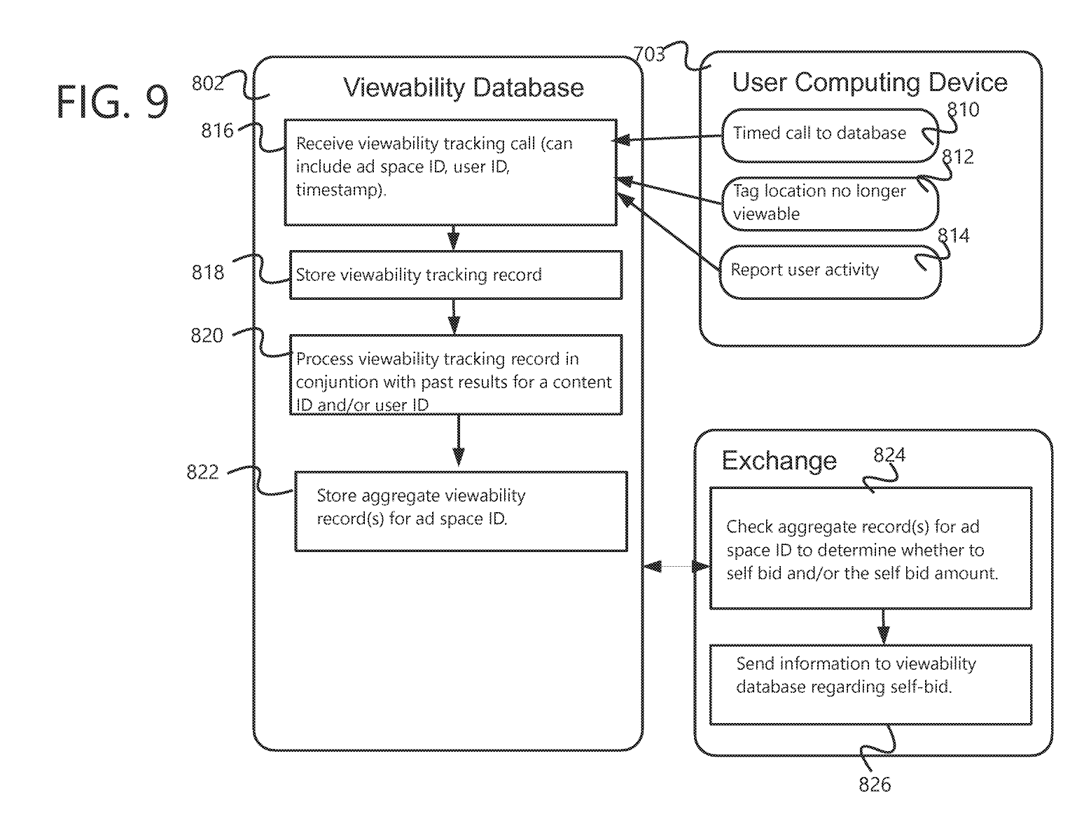

FIG. 9 is an exemplary flow chart with non-exhaustive listings of steps that may be performed to verify viewability decisions by self-monitoring ad tags, in accordance with an embodiment;

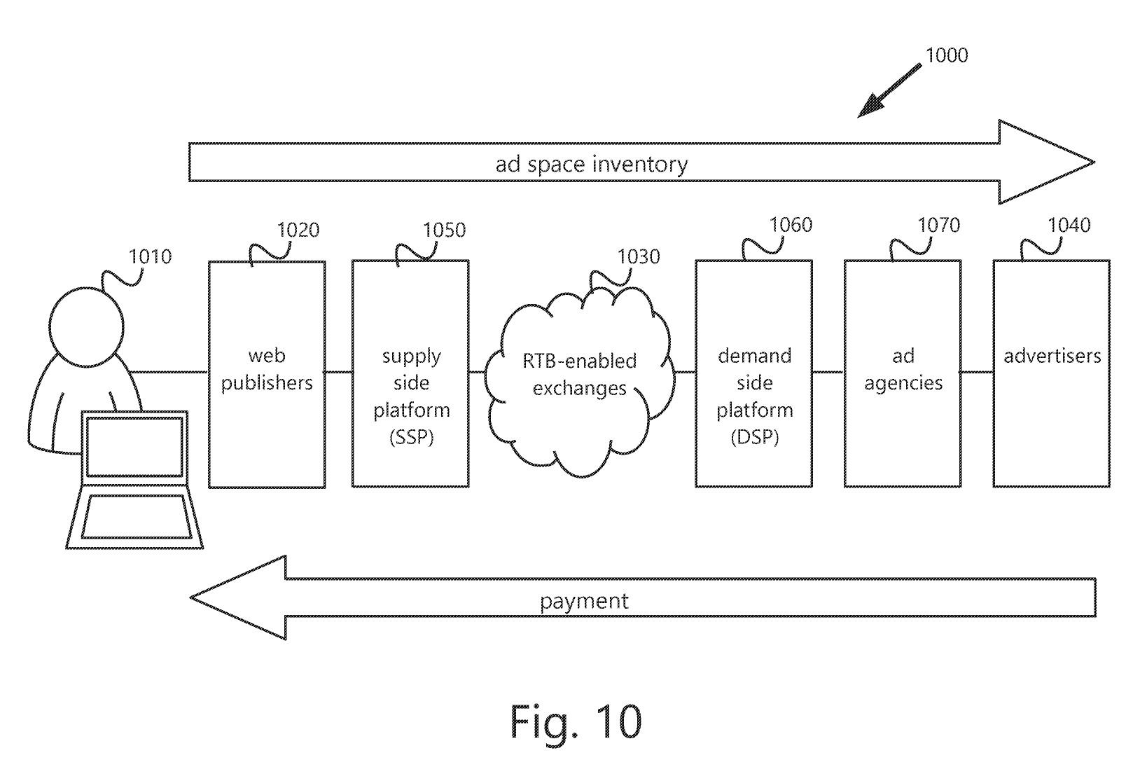

FIG. 10 is an exemplary illustration of an environment for facilitating the sale of advertising space on a publisher's webpage to an advertiser, in accordance with an embodiment;

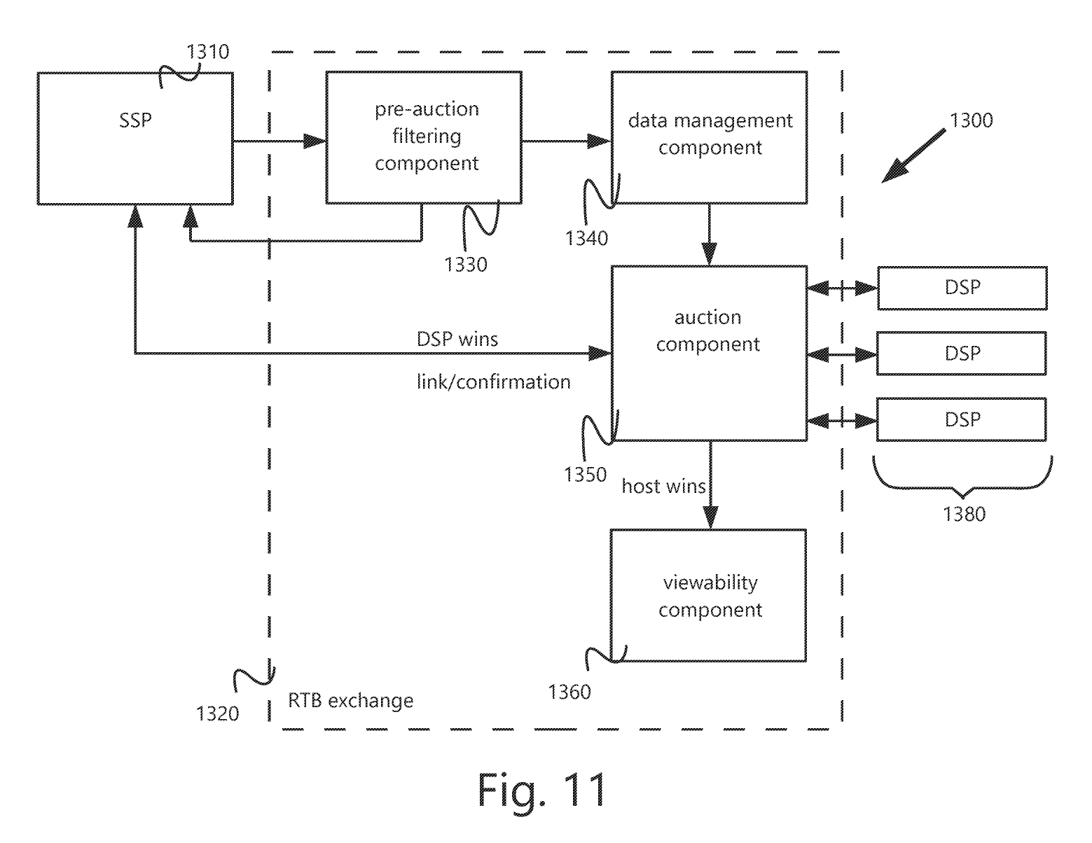

FIG. 11 is an exemplary illustration of an RTB exchange environment, in accordance with an embodiment;

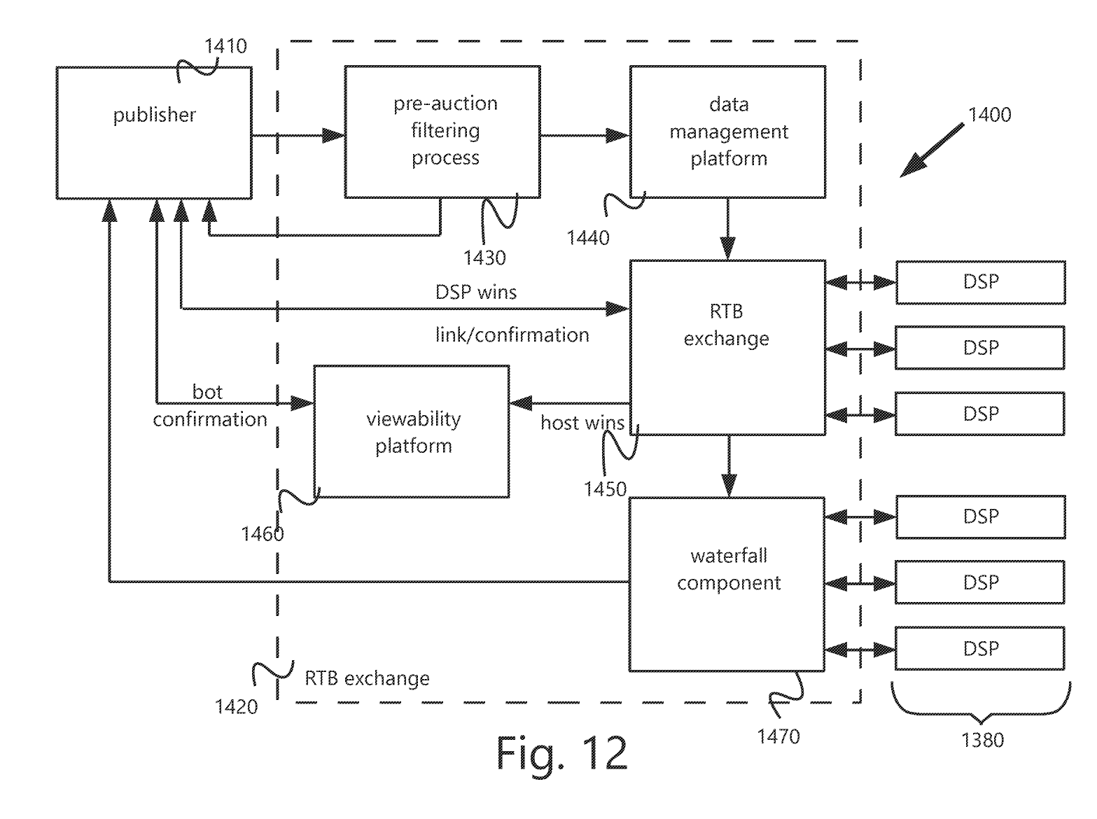

FIG. 12 is an exemplary illustration of an RTB exchange environment, in accordance with an embodiment;

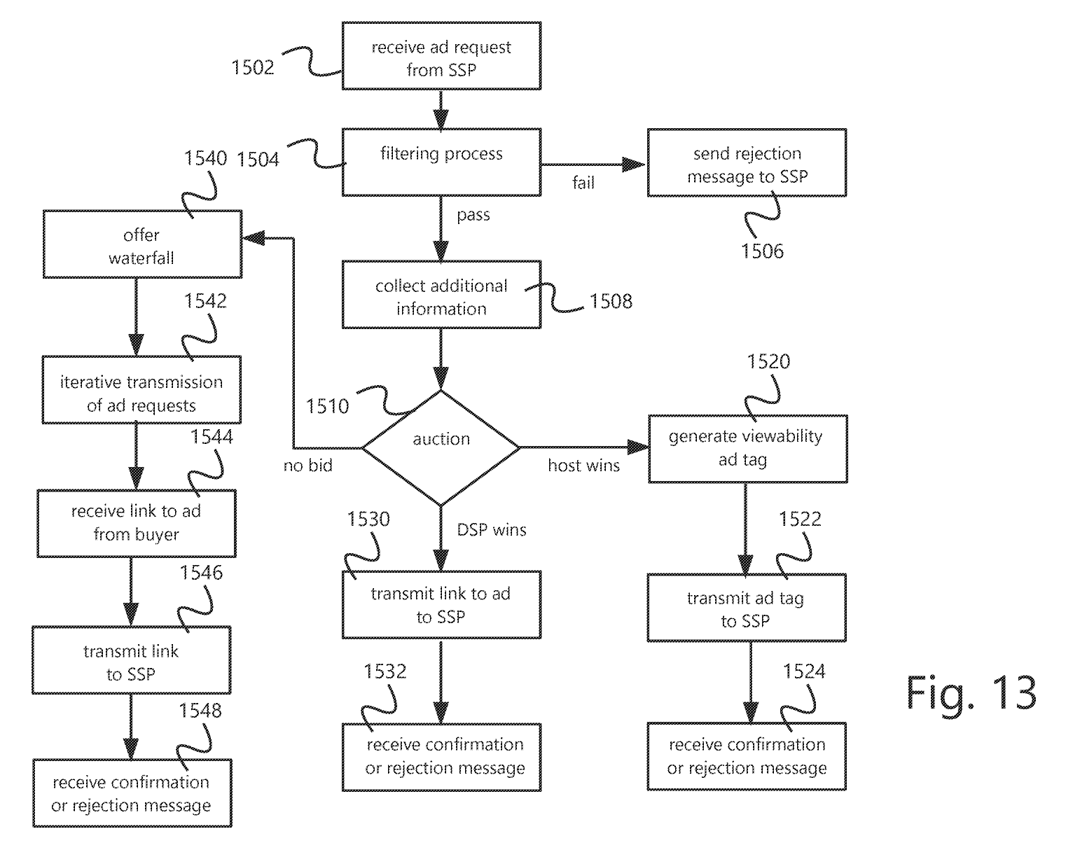

FIG. 13 is an exemplary flowchart for purchasing advertising inventory from an SSP or web publisher, in accordance with an embodiment;

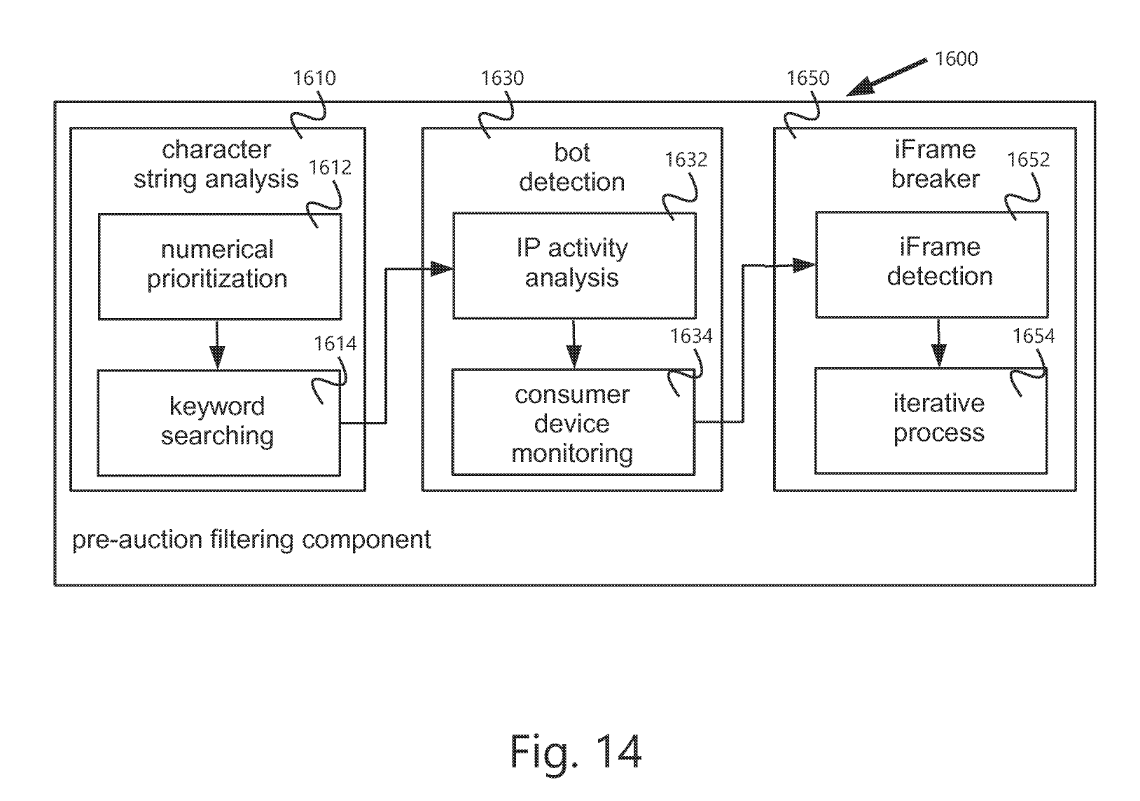

FIG. 14 is an exemplary illustration of a filtering component, in accordance with an embodiment;

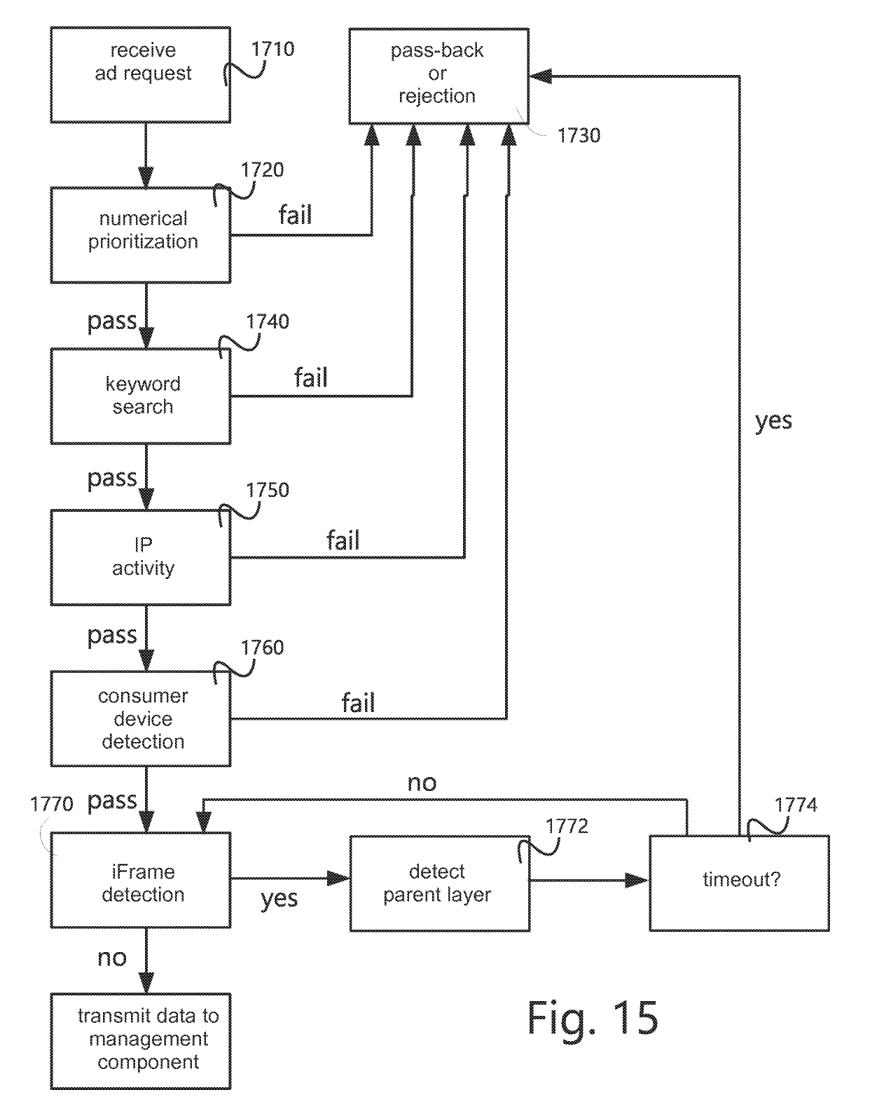

FIG. 15 is an exemplary flowchart for filtering out ad requests associated with undesirable inventory, in accordance with an embodiment;

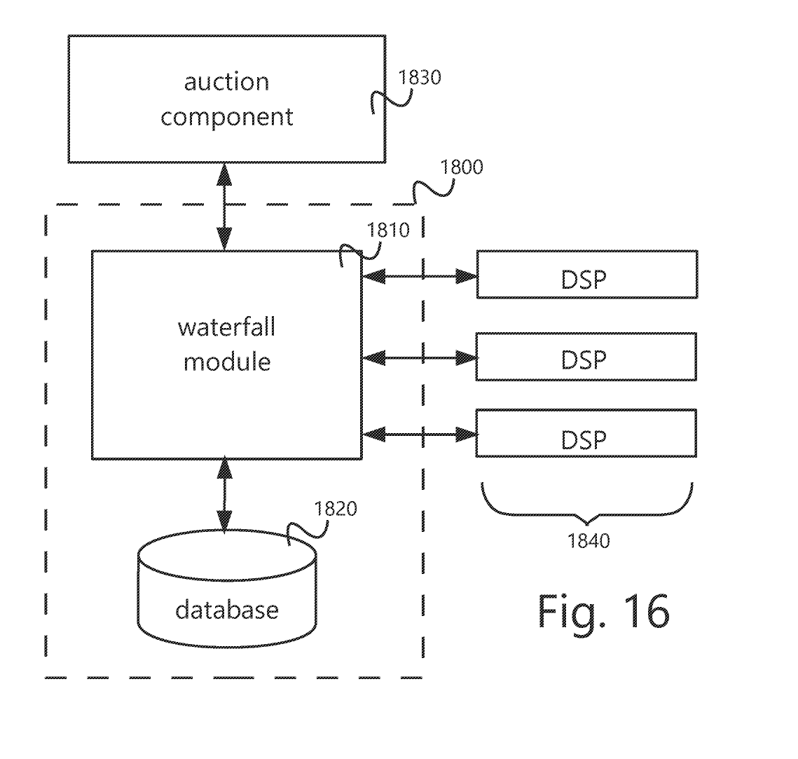

FIG. 16 is an exemplary illustration of a waterfall component, in accordance with an embodiment;

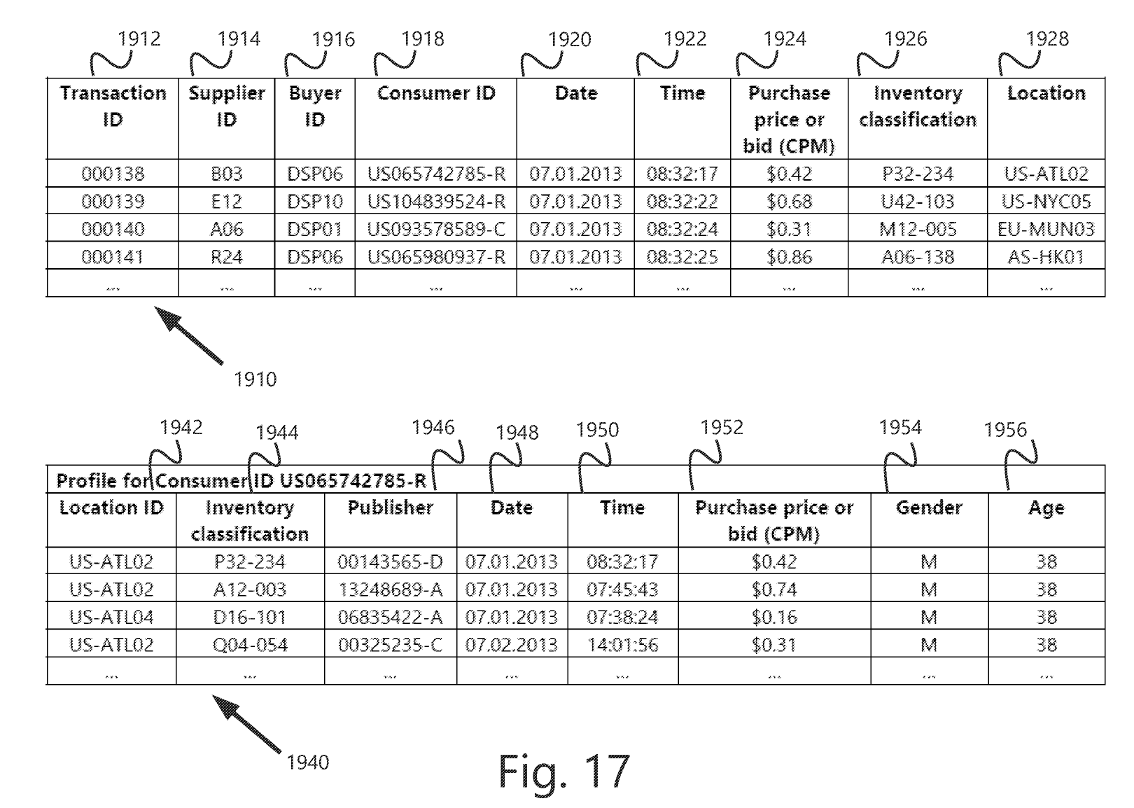

FIG. 17 is an exemplary illustration of data contained within a database, in accordance with an embodiment; and

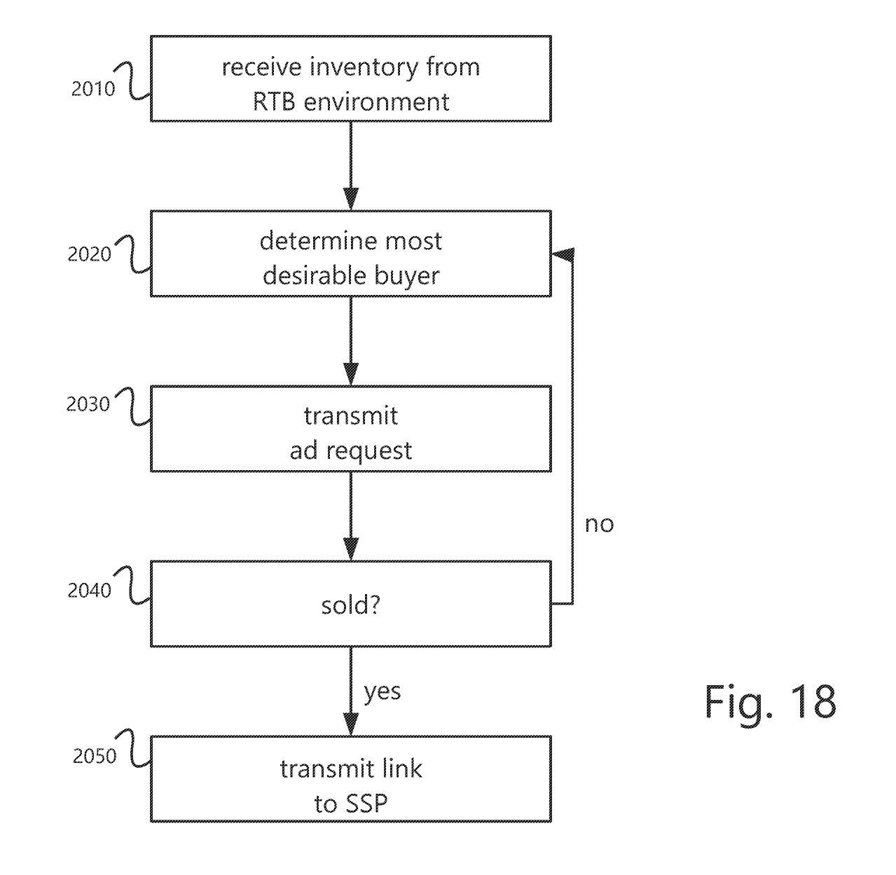

FIG. 18 is an exemplary flowchart for selling inventory through a waterfall component, in accordance with an embodiment

### DESCRIPTION OF THE EMBODIMENTS

Reference will now be made in detail to the present exemplary embodiments, including examples illustrated in the accompanying drawings. Wherever possible, the same reference numbers will be used throughout the drawings to refer to the same or like parts.

### Viewability Summary

Exemplary embodiments herein allow an entity, such as an exchange, to purchase ad space as part of a real-time bidding auction. The ad space may be located within content, such as a webpage, being loaded on a user computing device. But instead of placing a traditional advertisement within the space, an exemplary embodiment herein may supply a self-monitoring ad tag. The self-monitoring ad tag may be executed by the user computing device to locally monitor events, causing the user computing device to request resale of the ad space at an optimal time.

This may allow an exchange to purchase an ad space for a relatively low price and then resell it for a higher price. For example, once the location of the ad space (i.e., also the location of the self-monitoring ad tag) becomes viewable, ad space at the viewable location may be worth much more money to advertisers than ad space at an unknown location (which might never be viewed by the user). Thus, the self-monitoring ad tag may cause the user's computing device to monitor viewability of the ad space location, in addition to monitoring other user activities and potentially-valuable context, and initiate a resale when conditions are optimal. In this way, the exchange may use its own auctions and/or SSP auctions to buy low and sell high.

When the self-monitoring ad tag becomes viewable, it may cause the user's computing device to contact a second RTB auction (e.g., at the exchange or a different exchange) that exclusively sells viewable ad space. Special arrangements with advertisers bidding at the second RTB auction may facilitate greater financial returns in one embodiment.

The self-monitoring ad tag may also initiate a sale to avoid losses when conditions indicate the user may not view the ad space before navigating away from the surrounding content (e.g., by closing the browser or visiting a new website).

For simplicity, the content where the self-monitoring ad tag is placed may be discussed herein as a webpage or website, but that is just one example of content. Embodiments described herein also operate with other types of content, such as a video, movie, television show, software application, e-book, e-mail, music streaming app, video game, or any other type of content where at least a portion containing the ad space is delivered over and/or has access to the Internet. Thus, none of the disclosures herein are limited to only a webpage or website, and the concepts herein also apply to other types of content.

Similarly, it is contemplated that embodiments herein may acquire ad space through a purchase, sale, resale, buy, joint venture, compartmentalization, or any other method of acquisition. Use of terms such as “bid,” “buy” or “purchase” are not limiting with regard to how the ad space is acquired (e.g., auction or waterfall), but are used broadly to apply to any programmatic sales transaction. Similarly, the term sale can include a resale, and sell and can include resell, unless otherwise specified.

### Exemplary System and Environment Overview

Turning to FIG. 1A, it shows an exemplary illustration of a network of auction platforms for distributing self-monitoring ad tags that solicit real-time advertisement bids, in accordance with an embodiment is shown. In this example, a user 110 at a computing device 112 may attempt to view content, such as a webpage, on the computing device 112. The webpage may have an SSP's ad tag hard-coded into it. Stages 113, 116, and 118 represent functions that may be performed locally at the computing device 112.

At stage 113, when the webpage loads, the computing device may execute the SSP's tag, causing the computing device 112 to contact an SSP auction platform 114. The SSP auction platform 114 may then execute an automated auction to sell ad space on the webpage being loaded by the user 110 computing device 112.

As part of the SSP auction, the SSP may contact an exchange with a bid request. The bid request may identify the source of the content (e.g., a particular webpage), the ad space (e.g., an ad space identifier), and/or the computing device 112 (e.g., a user ID). In response to the bid request, the exchange may then hold its own first auction 115, soliciting bids for the ad space being offered by the SSP, and forwarding the winning bid of the exchange auction to be placed as a bid in the SSP auction.

In some cases (as will be described more fully herein), the exchange will determine that it should bid on the ad space itself, and if it has the high bid in its own auction (i.e., the first exchange auction), the exchange will pass its own bid back into the SSP auction 114. If the exchange ultimately wins the SSP auction 114, the SSP and/or exchange then deliver the exchange's self-monitoring ad tag to the computing device instead of delivering a traditional advertisement.

The computing device then loads the self-monitoring ad tag at block 116, which may cause the computing device to monitor user activity and wait for an optimal time to resell the ad space. In particular, if the ad space is in viewable (e.g., in view for 3 seconds) or engaged (i.e., moving into view), the code self-monitoring ad tag may cause the computing device 112 to contact a second exchange auction platform 117 to resell the ad space at a premium based at least partially on the “viewable” or “engaged” status. “Viewable” may be sold at a premium compared to non-viewable, and “engaged” may be sold at a premium to even viewable in one embodiment. For example, an engaged ad may be more likely to be clicked than one that is merely viewable.

The second exchange auction platform 117 may then hold an auction for the ad space that may be a viewable-only auction (which may also include engaged ad space or be solely for engaged ad space in one embodiment), commanding higher prices from advertising entities based on the certainty that a placed advertisement will be in view or engaged. Once the second exchange auction platform determines the winner, the exchange may then place the winner's advertisement by communicating it back to the computing device 112. At stage 118, the computing device 112 may load the viewable or engaged ad of the winning bidder.

### Exemplary Physical Components for Placing a Self-Monitoring Ad Tag

Turning to FIG. 1B, an exemplary system 100 for delivering a self-monitoring add tag to a user computer is presented. In this example, the self-monitoring ad tag 138 may be placed within content, such as a webpage, when an exchange 130 purchases ad space in a real-time bidding (RTB) auction environment. System 100 can include a computing device 112, an SSP 120, an exchange 130, and DSPs 140 and 142. Computing device 112, an SSP 120, an exchange 130, and DSPs 140 and 142 can be configured for one or more of storing, receiving, transmitting, and displaying information, and can each include at least one non-transitory computer readable medium and at least one processor.

The computing device 112 may be any processor- or controller-based device for displaying, storing, receiving, and transmitting information. For example, computing device 112 can be a cell phone, smart phone, tablet, laptop, personal computer, or television. Other examples of computing device 112 include any portable or non-portable, processor- or controller-based device. Additional example computing devices 112 are discussed below, and any device capable of displaying the content discussed herein is contemplated.

Each of the SSP 120, exchange 130, and DSPs 140 and 142 may comprise one or more servers. For example, exchange 130 may include a plurality of servers located all over the world at locations proximate to one or more DSP or SSP servers. For simplicity, FIGS. 1B and 1C illustrate only one server for each entity, but embodiments with multiple servers for one or more of the entities are contemplated. Each of these servers may contain one or more of the elements depicted in FIGS. 2A and 2B, which are described separately below.

Continuing with FIG. 1B, ad space flows from left to right, from where it is available within content to where it is purchased by the exchange 130 or a DSP 140 or 142. SSP 120 (a supply-side platform) may be an online publisher responsible for selling ad space. This ad space appears within content (e.g., a webpage) that is delivered over a network, such as the Internet. The servers of SSP 120, exchange 130, and DSPs 140 and 142 may communicate with each other over that network or a different network. DSPs 140 and 142 (i.e., demand-side platforms) are technology platforms that allow buyers of advertising to manage bids and purchases of advertisements sold by SSPs and ad exchanges. More or less servers may be involved.

In such an environment, DSPs 140 and 142 may purchase ad space from SSP 120 in one embodiment and/or from exchange 130 in another embodiment. The term DSP as used herein should be understood to include any entity that programmatically purchases ad space to place advertisements, such as trading desks or direct advertising entities. Any advertising entity (e.g., trading desks and DSPs acting on behalf of ad agencies) may programmatically bid on the ad space, and the winning bidder is allowed to place an advertisement at the ad space, with the goal of that advertisement being viewed or clicked by the user 110.

Exchange 130 may sit between SSPs and DSPs and include an auction technology platform that facilitates bidding in the context of buying and selling of online media advertising inventory from multiple ad networks. For example, exchange 130 may include an auction engine that holds an automated real-time auction in which other entities bid on the ad space. In addition, exchange 130 may have a predefined set of entities to shop the ad space to in a waterfall fashion. One example of a waterfall is presented and explained with regard to FIG. 18, below.

Continuing with FIG. 1B, in one embodiment, the exchange 130 may subsume some or all of the functionality of the SSP 120 and/or DSP 140. For example, on the supply side, an exchange 130 may include a publishing desk for ad space or a direct relationship to sell ad space for particular websites. On the demand side, the exchange 130 may include an advertising trading desk with a direct relationship with advertisers who which to purchase ad space.

### Example Interactions of Physical Components to Place the Tag

As an example of how the entities of FIG. 1B may interact with one another, the user 110 may visit a website that is hard-coded with an ad tag that notifies an SSP 120 to sell the ad space. This hard-coding may be done in advance based on a prior agreement between the website owner and the SSP 120 (e.g., a publishing agreement). The computing device 112 executes the hard-coded ad tag and contacts the SSP 120, which, upon receiving the request, then attempts to sell the ad space to an advertising entity as the page is loading on the user's computing device 112.

However, this sale is generally made without regard to the location of the ad tag relative to the user's screen, and can often involve selling ad space that is not visible to the user 110 (e.g., ad space that is “below the fold” and will not be in view unless the user scrolls down). For example, as shown in FIG. 3A, a webpage 310 may load with a portion on screen 312 (i.e., “above the fold”) and a portion below the screen 314 (“below the fold’). Whereas an advertisement at location 339 would be immediately viewable, ad space at location 338 would not be viewable unless the user scrolled down.

Selling the ad space can include holding a real-time auction for the ad space, in which the SSP 120 automatically (i.e., programmatically) contacts potential bidders over a network, such as the Internet. Exchange 130 is one such entity that may be contacted to bid on the ad space, in one embodiment.

Once contacted, the exchange 130 may hold its own automated real-time auction (e.g., an auction at the exchange taking place within the SSP auction), in which it solicits bids for the ad space over a network from advertising entities (e.g., DSPs 140 and 142) that may be different or the same as the other potential buyers contacted by the SSP 120.

Autonomously (i.e., programmatically), the exchange 120 may solicit bids from one or more such advertising entities, such as DSPs 140 and 142 and/or direct advertisers, as part of its real-time auction. The exchange 130 may do this over a network, such as the Internet, and supply information to the potential bidders regarding the ad space, the website, and/or the user 110 so that potential bidders may determine an appropriate bid.

For example, the exchange 120 may provide bidders (e.g., DSPs 140 and 142) with characteristics of the user 110 based on past history of the user logged based on online activities of the user 110. The exchange may automatically learn and track these online activities based on bid requests from SSPs and direct sellers of ad space for that user 110. Alternatively or in addition, the exchange may place a cookie on the user's display device 112 and learn attributes of the user based on the cookie. For example, when the exchange 130 provides a winning bid from a DSP 140 or 142, it may provide a cookie to the user's display device 112 or cause a cookie to be provided by the SSP 130.

The exchange's 130 automated RTB auction may be brief, such as 100 milliseconds or less, to provide time for the exchange 130 to communicate a high bidder to the SSP 120, which must then determine if the high bidder is the winning bidder within the overall auction taking place at the SSP 120. In other words, the RTB auction at the exchange 130 may begin and end within the time that the RTB auction at the SSP is held since the auction at the SSP is the highest-level auction that ultimately determines who wins the bid for the ad space.

In another embodiment, the SSP 120 does not hold an auction, and the highest-level real-time auction is held at the exchange 130, such as on behalf of the SSP 120 or when a publisher (e.g., website) contacts the exchange 130 directly. In that case, the exchange determines the winner of its auction (rather than just passing on its high bid to the SSP auction), and supplies the winner's advertisement for implementation into the website being loaded by the user's computing device 112. In any case, the time to load a webpage is short, and if the auction stretches beyond 130 milliseconds, the user may perceive a delay in loading the webpage. Thus, even if the exchange 130 subsumes the role of the SSP and is communicating directly with a publishing desk or website, the time for the automated auction may be limited to less than 130 milliseconds.

In an embodiment utilizing both an SPP auction and exchange auction, once the predefined period of time for the exchange RTB auction has elapsed (e.g., 100 milliseconds), the high bid may be presented to the SSP 120. The SSP 120 then notifies the exchange 130 if the presented bid won the overall auction (i.e., the SSP's 120 auction), and, if so, acquires and integrates the winner's advertisement into the webpage for potential presentation to the user 110. In one embodiment, exchange 130 facilitates placement of the advertisement by supplying a link to the advertisement with the respective entity's bid, allowing the SSP to locate the advertisement. In another embodiment, the exchange 130 facilitates placement by causing a processor to retrieve and pass the advertisement to the SSP 120 or even directly to the user's computing device 112. The exchange may cause a processor that is not handling the real-time auctions to perform this task, saving processing power for the time sensitive auctions. In an embodiment where the exchange 130 subsumes the role of the SSP and is communicating directly with a publishing desk or website, the exchange 130 may provide the winning advertisement to the publishing desk or website.

Additional details regarding the RTB environment and the entities involved is described relative to FIG. 10, in the below section titled Additional Overview and Details of Exemplary RTB Systems and Methods.

a. Example Dynamic Tag Placement Via Self-Bidding

In one embodiment, the self-monitoring ad tag 138 may be placed onto the webpage in dynamic fashion. It need not be pre-arranged or previously hard-coded into the webpage in an embodiment.

Continuing with the example embodiment of FIG. 1B, unlike the prior art, the exchange 130 itself may bid (i.e., self-bid) on the ad space within its own automated auction and/or the SSP's 120 automated auction. This bid need not be made on behalf of an advertising agency, a DSP 140, or an advertising trading desk. Instead, the exchange 130 may attempt to win the ad space in order to place code for a self-monitoring ad tag 138 onto the computing device 112 at the location of the ad space.

The exchange 130 may programmatically determine when to self-bid. In one embodiment, the exchange 130 may place its own bid (i.e., self-bid) in the SSP's auction if no other bids are received in the exchange's 120 auction. Alternatively or in addition, the exchange 130 may decide to place its own bid in its own automated auction (or the SSP's auction) based on past history of the user 110 or the ad space. For example, the exchange 130 may be able to identify that the user 110 commanded high prices for prior ad placements, such as 200% or more compared to the exchange's bid amount. This could be the case, for example, when the other bidding entities are not yet able to identify the user 110 (such as when the user's IP address changes, or the user ID is deleted from the DSP's database). The exchange 130 might also or alternatively determine that the current maximum bid is still less than a default price (e.g., 10 cents per CPM) that the exchange 130 can attain for that user 110 and/or ad space in a default waterfall, creating a positive arbitrage situation.

The exchange 130 may alternatively base its programmatic decision to self-bid on database records indicating prior successes or failures with (1) attaining and reselling the ad space and/or (2) the particular user ID. As will be discussed herein, the exchange 130 may communicate with a database that tracks whether ad space having particular ad space identification was previously immediately viewable, became viewable, or never became viewable. These past results (which may be expressed as a CPM to viewable ratio in one embodiment) may influence whether the exchange 130 will bid again on supply with that same ad space identification. Similarly, a communicatively-coupled database may track results for a particular user ID. If that user does not historically remain at content long enough for ad space to become viewable, the exchange 130 may pass on bidding on supply for that user ID.

In one embodiment, the self-bid decision is made based on a comparison of past success to CPMs (each CPM equaling 1,000 ad space impressions). For example, the exchange may determine whether to bid based on a CPM to viewability ratio previously calculated for the ad space identifier and stored in database that is communicatively-coupled to the exchange 130. In one embodiment, the exchange may set a threshold for self-bidding at 10,000 CPM per 1,000 viewable (10/1 ratio) in one embodiment. In another embodiment, the threshold may be a 25/1 ratio. If the ratio stored in the database for the particular ad space identifier is greater than the threshold, the exchange 130 may elect to not bid.

In an even further embodiment, the exchange may select its bid amount based on the stored CPM to viewable ratio corresponding to the available ad space. For example, a default bid price may be divided by the ratio to arrive at the exchange's actual bid price. In this way, the exchange 130 may programmatically bid less for ad space that is less likely to result in viewable impressions.

If the exchange 130 wins the auction with its own bid, rather than supplying an advertisement for placement at the ad space location, the exchange 130 supplies a self-monitoring ad tag 138. This self-monitoring ad tag 138 is comprised of code that is executed by a processor on the user's computing device 112 as the webpage loads. In one embodiment, the code is written in JAVASCRIPT™ and imbedded in the self-monitoring ad tag 138 for execution by the user's computing device 112.

In another embodiment, the self-monitoring at tag 138 may include additional tags (e.g., additional blocks of code) within it for analyzing viewability characteristics for a particular ad space, as discussed below with regard to FIG. 5.

Continuing with FIG. 1B, in one embodiment, the SSP 120 may retrieve the self-monitoring ad tag 138 from the exchange 130 as if it is an advertisement, and pass this self-monitoring ad tag 138 to the computing device 112, where it is executed. For example, the exchange 130 may facilitate placement by providing its bid and a link to its self-monitoring tag 138 the ad tag, so the SSP 120 can download the self-monitoring tag 138 upon determining that the exchange 130 has won the auction. Alternatively, the exchange 138 may facilitate placement of the self-monitoring ad tag 138 by delivering it to the SSP 120 or to the computing device 112 itself. Facilitating placement may also include providing parameters utilized by the tag 138, such as dimensions of the ad space available for sale and/or a timing threshold for triggering resale.

In an embodiment where the SSP's 120 functionality is subsumed by the exchange 130 (e.g., the exchange hard-codes its own tag into a webpage), the exchange 130 may itself, after determining it has won its own auction, simply supply the self-monitoring tag 138 to the computing device 112 (or a trade desk intermediary).

In this way, the self-monitoring ad tag 138 may be placed onto the webpage in a dynamic fashion. It need not be pre-arranged or previously hard-coded into the webpage in an embodiment.

The code of the self-monitoring ad tag 138 may cause the computing device 112 to operate such that it does not require monitoring by a separate server or database. Such local operation saves an overwhelming amount of system and network overhead in the aggregate, since the exchange 130 may see billions of ad requests each day. Whereas a system utilizing a server-monitored approach could not actively partake in monitoring user activities for hundreds of thousands of users simultaneously, the localized approach of an embodiment herein avoids this scalability issue.

b. Example Hard-Coded Placement of a Self-Monitoring Ad Tag

In another embodiment, the self-monitoring ad tag 138 may be hard-coded in advance in a webpage. For example, the exchange 130 may enter into a contractual relationship with a publisher, publishing desk, website, or other supply-side entity to provide the self-monitoring ad tag 138 in the content. In this way, the self-monitoring ad tag 138 may be provided in content, such as a website, such that when the website loads, the self-monitoring ad tag 138 begins executing.

In one embodiment, the hard-coded self-monitoring ad tag may contain a unique key that is provided to the exchange 130 that sells the ad space. The exchange 130 may use the key to verify that the self-monitoring ad tag is valid and not an attempt to hack the RTB platform or place false ad space for sale. In one embodiment, this verification involves checking the key against database records that correlate unique keys to particular content locations on the Internet (e.g., a URL or IP address). A similar verification process may also be provided for dynamically-placed self-monitoring ad tags 138 in one embodiment. For example, a key may be stored in a database in association with an ad space identifier. When the exchange 130 is contacted to sell the ad space associated with the ad space identifier, the stored key may be checked against the provided key. This process may also incorporate known public and private key methodologies.

Additional functionality for hard-coded self-monitoring ad tags is discussed with regard to FIG. 7B, herein.

c. Example Code of a Self-Monitoring Ad Tag

In one embodiment, the self-monitoring ad tag 138 may be included on a webpage being loaded and/or executed on the user's computing device 112 as follows. The webpage may comprise a listing of code written in HTML, ASP, Java, or other known website languages. Among that code may be a server-side section that is executed by a server prior to the page loading. The server side code may be responsible for initially calling the SSP 120 and/or exchange 130 to get an ad to place on the webpage. When the server receives the self-monitoring ad-tag 138, the server-side code block of the webpage may be replaced by client-side code representing the self-monitoring ad tag 138. In this way, when the user's browser application reads the webpage, the code of the self-monitoring ad tag 138 executes on the client side (i.e., on the user's computing device and not the server).

The code may be structured as a series of tags, as discussed more fully herein with regard to FIG. 5.

This code may cause the browser to monitor various activities discussed in more detail with regards to FIGS. 4A, 7A, 7B, and 8.

d. Exemplary Use of a Placed Self-Monitoring Tag to Trigger Sale/Resale

In one embodiment, the self-monitoring ad tag 138 causes the user's computing device 112 to monitor activities and trigger sale of the ad space at an optimal time. In the aggregate, even many millions of users may be monitored because no external server is required to do so—the monitoring occurs on the local computing devices. Instead of using an open communication between the webpage and a server such that the server can determine when to resell the ad space, such decisions may now be made locally in an embodiment. This may allow each local computing device to trigger a sale/resale of the ad space based on the ad space being viewable, engaged (e.g., moving into view), or sold as a standard ad space (i.e., without regard to viewability).

Example functionality of the self-monitoring ad tag 138 is discussed below with regard to FIG. 1C, and is further discussed elsewhere herein with regard to FIGS. 3A, 3B, and 4A.

Turning to the example of FIG. 1C, the self-monitoring ad tag 138 may cause the computing device 112 to place an ad call with the exchange 130, which may comprise different servers for receiving different types of ad calls (e.g., viewable, engaged, non-viewable). The ad call may cause the exchange 130 to sell (e.g., resell) the ad space and place a purchaser's ad 139 at the ad space.

In one embodiment, a processor in the computing device may execute the code on the computing device 112 to monitor the tag in relation to currently-viewable portion of the website. As will be described in more detail below, the self-monitoring ad tag 138 may contact the exchange 130 to request bids from advertising entities at a time when at least a portion of the tag 138 is within the viewable screen space of the computing device 112. As an example, if the self-monitoring ad tag 138 is off screen, but the user scrolls and a portion of the ad tag becomes on screen (e.g., 30%), the self-monitoring ad tag 138 may contact the exchange 130 or some other server associated with the exchange 130 (e.g., a special server for viewable ad space auctions).

In another embodiment, the self-monitoring ad tag 138 ensures that it is visible for a minimum amount of time, such as 1 second, before it causes the computing device 112 to place an ad call at the exchange 138 (or other RTB platform). During this wait period, the self-monitoring ad tag 138 may display a temporary advertisement, such as an advertisement promoting the exchange's viewability system to entice potential advertising entities to engage in buying the viewable supply.

In addition, the self-monitoring ad tag 138 may cause the computing device 112 to contact the exchange 138 to initiate a resale if conditions are met that indicate the tag may not become viewable before the browser window is closed or the user 110 navigates away from the website. This measure may be taken to mitigate against losses and/or ensure the publishing entity (e.g., website) profits from selling the ad space. In particular, if the ad space is not resold before the user navigates away from the website, the exchange 130 may lose the money it spent to acquire the ad space and supply the self-monitoring ad tag 138. Considering the exchange could purchase ad space and supply a self-monitoring ad tag 138 millions of times in a day, such mitigating actions may prevent substantial losses in one embodiment.

To determine when to mitigate against losses, the self-monitoring ad tag 138 may monitor and/or track the user's 110 activities to determine if the user is unlikely to view the location of the self-monitoring ad tag 138. Examples include if the user has deactivated a browser tab containing the self-monitoring ad tag 138, or if the user's cursor moves out of the viewable screen (such as towards the navigation controls).

Alternatively or in addition, the self-monitoring ad tag 138 may employ a time limit before reselling the ad space regardless of viewable status. In one embodiment, user activities may add or subtract from the time limit. For example, if the user is scrolling the webpage towards the self-monitoring ad tag 138 (such as with scroll bar 370 of FIGS. 3A and 3B), time may be added to the time limit or subtracted from the amount of time that has passed. But if the user minimizes a tab containing the self-monitoring ad tag, then the time limit may be shortened in one embodiment.

If the user's 110 activities or the time limit meet predetermined criteria, the self-monitoring ad tag 138 contacts the exchange 130 or associated server to sell the ad space before it is too late (e.g., before the user closes the browser window or goes to a new website). In this way, in one embodiment, the self-monitoring ad tag 138 supplied by exchange 130 may attempt to either resell the ad space when it becomes viewable (and much more valuable) or before the user navigates away from content (e.g., a webpage) that the ad space is within, which would result in a loss.

In one embodiment, the self-monitoring ad tag 138 contacts the exchange 130, causing the exchange to hold a real-time auction for the viewable ad space. The self-monitoring ad tag 138 may cause the computing device 112 to provide an indicator that the location of the ad tag is viewable (or engaged, which for simplification is incorporated into the “viewable” term for the purposes of this disclosure), causing the exchange 138 to indicate to bidders that the ad space is guaranteed viewable, commanding higher prices from advertising entities. In another embodiment, the self-monitoring ad tag 138 causes the computing device 112 to contact a different auction platform that is a viewable only-platform. The DSPs connecting to this platform may already know that the supply sold there is viewable, and therefore may not require another indicator regarding viewability. However, in another embodiment, an indicator may distinguish viewable and engaged ad spaces.

The exchange 130 may decline to bid on the ad space since it already owns the ad space. In one embodiment, the self-monitoring ad tag 138 contains a key that is provided to the exchange 130, allowing the exchange to authenticate the self-monitoring ad tag 138 against database records, and hold an auction while recognizing not to bid in the auction.

If there are no bidders, the exchange 130 may instead present the ad space to a predetermined list of default advertising entities (e.g., via a waterfall) that may buy the ad space at a fixed price. In one embodiment, the exchange 130 may also send the ad to a waterfall rather than RTB environment if the exchange is not able to discern the identity of the user, which could reduce the likelihood of high bids in the automated RTB auction. By using a waterfall, assuming the self-monitoring ad tag 138 causes the computing device 112 to contact the exchange before the user closes the webpage, the exchange 130 is able to resell the ad space in an embodiment.

In another embodiment, the viewable-only platform is a waterfall that does not require a real-time auction.

Once a purchaser for the ad space has been determined, the exchange may facilitate supplying the purchaser's advertisement 139 to the display device 112 for displaying at the ad space location.

e. Exemplary System Hardware Components

FIG. 2A depicts an exemplary processor-based computing system 200 representative of the type of computing system that may be present in or used in conjunction with any one or more of SSP 120, exchange 130, and DSPs 140 and 142. In one embodiment, the features of the SSP 120 and/or DSP 140 may be subsumed by the exchange 130. The computing system 200 is exemplary only and does not exclude the possibility of another processor- or controller-based system being used in or with one of the aforementioned components.

In one aspect, system 200 may include one or more hardware and/or software components configured to execute software programs, such as software for storing, processing, and analyzing data. For example, system 200 may include one or more hardware components such as, for example, processor 205, a random access memory (RAM) module 3210, a read-only memory (ROM) module 220, a storage system 230, a database 240, one or more input/output (I/O) modules 250, and an interface module 260. Alternatively and/or additionally, system 200 may include one or more software components such as, for example, a computer-readable medium including computer-executable instructions for performing methods consistent with certain disclosed embodiments. It is contemplated that one or more of the hardware components listed above may be implemented using software. For example, storage 230 may include a software partition associated with one or more other hardware components of system 200. System 200 may include additional, fewer, and/or different components than those listed above. It is understood that the components listed above are exemplary only and not intended to be limiting.

Processor 205 may include one or more processors, each configured to execute instructions and process data to perform one or more functions associated with system 200. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 2A, processor 205 may be communicatively coupled to RAM 210, ROM 220, storage 230, database 240, I/O module 250, and interface module 260. Processor 205 may be configured to execute sequences of computer program instructions to perform various processes, which will be described in detail below. The computer program instructions may be loaded into RAM for execution by processor 205.

RAM 210 and ROM 220 may each include one or more devices for storing information associated with an operation of system 200 and/or processor 205. For example, ROM 220 may include a memory device configured to access and store information associated with system 200, including information for identifying, initializing, and monitoring the operation of one or more components and subsystems of system 200. RAM 210 may include a memory device for storing data associated with one or more operations of processor 205. For example, ROM 220 may load instructions into RAM 210 for execution by processor 205.

Storage 230 may include any type of storage device configured to store information that processor 205 may need to perform processes consistent with the disclosed embodiments.

Database 240 may include one or more software and/or hardware components that cooperate to store, organize, sort, filter, and/or arrange data used by system 200 and/or processor 205. For example, database 240 may include user-specific account information, predetermined menu/display options, and other user preferences. Alternatively, database 240 may store additional and/or different information. Database 240 may also contain a plurality of databases that are communicatively coupled to one another and/or processor 205, which may be one of a plurality of processors utilized by exchange 130.

I/O module 250 may include one or more components configured to communicate information with a user associated with system 200. For example, I/O module 250 may include a console with an integrated keyboard and mouse to allow a user to input parameters associated with system 200. I/O module 250 may also include a display including a graphical user interface (GUI) for outputting information on a monitor. I/O module 250 may also include peripheral devices such as, for example, a printer for printing information associated with system 200, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 260 may include one or more components configured to transmit and receive data via a communication network, such as the Internet, a local area network, a workstation peer-to-peer network, a direct link network, a wireless network, or any other suitable communication platform. For example, interface 260 may include one or more modulators, demodulators, multiplexers, demultiplexers, network communication devices, wireless devices, antennas, modems, and any other type of device configured to enable data communication via a communication network.

### Exemplary Distributed Exchange Components

FIG. 2B presents an exemplary illustration of an exchange 130 comprising multiple RTB servers 201, 202, and 203. These RTB servers may autonomously communicate with buyers and sellers of ad space. These buyers and sellers can be SSPs, DSPs, ad agencies, trading desks, publishing desks, websites, or other entities, depending on the embodiment.

Each RTB server 201, and 202, and 203 may also be in communication with a respective user database 241, 242, and 243 in one embodiment. These user databases 241, 242, and 243 may log user activities and user statistics, and synchronize over a network 211, such as the Internet. A user database 241 may be separate from the respective server 201 so that the server 201 can more fully use its processing power to run RTB auctions and communicate with suppliers and buyers of ad space.

In one embodiment, at least one of user databases 241, 242, and 243 receive information about the user based on cookies on the user's computing device 112. In another aspect, the RTB server 201 may pass user information to the user database 241 based on information about the user supplied along with the ad space, such as by an SSP 120 inviting the exchange 130 to bid on the ad space.

In a further embodiment, when the exchange 130 purchases the ad space and supplies a self-monitoring ad tag, it may make an entry in a user database 241, logging the user and, in one aspect, the website where the ad space is located. When the exchange 130 is contacted by the user's computing device to resell the ad space, the exchange 130 may notify the database 241 to update the record to reflect that the ad space was resold.

In one embodiment, the exchange 130 may use such information to determine whether to bid on ad space for a particular user. For example, if the database 241 indicates that ad space was previously resold for that user, then the exchange 130 may bid on the ad space. However, if the database 241 indicates that a plurality of records for purchased-but-not-resold ad space exist for the user, the exchange 130 may not bid on the ad space, instead passing the ad space to a waterfall of fixed fee buyers or simply declining to bid back to the SSP 120.

### A Webpage and Browser Example of Self-Monitoring

Turning now to FIG. 3A, an exemplary illustration of a browser 320 displaying a webpage 310 on the display 300 of a computing device (such as computing device 112 of FIG. 1B) is shown. Although this example utilizes a webpage 310 for illustration purposes, this example also applies to other types of content, such as movies (e.g., an ad tag hidden behind foreground video), email (e.g., an ad tag below the fold), video games (e.g., an ad tag off screen), and other media.

In this example, advertisement 339 is visible because it is located in the visible portion 312 of the webpage 310. However, the location 338 of the self-monitoring ad tag 138 is not yet visible because it is in a non-visible portion 314 of the website that is below the bottom 322 of the browser 320 window.

As mentioned previously, the self-monitoring ad tag 138 contains code that is executed locally by a processor in the computing device 112 (e.g., a phone, tablet, television, etc.). This code may cause the processor of the computing device to monitor the status of the self-monitoring ad tag 138, as shown, for example, in FIG. 8.

The goal of the localized monitoring may be to sell and/or resell the ad space once it becomes viewable (i.e., in view), engaged (i.e., moving into view), or to sell it as a standard ad space (i.e., without regard to viewability) when monitored circumstances dictate that the user may navigate away from the content before the ad space is otherwise sold.

a. Locally Determining Viewability

Turning to FIG. 4 in conjunction with the display 300 of FIGS. 3A and 3B, at step 410 the processor determines if the self-monitoring ad tag 138 is viewable (or engaged, but for the sake of simplicity viewable is discussed). In one embodiment, the code causes the processor to determine the tag 138 is viewable if at least 30% of the tag 138 is located in the browser window 312. In another embodiment, at least half of the tag 138 must be located in the browser window 312 before the tag 138 is considered viewable. In still another embodiment, the tag 138 is considered viewable when the entire tag 138 is located in the browser window 312. In one embodiment, the tag 138 may be considered engaged when the user is moving the content in a direction that will reveal the location of the tag 138 and any portion of the location of tag 138 is above the fold.

In one embodiment, the self-monitoring ad tag 138 causes the prosecutor to determine the viewing dimensions of a browser screen by making function or procedure calls recognized by the browser. The self-monitoring ad tag 138 may also contain the dimensional information for the ad space. This dimensional information may be provided, for example, when the ad space is up for auction. The exchange 130 may send ad space dimensions as one or more parameters with the self-monitoring ad tag 138, which in turn may cause the processor to store the parameters in variables executing along with the self-monitoring ad tag 138. (A similar method may be used to provide a dynamic timing threshold with the tag 138, i.e., by retrieving timing threshold information from a database and sending it along as a parameter with the self-monitoring ad tag 138.) When executing on the computing device 112, the tag 138 may cause the browser to calculate the location of the tag dimensions relative to the on-screen dimensions of the browser. The browser may have access, for example, to the total webpage size based on the HTML or other code of the webpage. The location of the ad space may be determined within the overall webpage, which also allows the location of the ad space to be determined relative to the on-screen dimensions of the browser.

In one embodiment, the dimensions of the ad space associated with the self-monitoring ad tag 138 contain a first set of X and Y dimensions (e.g., defining a rectangular ad space). The minimum X value and the maximum X value may comprise an X-dimensional range of the ad space, and the minimum Y value and maximum Y value may comprise a Y-dimensional range of the ad space.

Similarly, the browser may report, track, and/or store a separate second set of X and Y dimensions defining a screen-space. The tag 138 may cause the browser to mathematically determine what portion of the X-dimensional range of the ad space is within the X-dimensional range of the on-screen space. A similar calculation may be made regarding the Y-dimensional ranges. The tag 138 may cause the browser to calculate the percentage of X-dimensional range of ad space within X-dimensional range of on-screen space, and the percentage of Y-dimensional range of ad space within Y-dimensional screen space. In one embodiment, if there is overlap in both the X and Y dimensional ranges, then the ad space location may be considered viewable and the self-monitoring ad tag 138 may make an ad call to the exchange 130. In one embodiment, the threshold percentage of ad space viewable, such as 30%, requires a minimum threshold of viewability along both the X and Y dimensions, such as 30% for each.

In one embodiment, the tag 138 may cause the browser to monitor changes in the on-screen X-dimensional range. If the Y-dimensional range of the ad space overlaps with the on-screen Y-dimensional range but there is no overlap in the X-dimensional range and has not been any change in the X-dimensional range, the tag 138 may cause the browser to wait a short amount of time, such as 5 seconds, before placing an ad call for non-viewable ad space. For example, if the user has scrolled down far enough for the ad space location to be in view, but it is still off screen to the left or right, then the tag 138 may check whether the user has moved the webpage to the left or right. If not, then the tag 138 may take an action based on anticipating that the user will likely not view the ad space location.

In an even further embodiment, the code causes the processor to choose the required visible portion based of tag 138 based on scrolling of the webpage 310. For example, if the user is moving the page 310 such that the tag 138 is entering the screen, only 30% of the area 338 occupied by tag 138 may need to be visible for the processor to count the tag 138 location as viewable. However, if the webpage loads with part of the tag 138 location as viewable, the code may cause the computing device 112 to wait until a greater percentage of the tag 138 location is moved into view before placing an ad call to the exchange 130. The processor of the computing device 112 may also check that the page is currently moving in a direction that will cause the tag to be further revealed when a portion of the tag 138 is viewable, before placing an ad call.

A top portion, such as 30%, of the space 338 occupied by tag 138 may also contain a default advertisement that is visible prior to the tag 338 notifying the exchange 130 to resell the ad space. For example, the top portion could advertise the exchange 130 itself in one embodiment.

In another embodiment, the tag 138 causes the computing device to count how long the webpage has been viewed by the user when the tag 138 location becomes in view. In one embodiment, the tag 138 does not cause the computing device 112 to call the exchange 138 until a certain amount of time has passed, such as 3 seconds, 6 seconds, or 9 seconds, to provide confidence that the webpage is being viewed by a user. If the webpage has been open for a period of time and the tag 138 is in view, then chances are extremely high that an actual person can view the location of the tag 138, which may command a higher price for the corresponding ad space.

b. Viewability Attributes Included with Ad Call

Continuing with FIG. 4, if the tag is viewable at step 410, then at step 438 the code of the browser may cause the computing device to contact the exchange 130 or some other RTB platform to request an ad for the space 338. The automated auction may utilize a server and/or RTB platform that is designated as viewable-only supply, guaranteeing bidders that they supply is viewable. DSPs and other purchasing entities may be configured to pay more for viewable ad space.

Additionally, the computing device 112 may include other information when contacting an RTB platform (e.g., exchange 130 or another RTB platform) that may assist in selling the ad space. For example, the computing device 112 may include an indicator of how long the user has been on the webpage. Alternatively or in addition, the self-monitoring ad tag 138 may cause the computing device 112 may indicate how long the ad space location has been in view.

As another example of viewability attributes that may be tracked by the self-monitoring ad tag 138, the computing device 112 may include an indicator that the user is scrolling the webpage and the ad space is entering the screen, i.e., that the ad space is engaged. In one embodiment, this indicator may be used by the exchange 130 to place the ad space and an even more exclusive automated auction for viewable ad space that is just becoming visible (e.g., engaged). Statistically, a user may be more likely to view or click an advertisement that is in motion and coming into the screen, and therefore ad buying entities may be configured to spend even more money on such ad placement opportunities.

In one embodiment, the tag 138 causes the browser to monitor how quickly the user is scrolling the page, and if the speed is within a range indicative of reading (e.g., an average of 1 line per 4 seconds) an indicator that the user is reading is supplied to the exchange in an embodiment. In still another embodiment, the tag 138 causes the browser counts the text words per line and calculate a reading speed based on number of words and average scroll speed (e.g., 250 words per minute). If the calculated reading speed falls within a range (e.g., 100 to 100 words per second), then an indicator that the user is reading is supplied as part of the communication to the exchange in an embodiment. In one embodiment, the scroll speed is calculated at predefined intervals, such as every 5 seconds. In another embodiment, the tag may determine the scrolling speed at the time that it determines the tag 138 is viewable, such as by determining how much time has elapsed since the tag 138 became active and how far down the page has moved in that time.

c. Other Contextual Information Included with Ad Call

Other information about the user, such as a User ID, may be supplied by the browser when contacting the RTB platform (e.g., exchange 130) to resell the ad space. The exchange 130 may correlate this User ID with further information about the user through use of one or more user databases, for example, as illustrated in FIG. 2B.

The code of the self-monitoring ad tag 138 may cause the browser to retrieve and send context-specific information to the exchange 130 when the tag 138 triggers resale of the ad space at step 438. For example, turning to FIG. 3A, the browser may send text 340 that is next to or nearby the ad space 338. This text 340 may be very likely to be read by the user and directly relevant to advertising entities that may have related advertisements to place in front of the user, which could programmatically cause those entities to submit higher bids.

The tag 138 may cause the processor to determine which text is near the ad space 338 by parsing the website code, such as HTML. For instance, the processor may determine that the tag 138 is positioned next to text even though it is in a different iFrame or other divider element, based on that divider element's positioning in a table cell directly next to text, which may be in an adjacent cell. Alternatively, the processor may determine that the tag 138 is positioned next to text when both are in the same table cell or divider element.

If there processor determines there are two or more groups of text that are nearby the tag 138 in different divider elements, the text groups may be ranked based on which text is most likely featured the most for user viewing (which, in turn, equates to that text being the most likely text the user is reading). For example, in FIG. 7, text at the center of the webpage 310, such as text 340, is more likely to be read than text on an outside column, which may be unrelated to the main topic on the webpage.

Additionally, some text may be of larger font size than others, making it more featured and, in turn, more likely to be what the user is reading. For example, text that is “H1” size, indicating a heading, may be included with the ad call when the tag 138 causes the computing device 112 to contact the exchange 138. In one embodiment, heading text is always included, within a character maximum such as 50 characters. In an embodiment that decides which nearby text to include, the larger text may be determined to be the most featured and may be included with the ad call to exchange 130.

Specific to the example of FIG. 3A, the text “Georgia Tech wins again” may be part of a heading, which may be labelled H1 in the HTML code. Consequently, the self-monitoring ad tag 138 may cause the computing device to supply the text to the exchange (which may include an additional server for reselling the ad space). A sports company interested in selling a product or service to a Georgia Tech fan may bid in and ultimately win the auction. Then, as shown in FIG. 3B, the sports company ad 337 may be placed at the ad space, and may be relevant to the surrounding text being consumed by the user.

In one embodiment, the tag 138 may parse and remove words unlikely to convey contextual information from the nearby text, such as common pronouns and conjunctions, before passing this text to the exchange 130 in an ad call. This may reduce the amount of text that needs to be parsed by exchange 130 or any potential buyers of ad space, which in turn may allow more processing time for an RTB auction.

The computing device 112 may supply an indicator to notify the exchange 130 that this is a resale in one embodiment. This may allow the exchange 130 to bypass logic normally in place to determine that the ad space is associated with a real user and not a bot, since that logic may have already been employed prior to exchange 130 purchasing the original ad space. In one embodiment, the indicator may also cause the exchange 130 to bypass the RTB auction and/or not bid on the ad space itself (having already done so), instead directly providing the ad space to a waterfall platform in which the ad space is placed by soliciting acceptance from a predetermined set of buyers. In still another embodiment, the self-monitoring ad tag 138 cases this computing device 112 to contact the exchange 130 at an interface 260 that is pre-configured to bypass the RTB auction and route the ad request directly to the waterfall platform. In some instances however, the exchange 130 will utilize the RTB auction for reselling non-viewable ad space, such as when additional context makes it likely that the RTB auction will fetch a higher price than the waterfall platform. For example, if the User ID is now known, it is likely that the ad space will be worth more in the RTB auction.

Other contextual information that may be provided by the computing device 112 at step 440 of FIG. 4 includes an indicator of why the ad space was resold prior to it becoming viewable. If the ad space was resold prior to the time threshold expiring (e.g., in anticipation of the user navigating away from the webpage), then the amount of time that the user was on the webpage may be included. This information may be tracked in a database by exchange 130, and utilized to better determine which self-monitoring ad tag to supply for that webpage and/or user in the future. I

Still other contextual information that may be provided by the computing device 112. At step 440 of FIG. 4, the contextual information may include information similar to that already described with regard to step 438. Additional information may include how long the user has been viewing the content.

Content in proximity to the bottom of the screen 322 may also be provided, as this may allow for prediction of what content is relevant to the ad space 338 that is still below the fold 314. In one embodiment, such key words may be used to solicit bids from advertisers who may have ads directly relevant to the webpage content, for example as outlined with regard to step 438.

d. Activity Trigger Examples

Continuing with FIG. 4, if the tag is not yet viewable and/or engaged, then monitoring continues at steps 420 and 430. At step 420, the tag 138 causes the browser to check for activity triggers, which could positively or negatively impact the likelihood that the user will navigate away from the webpage without viewing the ad space 338. In one aspect, if the user is about to navigate away from the website, the tag 138 contacts exchange 130 to resell the ad space before it is too late to do so.

Possible activity triggers indicative of the user potentially navigating away from the website 310 or closing the browser 320 altogether include detecting that the user's pointer is on the browser control bar 316, that the pointer is in proximity to the navigation controls 366, that the pointer is in proximity to the close browser controls 350, and/or that the user is typing in the address bar 364. Further detectable activities that may weigh in favor of reselling the ad space before it becomes viewable include detecting that the user is active in a tab 362 other than the tab 360.

e. Time Threshold Examples

Continuing with FIG. 4, at step 430 the processor of the computing device 112 may check whether the ad space 338 of self-monitoring ad tag 138 should be sold (e.g., resold) based on the amount of time that has passed without the tag 138 becoming viewable. In one embodiment, when the self-monitoring ad tag 138 becomes active (e.g., when the webpage initially loads), a time variable may be initialized by the processor of the computing device. The time variable may start at zero at one embodiment, and count upwards towards a threshold, such as 20 seconds. Conversely, in another embodiment, the variable may be initialized at a value, such as 20, and count down towards a threshold such as 0 at a rate of 1 per second. If the tag 138 has not become viewable (e.g., at least a portion of tag 138 has not been above the fold) when the threshold is met or exceeded, then the processor may contact the exchange 138 to sell (e.g., resell) the ad space.

Facilitating placement of the self-monitoring ad tag 138 may include one of supplying a time threshold parameter for use with the tag 138 or selecting a tag 138 from a plurality of tags having different pre-coded timing thresholds.

In one embodiment, the time threshold may be dynamically specified by exchange 130 based on prior user activity and/or prior activity of a plurality of users with regard to the content (e.g., the website). For example, when the exchange 130 causes the self-monitoring ad tag 138 to be placed on the website (as discussed above in conjunction with FIGS. 1A-1B and below with regard to FIG. 9, step 1030), a timing parameter included with the tag 138 may include a time value for initializing the timer or time threshold. That time threshold value may be selected based on information available in database 240 and/or user databases 241, 242, and/or 243. In another embodiment, supplying the time threshold as a parameter includes supplying a different tag altogether with a particular time threshold pre-coded into it.

As an example, certain webpages may have a history of triggering resale based on time expiring before the ad space is viewable in a relatively high percentage of instances in comparison to the number of times the ad space is not resold at all and/or in comparison to the number of times the ad space is resold as in view. A process that runs on hardware that is part of or associated with exchange 130 may detect that this ratio is outside of a threshold range, and cause exchange 130 to adjust the time value to lower the ratio of resales that occur based on timeouts when the ad space is non-viewable versus based on the ad space becoming viewable. This process may run incrementally, such as at the end of the day, and update a time threshold table of time threshold values associated with various websites in one embodiment, allowing the exchange 130 or associated hardware to create and provide self-monitoring ad tags with different time thresholds.

In another embodiment, if historical data reflects that a particular ad is likely immediately viewable, a lower time threshold may be selected. For example, if database records indicate a particular ad space identifier was immediately resold as viewable, then the exchange 130 may select a small time threshold for use as a parameter or supply a self-monitoring ad tag 138 with a small time threshold, such as 5 seconds (or, in one embodiment, 1 second). If that selection results in a resale based on viewability (including engaged), then, in one embodiment, this is logged in a database. The next time that ad space identifier, the exchange 130 may, based on the database indicator, attempt to purchase that ad space as a guaranteed viewable (i.e., “known viewable”). Treatment of “guaranteed” or “known viewable” ad space is addressed in more detail herein.

In another embodiment, the time threshold table instead associates each website and/or webpage with one of a plurality of time categories. Each time category may be associated with a different self-monitoring ad tag having a different pre-coded timing threshold. Alternatively, a pre-determined set of timing thresholds may be available to select and supply as a parameter with the self-monitoring ad tag 138. For example, there may be five different categories, corresponding to self-monitoring ad tags with time thresholds of 5, 10, 20, 30 and 40 seconds respectively. The exchange 130 may select a corresponding link to provide the SSP that correlates to the selected self-monitoring ad tag 138 having the time category associated with the website and/or webpage where the ad space is for sale. Alternatively, supplying the custom tag 138 may including supplying the respective time threshold as a parameter for use with the self-monitoring ad tag 138. Thus, a self-monitoring ad tag 138 with a tailored time threshold may be placed on that website and/or webpage.

In another embodiment, similar logic may be incorporated for supplying a self-monitoring ad tag with a custom timing threshold based on user history. For example, if database records indicate that ad space (identified by an ad space identifier) is not resold a relatively high percentage of the time (e.g., greater than 15%) for a particular user, then the exchange 130 may be automatically configured to supply a self-monitoring ad tag 138 with a lower-category time threshold to that user. For instance, even if the website indicates sending a category 4 tag (e.g., 30 second threshold), the user data may cause the exchange 138 to link to or supply a category 2 tag (e.g., 10 second threshold). Conversely, user data indicating a relatively high rate of reselling ad space before it becomes viewable (e.g., greater than 40%) and low percentage of unsold ad space for that user (less than 5%), may cause the exchange 138 to select a higher category tag in an attempt to increase the chances that the ad space is resold as viewable.

Alternatively, the database computations used in selecting a self-monitoring ad tag may be tied to the CPM to viewable ratio. In one embodiment, an ad space identifier associated with a low ratio, such as 3/1, may cause the exchange 130 to select a self-monitoring ad tag with a longer time threshold, such as 40 seconds (i.e., to give the user longer to reveal the ad space). On the other hand, an ad space identifier associated with a high CPM to viewable ratio, such as 20/1, may cause the exchange 130 to select a self-monitoring ad tag with a relatively low time threshold, such as 7 seconds (i.e., to reduce the chances that the user navigates away before the ad space is sold/resold).

Once the tag 138 is active on the user's website, certain detected activities may cause the processor to decrease the amount of time remaining before the ad space is resold. For example, when the user is active in another tab 362 that does not contain the ad space 338 of self-monitoring ad tag 138, the tag 138 may cause the processor to reduce the amount of time remaining before the processor resells the ad space prior to it becoming viewable. In one embodiment, when the user's pointer is close to or entering the control bar 316 of the browser, the time is reduced. In a further embodiment, when the user is scrolling away from the ad space 338 of the self-monitoring ad tag 138, then the time is reduced. The amount of time reduced may vary by embodiment.

Conversely, other detected activities may cause the processor to increase the amount of time left before the ad space is resold prior to becoming viewable. For example, if the user switches back to the tab 360 containing the webpage 310 with the self-monitoring ad tag 138, or that the user is active on the webpage 310 containing the tag 138, such as by detecting that the user is scrolling the webpage 310 with or without scroll bar 370.

Other activities may cause the processor to pause or reset the timer. For example, if the user is scrolling the page toward the ad space in the X or Y direction, the timer may be paused, reset, or the time left may be otherwise increased, depending on the embodiment.

Once the time threshold has been met or exceeded without the ad space 338 at self-monitoring ad tag 138 becoming viewable, the processor causes the user's computing device 112 to contact an RTB platform to resell the ad space (even though it is not yet viewable). The RTB platform may be the same exchange 130 that won the RTB auction resulting in placement of the self-monitoring ad tag 138 in one embodiment.

### Verification Features

In some embodiments, it may be important to verify that the ad spaces being sold or resold as viewable via triggers by the self-monitoring ad tags 138 are remaining in view after an advertisement has been placed at the ad space. For example, a third party may desire such statistics to justify the higher price of ad space sold in a viewable-only auction or waterfall.

To facilitate this, in one embodiment, the self-monitoring ad tag 138 may contain additional embedded tags (e.g., code) within the self-monitoring ad tag 138. One such example is presented in FIG. 5, which illustrates an exemplary self-monitoring ad tag 138 containing a first embedded tag (i.e., first code portion) that may monitor events and trigger a sale (e.g., resale) of the ad space associated with the first embedded tag. However, even if this first embedded tag is replaced by an advertisement, the self-monitoring ad tag 138 may have one or more additional embedded tags that continue to monitor status for verification purposes.

In the example of FIG. 5, a second embedded tag 452 may remain to report to a database 241 associated with exchange 130 for tracking how long the tag remains viewable. In one embodiment, the second embedded tag 452 makes periodic calls, such as every 2 seconds, to database 241 with an ad space identifier for the original ad space and a time stamp since ad was viewable. The database may store this information with the ad space identifier, and continue to update the table(s) based on further communications received. The second embedded tag 452 may continue to report every specified interval, such as 2 second, until the user navigates away from the content and/or the tag becomes unviewable, so that the final entry in the database 241 reflects how long the ad was viewable (e.g., engaged).

In one embodiment, the second embedded tag 452 also provides the amount of time that passed before the tag 138 location became viewable. If this number is consistently low, or close to zero seconds, this may indicate that the ad space associated with that ad space identifier is on the screen as soon as the page loads, and should be purchased by the exchange nearly every time.

In one embodiment, the second embedded tag 452 also provides the ad type on an initial call to database 241. The ad type could be, for example, viewable or engaged. A user ID may also be reported on the first call, such that the database 241 may be able to isolate any inconsistencies on viewability to a particular user ID that is actually not a human (e.g., a bot). In still a further embodiment, the second embedded tag 452 may report the size of the advertisement on the initial call. This may be useful in isolating viewability inconsistencies that may arise from the advertisement being too small or too large.

A nightly or hourly process may aggregate the database information for a particular ad space identifier. Based on the aggregate results, this process may flag certain ad space identifiers in the database 241 so that when the exchange 130 encounters that ad space identifier in a future ad call, the exchange 130 may recognize the associated ad space is a “false” viewable that should not be purchased (for example, if the viewability reporting indicates that it is rarely viewable for more than a second). Conversely, a different flag (e.g., value stored in a database table) may indicate that the ad space is should be treated as instantly viewable as soon as the page loads, and purchased nearly every time by the exchange.

In still another embodiment, the self-monitoring ad tag 138 may include a third embedded tag 454 that performs similar monitoring to that of the second embedded tag 452, but is controlled by a third-party entity and not the exchange 130. For example, the third tag may be selected from a third party as an independent verifier of the viewability of the ad space and/or to report how long the webpage was active after a viewable ad was placed at the location of the second tag. Thus, whereas the exchange 130 may control the second embedded tag 452 as a means to verify viewability post ad placement, and the first embedded tag 450 may perform the monitoring described herein and ultimately be replaced by an advertisement at the resold ad space, the third embedded tag 454 may be code supplied by a third party for data verification.

In one example, the exchange 130 may programmatically select code to provide for the third party data verification based on the advertising entity purchasing the ad space. For example, a particular ad purchasing entity (e.g., DSP) may specify a particular verification entity to validate its viewable ad purchases through the exchange 130, and this association may be stored in a database accessible to the exchange 130 so that the exchange may retrieve a link to code for the third embedded tag 454 based on the purchaser of the ad space. For example, the database may contain a table with a purchaser ID and a link for that purchaser ID that corresponds to the applicable third embedded tag 454.

In one embodiment, the exchange 130 may select a second embedded tag 452 from amongst a plurality of second embedded tags based on the third embedded tag 454 associated with the buyer of the ad space. For example, the exchange may pair its own verification tags (i.e., second embedded tags) based on additional insights that could be gained over the relevant third party tag (i.e., third embedded tag 454). For example, by selecting a second embedded tag 452 that reports similar but more detailed (e.g., on a smaller time interval and/or additional reporting details) than the third-party verification tag 454, a process running on database 241 may be able to programmatically identify any viewability verification issues before the third party does, or provide additional information to explain any anomalies determined by the third party.

Turning now to FIG. 9, exemplary automated steps for viewability quality control are illustrated. At step 810, a user computer device 703 that executes a second embedded tag 452 (e.g., provided with the self-monitoring ad tag 138, as exemplified in FIG. 5) may cause the computing device to call a database once every time interval, such as once every two seconds. The call may include the ad space identifier and/or user ID, and allow a database coupled to exchange 130 to determine that the placed advertisement is still viewable. In one embodiment, the timed call only occurs once the advertisement has been placed at the ad tag location, and only continues while the advertisement remains viewable. In another embodiment, the timed call may include the percentage of the advertisement that remains viewable.

In one embodiment, at step 812, the second embedded tag 452 may cause the computing device to supply an indicator that the tag 138 location is no longer viewable. This indicator may be provided with the timed call 810 in one embodiment, so that the database may track both the time viewable and the amount of time that the user remained on the webpage.

In another embodiment, at step 814, the second embedded tag 452 may cause the computing device to report user activity discussed herein, such as the user minimizing the tab, such that the database may contain enough data to analyze why the advertisement became non-viewable.

At step 816, a quality control database may receive a viewability tracking call from a computing device, such as the calls made related to steps 810, 812, and 814. Various information described herein may be included in the call. In one embodiment, the information may include an ad space identifier so that the database 802 may store a record keyed to the ad space identifier. Other potential information includes a user ID and a timestamp (e.g., the value of a counter).

At step 818, the database 802 may store the received information. In one embodiment, the database 802 maintains a single record for the combination of the ad space identifier and user ID, and updates the record with the most recent timestamp. In another embodiment, the timestamp is not provided but instead the database 802 query includes a procedure call to return a timestamp (e.g., the current time), and the database does the math to add to an existing time tally for that record.

At step 820, a process may run that aggregates the information stored in the database for each ad space identifier. For example, at a down-peak time, such as 3:00 AM at the location of the database, the process may, for each unique ad space identifier, determine median values for the amount of time viewable after ad placement. The process may take this information and update a table containing past aggregate data for ad space identifiers. In one embodiment, a new aggregate value is calculated by multiplying the previous aggregate value by a number X, such as 6, multiplying the new median value by a number Y, such as 1, adding those results together, and then dividing by (X+Y) (e.g., 7). However, the process may also check whether the new median is more than a threshold (e.g., 2 seconds) different than the past aggregate. If there is more than a threshold difference, then the process may replace the prior aggregate with the new median.

In one embodiment, the process calculates a different value than a median, such as a standard deviation, average, percentage above or below a time threshold, or another metric to measure sustained viewability.

In still another embodiment, a similar process is performed for each unique user ID. In this way, viewability may be separately verified for users, which may help determine if a particular user is actually an automated process, such as a web crawler or a bot. In one embodiment, if the aggregate average or median sustained viewability for a user ID is less than a threshold (e.g., 2 seconds) over a second threshold number of transactions (e.g., 10), the database may update a table to indicate that the exchange 130 should not attempt to place a self-monitoring ad tag 138 for that user ID and/or that user ID should not be incorporated into the viewable-only RTB platform.

In yet another embodiment, the process calculates aggregate sustained viewability by user ID prior to calculating similar data per ad space identifier. In that embodiment, the process may identify an avoidance set of user ID's that are likely to correspond to web crawlers or bots rather than a human, based on an average sustained viewability of zero or less than a threshold, such as 2 seconds. The process may then perform aggregation on the ad space identifiers while excluding records from the aggregation that are attributable to a user ID within the avoidance set of user IDs.

At step 822, the process may cause the aggregate viewability record to be stored in a separate table, keyed to an ad space identifier. In another embodiment, aggregate viewability records are also stored based on user IDs.

At step 824, when the exchange 130 may check aggregate records(s) based on ad space identifier and/or user ID for a number of reasons. For example, the exchange 130 may check these records to determine whether to bid on ad space having a particular ad space identifier and/or being presented to a particular user ID. If aggregate records indicate that the ad space is unlikely to ever be viewed or the user ID is likely associated with an automated process rather than a person, then the exchange 130 may elect to no bid on the ad space.

At step 826, the exchange 130 may also update the viewability database when it purchases ad space for resale to a particular user. This may involve sending information to the viewability database regarding the self-bid placed by the exchange 130. For example, the exchange may relay the ad space identifier, the user ID, and the bid amount in one embodiment. This may be stored as a purchase record and later updated by the viewabililty database upon receiving indication that the ad space was resold. If it is not resold, the automated process may detect that the record was never updated, and use such non-updated records as a way to count the number of times that ad space was not resold for a particular ad space id and/or user id.

In one embodiment, the second embedded tag 452 may make a timed call to the database, such as at step 810, such that the viewability database may track whether any time at all lapsed before a user (potentially a bot) navigated away from the content within which the ad space was located. In such an embodiment, the viewability database may update the purchase record to store how long the purchased ad space was present before it became viewable (or before the user navigated away), similarly to as previously described with regard to step 810.

In one embodiment, if the amount of time it was present is close to zero and the viewability rate is high, then the automated process may flag the ad space identifier as being in view upon page load. This may allow the exchange 130 to automatically decide to purchase the ad space associated with the ad space identifier in the future.

In one embodiment, the automated process may aggregate the timing information to programmatically update the database regarding which self-monitoring ad tag the exchange 130 should select for a particular ad space identifier and/or user ID. For example, the process could determine the maximum amount of time that passed in a threshold percentage of cases for a particular ad space identifier, such as 75%, and ensure that the exchange 130 is selecting a self-monitoring ad tag 138 having a time threshold that is equal to or less than the amount of time associated with the threshold percentage. This may help ensure that the ad space is resold a threshold percentage of the time, making profitability more predictable.

### Example Flow Charts for Dynamically Placing a Self-Monitoring Ad Tag

Turning now to FIG. 6, an exemplary flowchart of steps performed by an exchange 130 to place a self-referencing ad tag for execution by a user's computer, in accordance with an embodiment is presented.

At step 510, the exchange 130 may receive a request for a bid on available ad space (i.e., supply). The request may be submitted by a publisher, such as an SSP, publishing desk, or a particular website in one embodiment. Upon receiving the request, the exchange 130 may validate the supply through methods described herein.

If the supply is acceptable for selling in a real time auction, the exchange 130 may hold a real-time auction. In such cases, the exchange 130 may perform an RTB auction as described herein. Generally, this may involve soliciting bids from demand-side entities, such as DSPs and advertising trading desks.

In other cases, the RTB auction may be bypassed. For example, when the request for a bid includes an indicator that the exchange 130 already owns the ad space via a previous RTB auction, the exchange 130 may bypass the RTB auction and send the supply to a waterfall platform (though this is not always the case, as previously described). As another example, the exchange 130 may detect that the ad space will be in view as soon as the webpage loads, based on records it has stored in a database in accordance with an embodiment. In that case, the exchange 130 may wish to purchase the inventory prior to reselling it in its own real-time auction.

At step 520, the exchange 130 may bid on the ad space if certain conditions are met. For example, if the exchange 130 recognizes the user (e.g., based on a User ID or IP address) and/or the webpage where the ad space is located, the exchange 130 may place a bid on the ad space. In another embodiment, if the RTB auction does not receive any bids, the exchange 130 may purchase the ad space.

In still another embodiment, the exchange 130 may base the decision to bid at least in part on a database table that tracks results for ad space purchased by the exchange 130. For example, each time the exchange 130 bids for and wins ad space, the exchange 130 may cause a record to be stored in a table of that user and the ad space purchased and the category of self-monitoring ad tag 138 supplied. Once the ad space is resold, the exchange 138 may update the database record to indicate that the ad space was resold. By doing this, the exchange 138 may be able to statistically gauge the relative success of past attempts to buy and resell ad space associated with a particular user and/or webpage. For example, if more than a threshold number of unsuccessful resells, such as five, exist for the user, then the exchange 130 may elect to not bid. Conversely, if the database table indicates past successes at reselling the ad space for that user and/or website, then the exchange 130 may place a bid.

The bid may be at or below a known prior sale price for that user, which may be stored in a database accessible by the exchange 130, in one embodiment. In another embodiment, whether the user is known or unknown, the exchange 130 may place a bid at or below a known waterfall platform price. By bidding below a fixed waterfall platform price, this may increase chances that the exchange 130 can resell the ad space at a profit even if it does not come into view on the user's browser.

Other examples disclosed herein involving the exchange 130 using a database to determine the likelihood of viewability for a particular ad space identifier or User ID may also be incorporated in determining whether to self-bid on the ad space for a particular user.

When the ad space is being sold by an SSP 120, the exchange 130 bid is passed back to the SSP 120, which determines the overall winner of the RTB auction occurring at the SSP 120. The exchange 130 may also provide a link to the self-monitoring ad tag 138 along with its bid. As previously described, this link may be selected based on a selection of one of a plurality of different self-monitoring ad tags most appropriate for the user and ad space (e.g., to choose an optimal time limit for triggering resale). If the exchange 130 wins the RTB auction at the SSP 130, the SSP may utilize the link to retrieve the self-monitoring ad tag 138.

At step 530, if the exchange 130 is the high bidder for the ad space, the exchange 130 may provide code for a self-monitoring ad tag instead of an advertisement. In one embodiment, the SSP 120 retrieves the self-monitoring ad tag 138 from the link supplied with the bid by the exchange 130. In another embodiment, the exchange 130 supplies the self-monitoring ad tag to the SSP 120 and/or the user's computing device 112.

Monitoring of user activities may occur locally without any input or communication with a server.

Then, at step 540, the exchange 130 may receive a request from the user's computing device to resell the ad space. This request may be triggered by the self-monitoring ad tag 138 that is executing on the user's computing device 112. In one embodiment, the server contacted to resell the ad space when the ad space is in view is different than the server utilized by the exchange 130 for the original RTB auction. This server may have access to a database updated by the original server, such that the resale attempt may be further documented. In another embodiment, the request is received by the same server that held the original RTB auction.

The request may indicate that it is a resell request. This may allow the exchange 130 to proceed knowing that the ad space was previously vetted and, in one embodiment, that the exchange 130 should not bid in response to the request.

An indicator of whether the ad space is viewable may also be supplied. This indicator may distinguish between ad space that is coming into view and ad space that was in view originally. This is because ad space coming into view may be worth even more in an RTB auction.

At step 550, the exchange 130 may analyze the indicator to determine whether the request indicates the ad space is viewable, viewable and moving, or not yet viewable.

At step 555, if the ad space is not yet viewable, the exchange 130 may send the supply (i.e., ad space) to a default waterfall platform to sell the ad space to one of the entities in the waterfall. Alternatively, the exchange 130 may send the supply to an RTB auction if additional contextual information indicates the exchange 130 is likely to resell in the RTB auction for an amount higher than the fixed purchase prices in the waterfall platform.

On the other hand, at step 560, if the request indicates the ad space is partially viewable or partially viewable and moving, the exchange 130 may hold an RTB auction to resell the ad space. In one embodiment, the RTB auction is on a viewable-only auction platform that is different than the original RTB auction platform through which the exchange 130 acquired the self-monitoring ad tag. In one embodiment, the viewable-only RTB auction is held on a different server than the viewable-neutral RTB auctions.

The exchange 130 may also have a viewable-only waterfall platform specific to viewable ad space. In this embodiment, as shown in step 565, the exchange 130 may send the ad space to the viewable-only waterfall if the high bid in the viewable-only RTB auction is less than known default values in the viewable-only waterfall.

At steps 570 and 580, the advertisement is retrieved and transmitted to the user's computing device 112. For example, at step 570 a winning bidder in the RTB auction may supply a link to the advertisement, which the exchange 130 or an associated server may retrieve and supply, at step 580, to the user's computing device 112. Similarly, the exchange 130 may be supplied with a link or the advertisement when a purchasing entity in the waterfall platform buys the ad space.

When the advertisement is supplied to the user's computing device 112 at step 580, it may take the place of the self-monitoring ad tag 138 in one embodiment. In another embodiment, the exchange 130 may supply a cookie along with the advertisement to track and obtain additional information about the user.

Further Exemplary Flow Charts for Determining when to Self-Bid

Turning to FIG. 7, additional exemplary steps performed are illustrated relative to the exchange 130 determining to place a bid on the ad space, in accordance with an embodiment.

At step 602, the exchange 130 may receive a bid call (i.e., request to bid or sell the ad space), which may include an ad space identifier that is unique to the ad space being sold, as well as information identifying a user who will potentially view an ad placed at the ad space. In one embodiment, the exchange may determine the user ID based on the user information, such as by referencing a database table that links the user information (e.g., a supply-side user ID, cookie ID, or unique IP address) to a user ID used by the exchange 130.

Armed with this information, at step 604 the exchange 130 may check the database to determine whether the ad space is “known viewable,” i.e., expected to load as viewable as-soon-as the content is presented to the user. The database may contain a table where known viewable ad space identifiers are stored, or there may be an indicator stored in some other table associated with ad space identifiers that indicates the ad space identifier is “known viewable.” In one embodiment, the exchange 130 may also check to make sure that the user ID is not flagged as a bot, web crawler, or other non-human entity.

If the exchange determines that the ad space identifier is known viewable and the user is not a non-human entity, then the exchange may skip to step 625 and purchase the ad space. In another embodiment, the exchange 130 may hold a real-time auction for viewable-only inventory and return a bid to the SSP that is lower than the winning bid, such that the exchange 130 may earn an extra commission for identifying the ad space as “known viewable.”

Otherwise, at step 610, the RTB auction may begin at the exchange 130.

At step 620, the exchange 130 may determine whether any bids have been placed on the ad space.

If no bids were placed, then at step 625, the exchange 130 may bid on the ad space for less than a default waterfall price in one embodiment. In another embodiment, the exchange checks a database of resale history for the particular user and/or webpage before placing the bid, as previously described. From there, exemplary steps continue at FIG. 6, step 530, also described above.

If one or more demand-side entities bid on the ad space, then at step 1130 the exchange may look for recent historical results of purchasing and attempting to resell ad space for the particular user and/or website. If the history is favorable (i.e., indicating that the ad space is usually resold at a price higher than the current max bid), then the exchange 130 may place a competing bid on the ad space at 640. Otherwise, at step 635, the exchange 130 may refrain from bidding and supply the highest bid from its RTB auction to the SSP.

The SSP may then notify the exchange 130 if it supplied the winning bid at step 650. If it the high bid from the exchange 130 did not win, then nothing may happen.

If the high bid from the exchange did win but it was not the exchange's 130 own bid, then at step 670 the exchange 130 may notify the winning bidder and supply the SSP 120 with a link to the winning bidder's advertisement (if such link was not already provided to the SSP 120 with the bid). In another embodiment, at step 680, the exchange 130 may receive and transmit the advertisement to the computing device associated with the ad space.

If the exchange's 130 own bid won, then the exemplary steps may continue at FIG. 6, step 530, discussed above.

### Further Multi-Entity Flow Charts for Viewable Ad Space Markets

Turning now to FIG. 8A, a flowchart is illustrated that has exemplary steps from multiple entities that may be involved in the entire process or buying and reselling ad space, including an SSP 120, an exchange 130, DSPs 140 and 142, and a user computing device 112. In an embodiment, the SSP performs steps in collection 701, the exchange performs steps in collection 702, the user's computing device performs steps in collection 703, and one or more DSPs perform steps in collection 704.

The process may include three separate real-time auctions, including an SSP auction 700a, an original exchange auction 700b (e.g., to determine a bid to enter into the SSP auction 700a), and a resale auction 740 (which may occur at the exchange 130 or some other auction platform associated with the exchange 130).

At step 700, an SSP 120 contacts the exchange 130 to request a bid for add space (i.e., supply) available at a location visited by a user, in accordance with one embodiment. In another embodiment, a different supply-side entity contacts the exchange, such as a pro

In response to the request, at step 710, the exchange 130 may hold an RTB auction to solicit bids on the supply (i.e., ad space).

At step 715, the exchange 130 may place its own bid in its RTB auction for the supply. The decision to bid may be reached in view of a combination of factors described herein. If the exchange 130 RTB auction is not part of a larger auction (such as an RTB auction by the SSP), the exchange 130 may determine the overall winning bidder on the ad space. Otherwise, the exchange 130 sends the high bid to the SSP 120, which treats that high bid as a competing bid in the SSP auction. In this instance, at step 720, the SSP determines the winner of the SSP auction.

At step 725, if the bid placed by the exchange 130 wins the auction for the ad space, then either the exchange 130 or the SSP 120 provides code for the self-monitoring ad tag 138 to the computing device 112. For example, the SSP 725 may retrieve the self-monitoring ad tag 138 based on a link previously provided to the SSP by the exchange 130 along with the exchange's 130 bid. In another embodiment, the SSP may store the link as a way to troubleshoot issues, but the exchange 130 ultimately may provide the code at the link to the user computing device 112.

The above steps may all occur within 150 ms of the user attempting to access a webpage on the computing device 112.

At step 730, the webpage loads on the user's computing device 112, now containing the code of the self-monitoring ad tag 138. As a browser application interprets and causes the processor to execute the code of the webpage, the code of the self-monitoring ad tag 138 is read by the browser application and executed by a processor in one embodiment. This code may cause the processor to monitor for events discussed above, including whether the ad space at the tag 138 is viewable or whether the ad space should be resold prior to it becoming viewable.

At step 735, the processor on the user's computing device 112 determines whether the self-monitoring ad tag 138 is viewable and/or engaged. If it is not, then at step 745 the processor on the user's computing device 112 determines whether the ad space should be resold prior to becoming viewable, for example, by analyzing activities and/or a time limit on how long to wait before reselling. If no such immediate sales triggers are met, the processor may continue to monitor according to steps 735 and 745, such as in a looped fashion.

If the processor determines the tag is viewable at step 735, this may cause the user's computing device 112 to contact an exchange platform, such as exchange 130, to request bids and/or resell the ad space. In one embodiment, the code of the self-monitoring ad tag 138 may include a call to a specific server responsible for a viewable-only RTB auction, such as a server controlled by exchange 138. In another embodiment, the call may include an identifier that the exchange 138 uses to validate the request and confirm that the ad space is being resold. The code of the self-monitoring ad tag 138 may also cause the processor to gather information about the user and transfer this information to the exchange 130 as part of the call to the exchange 138 to resell the ad space.

For viewable supply, at step 740 the exchange 130 may solicit bids specifically for viewable supply. In one embodiment, this includes an RTB auction at an auction platform that is only used to auction viewable ad space. In another embodiment, the exchange 138 uses an RTB auction platform that is not exclusive to viewable-only ad space, but supplies bidding entities with an indicator that the ad space is viewable. In another embodiment, the exchange 138 might also indicate that the ad space is moving into view (e.g., an engaged ad). The exchange 138 may also provide additional learned information, such as user data from the exchange 138 database or user data received from the computing device 112 when it contacted the exchange 138 to resell the ad space.

At step 760, DSPs then bid on the viewable ad space.

At step 765, the exchange 138 determines the winner of the RTB auction for the viewable ad space, and sends the winner's advertisement to the user's computing device 112. At step 770, the advertisement may be displayed as part of the webpage on the user computing device 112.

If, on the other hand, at step 745 the processor on the computing device 112 determines the ad space should be resold prior to becoming viewable, this may cause the user's computing device 112 to contact an exchange platform, such as exchange 130, to resell the ad space. In one embodiment, the code of the self-monitoring ad tag 138 may include a call to a specific server responsible for reselling supply that is not yet viewable, such as a server controlled by exchange 138. In another embodiment, the call may include an identifier that the exchange 138 uses to validate the request, recognize that it already owns this ad space, and/or route the sale to the default waterfall (i.e., bypassing an RTB auction). The code of the self-monitoring ad tag 138 may also cause the processor on the computing device 112 to gather information about the user and transfer this information to the exchange 130 as part of the call to the exchange 138 to resell the ad space.

At step 750, the exchange 130 may sell the non-viewable supply in response to the ad call placed by the user computing device 112 in response to an immediate sell trigger at step 745. This resale may take place in another RTB auction, or the exchange 130 may utilize a waterfall process described herein.

In one embodiment, the exchange 130 may determine that the learned information, such as a confirmed User ID, justifies reselling the non-viewable supply in an RTB auction based on a likelihood that higher bids will be possible than in the first RTB auction in which the exchange 130 had the winning bid.

If the exchange 130 routes the supply to an RTB auction platform, at step 1240 the exchange 130 may solicit bids specifically for viewable supply. In one embodiment, the exchange 138 uses an RTB auction platform that is not exclusive to viewable-only ad space, but refrains from bidding itself since it already purchased the ad space and failed to resell it as viewable. The exchange 138 may also provide additional learned information, such as user data from the exchange 138 database or user data received from the computing device 112 when it contacted the exchange 138 to resell the ad space.

Alternatively, at step 750 the exchange 130 may send the ad space to a default waterfall where a DSP may purchase it at a fixed price, effectively bypassing step 760.

Once the ad space has been resold, then at step 765, the exchange 138 sends the winner's advertisement to the user's computing device 112. At step 770, the advertisement may be displayed as part of the webpage on the user computing device 112.

An alternate example flowchart is presented in FIG. 8B, which illustrates exemplary steps from multiple entities that may be involved in the entire process or buying and reselling ad space. In this example, the user computing device 112 contacts the exchange 130 without an SSP intermediary.

At step 772, a hard-coded tag causes the user computing device to place an ad call with exchange 130.

In response, at step 700b, the exchange 130 may hold a real-time auction to sell the ad space. Unlike FIG. 8A, this real-time auction is not used to place a high bid in a separate auction being carried out by an SSP.

At step 776, the exchange 130 may place a self-bid in its own auction for reasons already discussed herein.

If the exchange 130 wins its own auction, then at step 778 it may provide code for the self-monitoring ad tag to the user computing device, in accordance with embodiments discussed herein.

At step 780, the dynamically-provided self-monitoring ad tag 138 may begin executing when the webpage loads.

In another embodiment, a self-monitoring ad tag may be hard-coded into the webpage, and this hard-coded tag may begin local execution at step 782.

The remaining steps 735-770 may be performed as described with regard to FIG. 8A and/or with regard to other embodiments described herein.

### Additional Overview and Details of Exemplary RTB Systems and Methods

FIG. 10 depicts an exemplary environment 1000 for facilitating the sale of advertising space, i.e., inventory, on a publisher's webpage to an advertiser. In particular, the flow of available inventory from the publisher (or supplier) to an advertiser, as well as the flow of compensation from the advertiser back to the publisher/supplier is generally depicted. In one aspect, environment 1000 can comprise a consumer 1010, a publisher of advertising space 1020, a real-time bidding (“RTB”) exchange 1030, and one or more advertisers 1040.

In particular, when consumer 1010, using a personal computing device such as a desktop computer, laptop, tablet, or cell phone navigates to or “visits” the publisher's webpage, publisher 1020 may wish to derive revenue from the consumer's visit by selling advertising space (or inventory) located on the publisher's webpage. In such an instance, an advertisement request (“ad request”) may be generated by publisher 1020 and can be transmitted, directly or indirectly, to RTB exchange 1030 for selling of the inventory to an advertiser.

In one aspect, when consumer 1010 navigates to the publisher's webpage, information pertaining to consumer 1010 may be transmitted to the publisher. For example, information collected by consumer 1010's web browser (“cookies”) may be transmitted to publisher. Such information may include the consumer's web browsing history, the frequency with which the consumer visits particular webpages or types of webpages, and/or the consumer's online purchase history. Of course, these examples are only exemplary and other suitable information may also be collected and/or transmitted by the consumer's browser. In another embodiment, the consumer's computing device may transmit information indicative of consumer 1010's geographic location, IP address, or other information. In a further embodiment, consumer 1010 may have created an account at publisher 1020's webpage during a previous visit to the webpage, and consumer 1010 may have provided publisher with information in conjunction with creating that account. In such an instance, the information provided during creation of the account may also be recalled by publisher 1020 when consumer 1010 navigates to the publisher's webpage. In another embodiment, information collected by the consumer's internet service provider may be transmitted to publisher 1020. In addition to the aforementioned information, publisher 1020 may also possess information pertaining to consumer 1010 that was collected during a previous interaction with consumer 1010 and/or purchased from a third party data collector.

Upon receipt of any or all such information, publisher 1020 may generate an ad request for transmission to RTB exchange 1030. The ad request may contain all or any portion of the information collected from consumer 1010, consumer 1100's web browser, consumer 1010's computing device, consumer 1010's internet service provider, and/or a third party data collector. In one aspect, the ad request may further contain information pertaining to publisher 1020. For example, the ad request may contain information indicative of the publisher's IP address, how many visits the publisher's webpage receives in a period of time, information indicative of the content of the webpage, and how many advertisements are located on the webpage. Again, these examples are only exemplary and other suitable information may also be included in the ad request. As discussed further herein, the information contained within the ad request will be generally referred to as “transaction information.”

The ad request containing the transaction information can then be transmitted to RTB exchange 1030. In one embodiment, the ad request may be transmitted in the form of a recognized or predetermined protocol or sequence such that one or more recipients of the ad request can make use of the transaction information. RTB exchange 1030 may also operate according to an agreed upon standard that all parties privy to exchange 1030 have adopted. The ad request may also be transmitted in the form of a request for purchase of the associated advertising inventory at a predetermined price and/or an invitation to participate in an auction for the associated advertising inventory.

In another aspect, rather than publisher 1020 transmitting the ad request directly to RTB exchange 1030, the ad request may first be transmitted to an inventory aggregator 1050 commonly referred to as a supply side platform (“SSP”). SSP 1050 may, for example, aggregate advertising space inventory from a plurality of publishers and transmit a portion or all of any received ad requests to RTB exchange 1030. In many instances, SSPs can promise a publisher a higher sale price on their inventory than the publisher could garner on its own because individual publishers with a small volume of inventory have a difficult time attracting advertisers' attention. By aggregating inventory from many such webpages, and thereby increasing inventory volume available for purchase, an SSP is able to attract these same advertisers' business.

Regardless of whether the ad request is transmitted by publisher 1020 or SSP 1050, the ad request may eventually be received by RTB exchange 1030 where the associated advertising space inventory is sold in an auction environment to participating buyers. In one aspect, once the transaction information is made available within exchange 1030, one or more advertisers may review the transaction information and submit bids for purchasing the advertising space to be viewed by consumer 1010 at publisher 1020's webpage. A determination regarding how much to bid for particular inventory in view of a particular consumer/webpage can be handled on a case-by-case basis or according to predetermined algorithms constructed by each advertiser. For example, if advertiser 1040 is in the business of selling products known to be purchased by consumer 1010, advertiser 1040 may submit relatively higher bids for advertising space viewable by consumer 1010 as compared to bids submitted for advertising space viewable by a consumer who has no history of purchasing the advertiser's goods. In another embodiment, advertiser may have determined that consumers visiting a first webpage are more likely to buy the advertiser's products than consumers visiting a second webpage. In such an instance, advertiser 1040 may submit higher bids on inventory associated with the first webpage than inventory associated with the second webpage. In one embodiment, advertiser 1040 may have algorithms for weighting one or more data items from the transaction information according to a predetermined scale developed to identify consumers most likely to be interested in the advertiser's product(s). In such an embodiment, transaction information associated with consumers or webpages that match one or more profiles developed by advertiser 1040 may trigger a bid on behalf of the advertiser for the advertising space associated with that transaction information or trigger a bid at a predetermined amount. Depending on an advertiser's evaluation of the transaction information associated with a particular consumer or publisher, the bid for the advertising space may vary.

In one embodiment, an auction for particular advertising space may remain open to the submission of bids from one or more advertisers for a predetermined amount of time. For example, an auction may remain open to the submission of bids for 100 milliseconds or some other amount of time shorter or longer than 100 milliseconds.

After the auction has closed, a winning bidder may be determined. The price the winning bidder pays for the adverting space may depend, at least in part, on the amount the winning bidder and/or other bidders bid at the auction. In one embodiment, a modified Vickrey auction may be conducted in which the winning bidder pays the price bid by a second place bidder. In other embodiments, a Vickrey auction, a sealed first-price auction, a Dutch auction, an English auction, or any other suitable auction style can be used.

In other embodiments of environment 1000, rather than advertisers 1040 directly submitting bids at RTB exchange 130, bids may be placed at exchange 130 by a marketing aggregator 1060 commonly referred to as a demand side platform (“DSP”). DSP 1060 may, for example, aggregate advertising demand from one or more advertisers 1040 and facilitate the purchase of advertising space on those advertisers' behalf. In many instances, DSPs that rely on their own internal information caches and filtering processes can promise a higher return on investment for advertisers by targeting consumers and webpages more likely to result in click-throughs or sales for the advertiser. In other embodiments, both advertisers 1040 and DSPs 1060 may submit bids at exchange 1030.

In a further aspect, rather than handling the creative efforts involved in generating internet advertising of various formats and suitable for display on one or more computing devices, advertisers delegate this function to an advertising agency 1070. Advertising agency 1070 may then, in some instances, stand between advertiser 1040 and DSP 1060 in a transaction involving the sale of advertising inventory by a publisher and the publication of an advertisement on a webpage.

In another aspect, in conjunction with placing a bid within exchange 1030, advertiser 1040 or DSP 1060 may also transmit a link identifying the location of an advertisement for display at the publisher's webpage. Thus, in the event that the bid is sufficient to win the auction, the link to the advertisement has already been transmitted to exchange 1030. Exchange 1030 may then transmit the link to the winning advertisement to the SSP or publisher from whom the ad request was received. And, in a further aspect, the link is eventually provided to the webpage and displayed at the computing device of consumer 1010 when the webpage loads. In one embodiment, the link to the advertisement may comprise identifying information, including a location of the advertisement and an advertisement identification number. For example, identifying information may contain information regarding a database in which the advertisement is contained and an identification number unique to the advertisement within the database. The database can be any database within or outside environment 1000, and may be maintained locally by a party to the transaction or maintained in the cloud. In this manner, when the link is eventually provided to the webpage being visited by consumer 110, the appropriate advertisement can be located and displayed to the consumer.

In alternative embodiments, an advertisement to display at the webpage may be predetermined. For example, an advertiser 1040 or DSP 1060 may elect to display a particular advertisement every time it wins an auction within exchange 1030. In another embodiment, an advertiser 1040 or DSP 1060 may create multiple identities for bidding within exchange 1030 and which advertisement is displayed at the webpage depends, at least in part, on which of the advertiser's identities won the auction. Of course, other suitable methods for determining an advertisement for display at the advertising space are possible and should be obvious in light of this disclosure.

Returning to the auction process, after a winning bid has been selected, exchange 1030 may generate and transmit a confirmation message to the winning bidder. Where a DSP placed the bid within exchange 1030, the confirmation message may first be received by the DSP and the DSP can then either forward the confirmation message to the advertiser/ad agency or generate a new confirmation message and transmit it to the advertiser/ad agency.

Payment for the placement of the advertisement at the publisher's webpage can then be handled. In one aspect, and as depicted in FIG. 10, when exchange 1030 transmits the confirmation message to DSP 1060, a financial account maintained by the DSP may be automatically debited for the appropriate amount. Alternatively, payment to exchange 1030 for placement of the advertisement can be scheduled for some time in the future. In further embodiments, the DSP may have prepaid some amount to exchange 1030 to be placed towards winning bids. In such an embodiment, upon a determination that the DSP has won the auction, the prepaid amount will be debited to reflect the purchase. Other suitable methods for facilitating payment to exchange 1030 by DSP 1060 are also possible and the examples provided herein are only exemplary.

Likewise, the DSP may receive compensation for its role in placing the advertisement from ad agency 1070 who, in turn, receives its compensation from advertiser 1040. The transactions between the DSP and ad agency, and the ad agency and the advertiser may or may not be substantially similar to the transaction described above between exchange 1030 and DSP 1060.

On the supply side of the transaction, SSP 1050 may receive compensation for its role in placing the advertisement from exchange 1030, and publisher 1020 may receive its compensation for selling the advertising space from SSP 1050. Again, the transactions between the exchange and the SSP and between the SSP and the publisher may or may not be substantially similar to the transaction described above between exchange 1030 and DSP 1060.

FIG. 11 depicts an exemplary embodiment of an RTB exchange environment 1300. In one aspect, environment 1300 may comprise an SSP 1310, an RTB exchange 1320, and one or more DSPs 1380. In an alternative embodiment, SSP 1310 may be a web publisher rather than a supply side platform. Similarly, DSPs 1380 may comprise one or more SSPs, ad agencies, and/or advertisers, rather than or in addition to demand side platforms.

In another aspect, RTB exchange 1320 may comprise a filtering component 1330, a data management component 1340, an auction component 1350, and a viewability component 1360. Of course, RTB exchange 1320 may comprise additional, fewer, or alternative components to those depicted in FIG. 11.

As depicted in FIG. 11, RTB exchange 1320 may be configured to receive an ad request from SSP 1310. The ad request may be substantially similar to the ad request described above with respect to FIG. 10, however, other types or forms of ad requests and/or ad requests comprising more, less, or different information may also be transmitted from SSP 1310 to exchange 1320. In one embodiment, the ad request may be received at filtering component 1330. Filtering component may be configured to extract information from the ad request and perform one or more screening operations pertaining to that information. For example, filtering component 1330 may compare information extracted from the ad request to one or more criteria. In some embodiments, where the ad request contains information that does not meet one or more criteria, filtering component 1330 may reject the ad request and send a rejection message back to SSP 310. Alternatively, where the ad request contains information that does meet one or more criteria, the information extracted from the ad request may be transmitted to another component of exchange 1320 such as data management component 1340. Further details regarding filtering component 1330 are described below with respect to other figures.

Within data management component 1340, information extracted from the ad request may be compared and/or cross-referenced with information previously-stored by exchange 1320. For example, exchange 1320 may possess or have access to additional information pertaining to, among other things, particular IP addresses, consumers, web publishers, and/or webpages. This information may have been collected in conjunction with past transactions involving other ad requests, or the information may have been purchased from a third party data collector. In this manner, when data management component 1340 receives information extracted from an ad request from filtering component 1330, that information can be compared to the previously-stored information in order to generate or collect additional data regarding the particular transaction. For example, where information extracted from the ad request comprises a publisher identifier and the previously-stored information contains a record associating that publisher identifier with information indicative of a high-value publisher, that data may be helpful to exchange 1320 and/or DSPs 1380 when making a determination as to whether to buy or bid for the inventory associated with the ad request.

A portion or all of the information extracted from the ad request and/or the information recalled or generated based on the previously-stored information may then be transmitted from data management component 1340 to auction component 1350. In one embodiment, auction component 1350 may comprise an interface or communication channel with one or more DSPs 1380 interested in buying advertising inventory. Auction component 1350 provides an environment in which DSPs 1380 may view, receive, or otherwise evaluate information pertaining to the associated advertising inventory and make a determination regarding whether to buy the inventory and/or how much to bid for the inventory within the auction. In another embodiment, where a DSP decides to bid on inventory, a bid comprising a DSP identifier, a bid price, and a link to an advertisement may be communicated to exchange 1330 at auction component 1350. In this manner, should the bidding DSP win the auction, exchange 1330 will already be in possession of a link to the advertisement that the DSP desires to display at the associated webpage. Of course, a bid transmitted from a DSP may contain additional, less, or alternative information.

As discussed above, the auction for the advertising inventory may remain open for the submission of bids for a predetermined period of time, e.g., 50-100 milliseconds, or until some other condition is satisfied. Of course, the duration of the auction may be longer or shorter than 50-100 milliseconds and/or be determined based, at least in part, on a number of suitable conditions.

After the auction is closed to further bidding, a winning bidder may be determined. In instances where no bids were received or no bids were received above a predetermined floor price, exchange 1320 may transmit a pass-back or rejection message to SSP 1310 notifying SSP 1310 that the inventory will not be purchased. Conversely, in instances where a satisfactory winning bid is received at auction component 1350, the winning bid may then be transmitted, along with a link to the associated advertisement, from exchange 1320 to SSP 1310. SSP 1310, upon receiving the winning bid and link from exchange, may then transmit a confirmation message back to exchange 1320. Alternatively, where SSP 1310 is hosting its own auction for the advertising inventory, SSP 1310 may compare the winning bid transmitted by exchange 1320 to other bids for the same inventory submitted to SSP 1310 by other entities. SSP 1310 may then send a confirmation message to exchange 320 where the bid transmitted from exchange 1320 is sufficient to win the auction held by SSP 1310. Alternatively, SSP 1310 may transmit a losing bid message to exchange 1320 where the bid transmitted from exchange 1320 to SSP 1310 is insufficient to win the auction held by SSP 1310.

In the event that exchange 1320 receives a confirmation message from SSP 1310 indicative that SSP 1310 has accepted the bid price transmitted by exchange 1320 for the inventory, a second confirmation message may then be transmitted from exchange 1320 to the DSP that submitted the winning bid at auction component 1350. Any financial transactions between the parties may then be scheduled. For example, SSP 1310 may invoice exchange 1320 for the purchase of the inventory, and exchange 1320 may invoice the winning DSP for the purchase of the inventory.

In another aspect of environment 1300, upon consideration of information extracted from the ad request and/or previously-stored in association with data management component 1340, exchange 1320 may decide to place a bid for the inventory within its own auction component 1350. In such circumstances, and where exchange 1320 submits the winning bid to auction component 1350, information regarding the inventory and/or winning bid information may be transmitted to viewability component 1360. From viewability component 1360, the winning bid may then be transmitted, along with an ad tag (such as a self-monitoring ad tag 138), from exchange 1320 to SSP 1310. SSP 1310, upon receiving the winning bid and ad tag, may then transmit a confirmation message back to exchange 1320. Alternatively, and as discussed above, where SSP 1310 is hosting its own auction for the advertising inventory, SSP 1310 may compare the winning bid transmitted by exchange 1320 to other bids for the same inventory submitted to SSP 1310 by other entities. SSP 1310 may then send a confirmation message to exchange 1320 where the bid transmitted from exchange 1320 is sufficient to win the auction held by SSP 1310. Alternatively, SSP 1310 may transmit a losing bid message to exchange 1320 where the bid transmitted from exchange 1320 to SSP 1310 is insufficient to win the auction held by SSP 1310. The ad tag transmitted from viewability component 1360 may be used by exchange 1320 to monitor the viewability of the purchased inventory on a consumer's computing device and, in some circumstance, trigger another auction for the inventory once the inventory becomes viewable by the consumer or is likely to do so. More details regarding viewability component 1360 and associated ad tags are described below with respect to other figures.

FIG. 12 depicts an exemplary embodiment of an RTB exchange environment 1400. Like environment 1300, environment 1400 may comprise an SSP 1410, an RTB exchange 1420, and one or more DSPs 1480. Further, SSP 1410 may be a web publisher rather than a supply side platform and DSPs 1480 may comprise one or more SSPs, ad agencies, and/or advertisers, rather than or in addition to one or more demand side platforms.

RTB exchange 1420 may be substantially similar to exchange 320 depicted in FIG. 11, comprising a filtering component 1430, a data management component 1440, an auction component 1450, and a viewability component 1460. Of course, exchange 1420 may comprise additional, fewer, or alternative components. Moreover, the components of exchange 1420 may be configured substantially similar to the corresponding components of exchange 1320. Of course, environment 1400 may comprise additional, fewer, or alternative components.

In exchange 1320, however, a pass-back or rejection message is transmitted to SSP 1310 in instances where no bids are received from DSPs 1380 at exchange 1320 or no bids are received from DSPs 1380 above a predetermined floor price. In exchange 1420, rather than generating and transmitting such a pass-back or rejection message to SSP 1410, inventory that receives no bids or receives no satisfactory bids in auction component 1450, i.e., unsold inventory, may be transmitted to a modified waterfall component 1470.

Modified waterfall component 1360 may be associated or in communication with a database storing information pertaining to past purchase behavior of one or more DSPs, SSPs, ad agencies, and advertisers. Moreover, the database may contain information useful in determining the identity of the DSP, SSP, ad agency, or advertiser most likely to purchase the unsold inventory and information indicative of the price such a buyer may be willing to pay for the unsold inventory. Thus, modified waterfall component 1470 may generate an ad request not unlike the ad requests received from SSP 1410 that is associated with the unsold inventory and transmit the ad request to the DSP, SSP, ad agency, or advertiser most likely to purchase the unsold inventory at the highest price, i.e., the first waterfall recipient. Where the first waterfall recipient decides to purchase the unsold inventory, the first waterfall recipient may transmit a confirmation message to modified waterfall component 1470 comprising a link to the advertisement desired to be displayed at the location of the inventory. In instances where the first waterfall recipient decides not to purchase the unsold inventory, a pass-back or rejection message may be transmitted to modified waterfall component 1470. Modified waterfall component 1470 may then transmit the ad request to a second waterfall recipient of the remaining potential buyers, the second waterfall recipient now being the most likely to purchase the unsold inventory at the highest price. This iterative process may repeat until a buyer of the unsold inventory is found.

Once a buyer of the unsold inventory is found and a link to the advertisement desired to be displayed is received at modified waterfall component 1470, modified waterfall component 1470 may then transmit a message comprising the link to SSP 1410 for publication at the webpage. Alternatively, where SSP 1410 is conducting its own auction for the inventory, modified waterfall component 1470 may transmit the link and a bid for the inventory based, at least in part, on the price agreed to by the buyer of the unsold inventory. Where the bid is selected as the winning bid, SSP 1410 is already in possession of the link to the advertisement for display at the webpage and may transmit a confirmation message back to modified waterfall component 1470. Where the bid is not selected as the winning bid, SSP 1410 may transmit a losing bid message to modified waterfall component 1470. Modified waterfall component 1470 may then generate and/or transmit a message to the buyer of the unsold inventory indicative of a completed transaction or an unsuccessful bid.

Further details regarding modified waterfall component 1470 and the prioritization of a plurality of potential buyers of unsold inventory is described below with respect to other figures.

FIG. 13 depicts an exemplary embodiment of a method for purchasing advertising inventory from an SSP or web publisher. At step 1502, the RTB exchange may receive an ad request from an SSP or directly from a web publisher. The ad request may be substantially similar to the ad request described above with respect to FIGS. 10, 11, and 12, however, other types or forms of ad requests and/or ad requests comprising more, less, or different information may also be received from the SSP or web publisher.

At step 1504, information may be extracted from the ad request and that information may be compared against one or more filtering or screening criteria to determine if the inventory is suitable for sale within the exchange. Further details regarding the filtering or screening process are described below with respect to other figures.

Where the inventory associated with the ad request does not meet one or more criteria, the exchange may not accept the inventory and, at step 1506, may transmit a rejection message to the SSP. The rejection message can indicate that the inventory was rejected and/or will not be sold through the exchange. In another embodiment, the rejection message may describe one or more criteria that the inventory failed to satisfy and/or otherwise explain why the inventory has been rejected.

Where the inventory does meet one or more criteria, the information extracted from the ad request may then be used to identify additional information accessible to the exchange at step 1508. For example, the exchange may possess or have access to additional information pertaining to, among other things, particular IP addresses, consumers, web publishers, and/or webpages. This information may have been collected in conjunction with past transactions involving other ad requests, or the information may have been purchased from a third party data collector. In one embodiment, extracted information from the ad request may be used to cross-reference one or more databases in order to gather the additional information. Further details regarding the collection of additional information pertaining to inventory associated with received ad requests are described below with respect to other figures.

At step 1510, a portion or all of the information extracted from the ad request and/or the additional information may then be transmitted to an auction environment. In one aspect, one or more DSPs or other entities interested in purchasing advertising inventory may view, receive, or otherwise evaluate information pertaining to inventory made available for purchase through the auction. In one embodiment, as inventory is made available within the auction environment, a transmission is sent to one or more potential buyers, the transmission comprising one or more of: a notification that the inventory is available for purchase; information describing the inventory, such as the webpage on which it resides, consumer information, publisher information, and the number of advertisements on the webpage; and a floor price for bids. In response, one or more potential buyers may then submit bids to the exchange for the inventory. In conjunction with the bids, a buyer identifier and/or a link to an advertisement desired to be displayed at the location of the inventory may also be provided.

Upon conclusion of the auction, a winning bidder is selected. In instances where the exchange submitted a bid on its own behalf, e.g., as part of a viewability feature described below, a viewability ad tag may be generated at step 1520. At step 1522, the ad tag may then be transmitted to the SSP or web publisher selling the inventory along with a proposed purchase price, e.g. the amount of the winning bid. After transmission of the ad tag, at step 1524, the exchange may receive a confirmation message from the SSP or web publisher, informing the exchange that the offer for purchase of the inventory has been accepted and the ad tag has been placed at the location of the inventory. Where the SSP or web publisher is conducting its own auction for the inventory, the proposed purchase price may be compared to other bids submitted to the SSP/web publisher. In instances where the proposed purchase price is not the high bid, the exchange may receive a rejection message from the SSP/web publisher informing the exchange that the offer to buy the inventory has not been accepted. Alternatively, in instances where the proposed purchase price is the high bid, the exchange may receive a confirmation message from the SSP/web publisher informing the exchange that the offer to buy the inventory has been accepted and the ad tag has been placed at the location of the inventory.

In another aspect, where a DSP or other bidding party wins the auction rather than the exchange, the exchange may transmit the link to the advertisement associated with the winning bid to the SSP/web publisher at step 1530. This transmission may further comprise an offer price for the inventory that is the same or different from the winning bid of the buyer in the auction held by the exchange. At step 1532, after transmission of the link, the exchange may receive a message from the SSP/web publisher similar to the message received above with respect to step 1524, informing the exchange that the offer for purchase of the inventory was either rejected or it was accepted and the linked advertisement has been or will be displayed at the location of the inventory.

In the event that the exchange did not submit its own bid for the inventory to the auction and no satisfactory bids were received by a potential buyer, i.e., either no bids were received or the highest bid did not meet a floor price, information pertaining to the inventory may be subjected to an offer waterfall at step 1540. There, the information associated with the inventory may be used to cross-reference a database storing information pertaining to past purchase behavior of one or more buyers and the identity of the buyers most likely to purchase the inventory and/or most likely to pay the highest offer price may be ascertained. In this manner, a prioritized list of potential buyers can be generated.

At step 1542, the exchange may initiate an iterative process whereby an ad request similar to the ad request initially transmitted by the SSP/web publisher is transmitted to a first recipient, i.e., the potential buyer atop the prioritized list generated at step 1540. Where the first waterfall recipient decides to purchase the inventory, the first waterfall recipient may transmit a confirmation message to the exchange comprising a link to the advertisement desired to be displayed at the location of the inventory. In instances where the first waterfall recipient decides not to purchase the unsold inventory, the exchange may receive a pass-back or rejection message. The exchange may then transmit an ad request to a second waterfall recipient newly atop the prioritized list generated at step 1540, the second waterfall recipient now being the most likely to purchase the inventory at the highest price. This iterative process may repeat until a buyer of the inventory is found. Further details regarding the offer waterfall and the prioritization of a plurality of potential buyers of inventory is described below with respect to other figures.

Once a buyer of the inventory is found, a link to the advertisement desired to be displayed may be received by the exchange at step 1544 and transmitted to the SSP/web publisher at step 1546, similar to the process described above with respect to step 1530. At step 1548, after transmission of the link, the exchange may receive a message from the SSP/web publisher similar to the message received above with respect to steps 1524 and 1532, informing the exchange that the offer for purchase of the inventory was either rejected or it was accepted and the linked advertisement has been or will be displayed at the location of the inventory.

### Filtering Component

FIG. 14 depicts an exemplary embodiment of filtering component 1600, which may be substantially similar to filtering component 1330 of FIG. 11 and/or filtering component 1430 of FIG. 12. As discussed above, an RTB exchange may be configured to receive an ad request from an SSP. The ad request may be substantially similar to the ad request described above with respect to FIG. 10, however, other types or forms of ad requests and/or ad requests comprising more, less, or different information may also be transmitted from the SSP to the exchange.

In one embodiment, the ad request may be received at filtering component 1600, which may be configured to extract information from the ad request and perform one or more screening operations pertaining to that information. For example, filtering component 1600 may compare information extracted from the ad request to one or more criteria. In some embodiments, where the ad request contains information that does not meet one or more criteria, filtering component 1600 may reject the ad request and send a rejection message back to the SSP. Alternatively, where the ad request contains information that does meet one or more criteria, the information extracted from the ad request may be transmitted to another component of the exchange for further analysis, manipulation, and/or transmission.

In one embodiment, filtering component 1600 may comprise a character string analysis component 1610, a bot detection component 1630, and an iFrame breaker component 1650. Of course, these components are exemplary and other embodiments of filtering component 1600 comprising fewer, more, or alternative components are also possible.

As shown in the FIG. 14, information associated with a received ad request may undergo character string analysis, then bot detection, followed by iFrame breaking. In alternative embodiments, however, the order in which the information is subjected to or analyzed by the various components depicted in FIG. 14 may be different. In further embodiments, one or more processes undertaken by one or more of the depicted components or additional components may be carried out simultaneously and/or in an overlapping fashion.

In the embodiment depicted in FIG. 14, information associated with an ad request is first processed by character string analysis component 1610. Character string analysis component 1610 may comprise a numerical prioritization component 1612 and a keyword searching component 1614. Again, although the numerical prioritization is depicted as occurring prior to the keyword searching in FIG. 14, these processes may take place in reverse order, simultaneously, or at overlapping times.

Numerical prioritization component 1612 may be configured to prioritize numerical information contained in the ad request above alphabetical information contained in that ad request. For example, information pertaining to an IP address and contained in the ad request would be represented numerically rather than alphabetically. In this manner, regardless of how information may be presented in the ad request, an IP address may be identified quickly and, for example, cross-referenced against a database containing known “bad” IP addresses. An IP address may be characterized as “bad” for a number of reasons, including but not limited to: past identification as a malicious site (e.g., a site containing nothing but advertising space and little to no substantive content); past association with bot-like activity (i.e., ad requests associated with the IP address have previously been associated with activities indicative of a bot rather than a live person); or past identification as a website associated with restricted content (e.g., pornography or otherwise undesirable web content).

The ability to quickly and efficiently eliminate undesirable ad requests from the exchange may be critical, particularly considering the limited time within which the inventory and/or ad request must be transmitted, evaluated, placed up for auction, and/or sold. For example, it is not uncommon that an exchange must evaluate, process, and sell inventory associated with an ad request in 150 ms or less. Of course, the time limitations set on an exchange may be greater or less, and 150 ms is only exemplary. Prioritizing numerical characters so as to quickly identify and cross-reference IP addresses may save a considerable amount of time that would otherwise be spent processing or analyzing an ad request that should eventually be removed from the exchange or, worse, reimbursing a DSP who inadvertently purchases inventory at auction that is associated with malicious or undesirable web content despite representations made by the exchange that it will filter out such inventory.

In another aspect, character string analysis component 1610 may also perform keyword searching on alphabetical characters associated with the information contained in the ad request at keyword searching component 1614. For example, keyword searching component 1614 may search for letters, words, and/or phrases within the ad request information indicative of malicious or undesirable content (e.g., “XXX,” “nude,” or “ad pumping”). Further, alphabetical information contained in the ad request may be cross-referenced against a database of known letters, character strings, words, or phrases that have previously been associated with malicious or undesirable web content.

As described above with respect to numerical prioritization component 1612, the ability to quickly and efficiently eliminate undesirable ad requests from the exchange may be critical in light of the limited time within which the inventory and/or ad request must be transmitted, evaluated, placed up for auction, and/or sold. Performing keyword searching on information contained within the ad request quickly or early in the exchange's evaluation process may save a considerable amount of time that would otherwise be spent processing or analyzing an ad request that should eventually be removed from the exchange.

Filtering component 1600 may also comprise bot detection component 1630. As depicted in FIG. 14, bot detection component 1630 may comprise an IP activity analysis component 1632 and a consumer device monitoring component 1634. Although the IP activity analysis is depicted as occurring prior to the consumer device monitoring in FIG. 14, these processes may take place in reverse order, simultaneously, or at overlapping times.

In one aspect, IP activity analysis component 1632 may extract or analyze information contained in the ad request associated with the online activity of a particular IP address or web browser. For instance, the ad request may contain cookies or other information indicative of online behavior exhibited by the user/consumer at the IP address or within the consumer's browser. In one embodiment, for example, the number of webpages visited by a consumer within a predetermined period of time may be evaluated. In instances where a consumer has visited a large number of websites in a relatively short period of time, it may be presumed that the consumer is actually a bot generating web traffic rather than a live person or, even if the consumer is a live person, the consumer does not stay on any particular website long enough to view advertisements placed on the visited websites. In an alternative embodiment, rather than evaluating the number of websites an IP address or web browser has visited in a predetermined period of time, IP activity analysis component 1632 may evaluate how many advertisements have been viewed at the IP address or within the browser in a predetermined period of time. In instances where a consumer has viewed a large number of advertisements in a relatively short period of time, it may be presumed that the consumer is actually a bot generating web traffic and attempting to inflate advertising revenue rather than a live person or, even if the consumer is a live person, the consumer may be more concerned with driving advertisements to a webpage than viewing substantive web content.

Bot detection component 1630 may further comprise consumer device monitoring component 1634. In one embodiment, consumer device monitoring component 1634 may determine whether the client device that generated the ad request (by visiting a webpage) is connected to a monitor or whether light on the monitor of the client device has been detected. In some instances, information regarding whether a monitor is connected to the client device may be contained in the ad request. In such cases, this information can be quickly evaluated. In other cases, other information within the ad request may be cross-referenced or compared against data associated with past transactions in order to determine if the IP address or web browser associated with the ad request has ever been determined to lack a connected monitor. For example, in some embodiments, it may not be possible to determine whether a monitor is connected to the client device until after inventory has been purchased at the IP address or web browser. Once inventory has been purchased, the exchange and/or a DSP or advertiser may have an open communication channel to transmit and receive further information regarding the client device. Thus, details such as whether a monitor is connected to the client device may sometimes be “learned” using a trial-and-error process in conjunction with a database for storing information associated with past ad requests and purchases. Regardless of when or how the absence of a monitor may be detected, once such a determination is made, it may be presumed that a bot is generating the web traffic and the ad request rather than a live person. Ad requests associated with the corresponding client device may then be filtered out of the exchange rather than sold to unsuspecting DSPs or advertisers.

Filtering component 1600 may also comprise iFrame breaker component 1650. As depicted in FIG. 14, iFrame breaker component 1650 may comprise an iFrame detection component 1652 and an iteration component 1654. In one aspect, once inventory has been purchased from a publisher or SSP, the purchaser (e.g., the exchange, a DSP, or a marketer) may gain additional access and details regarding the webpage in which the inventory is positioned. This can be accomplished by transmitting a link to code (as part or separate from an advertisement) that the publisher will use to insert content at the location of the inventory. The code, once placed at the location of the inventory, can then detect and transmit information about its location back to the purchaser of the inventory. Among the information that the code may detect and/or transmit back to the purchaser may be information indicating that the advertisement is positioned within an Inline Frame (an “iFrame”). Generally speaking, an iFrame is an HTML document embedded inside another HTML document on a website. iFrames are commonly used to insert content from another source (such as an advertisement) into a webpage. The iFrame may behave like an inline image in many respects, but it may also be configured with its own scrollbar, etc. Additionally, the presence of an iFrame may obscure or otherwise prevent a purchaser of inventory from learning the true identity/nature of the underlying webpage in which the iFrame is located. In fact, some malicious publishers use iFrame stacks, i.e., several layers of iFrames positioned within iFrames, in order to disguise the true nature of the underlying webpage. Thus, a purchaser's desire to buy only “clean” inventory meeting particular standards may be frustrated by publishers obscuring information pertaining to a webpage that would otherwise cause a buyer to refuse or pass on the inventory.

Once inventory has been purchased and the code or some other data transmission has been placed at the location of the inventory, not only can information indicating that the inventory is positioned within an iFrame be detected, but information pertaining to the parent HTML document (the document within which the iFrame is positioned) may also be identified, transmitted, and/or analyzed. The information pertaining to the parent HTML document may then be used to transmit code or another link to code from the purchaser to that parent HTML document. Iterative process component 1654 may then repeat the iFrame detection process in order to determine if the parent document is an iFrame and, if so, information identifying its parent HTML document. This process may repeat itself until a parent HTML document other than an iFrame is identified, thereby allowing the exchange or purchaser to assess the nature and content of the underlying webpage.

After the non-iFrame, parent HTML document is identified and analyzed, information pertaining to the parent document may be stored in a database and associated with ad requests containing information indicative of any previously-identified iFrames within the parent document. In this manner, when an ad request associated with one of the previously-identified iFrames is transmitted to the exchange, information from the ad request may be cross-referenced against the database and the exchange can ascertain the true nature of the underlying webpage without needing to purchase the associated inventory and engage in the iterative process described above.

FIG. 15 depicts an exemplary embodiment of a method for filtering out ad requests associated with undesirable inventory. At step 1710, the RTB exchange may receive an ad request from an SSP or directly from a web publisher. The ad request may be substantially similar to the ad request described above with respect to FIG. 1, 3, or 4, however, other types or forms of ad requests and/or ad requests comprising more, less, or different information may also be received at the exchange.

At step 1720, information associated with an ad request may be subjected to numerical prioritization. In other words, numerical information contained in the ad request may be analyzed or extracted from the ad request prior to any analysis or extraction of alphabetical information contained in the ad request. For example, information pertaining to an IP address and contained in the ad request would be represented numerically rather than alphabetically. Regardless of how information may be presented in the ad request, numerical data such as an IP address may be identified and analyzed quickly, prior to any other analysis of the ad request. For example, numerical data indicative of the client and/or webpage IP address may be cross-referenced against a database of known “bad” IP addresses. As described above, an IP address may be characterized as “bad” for a number of reasons, including but not limited to: past identification as a malicious site; past association with bot-like activity; and/or past identification as a website associated with restricted content. The ability to quickly and efficiently eliminate undesirable ad requests from the exchange may be critical, particularly considering the limited time within which the inventory and/or ad request must be transmitted, evaluated, placed up for auction, and/or sold.

In instances where a known bad IP address is identified, the exchange may transmit a pass-back or rejection message to the sender of the ad request at step 1730, informing the source of the request that the ad request has been rejected and/or will not be sold within the exchange. In some embodiments, the pass-back or rejection message may contain information describing the reason for the pass-back or rejection. For example, the pass-back or rejection message may contain a message such as “bad IP address” or “suspected bot.” In further embodiments, the pass-back or rejection message may trigger a monetary indemnification or payment from the source of the ad request to the exchange. This may be the case in instances where the SSP or publisher who generated and/or transmitted the ad request to the exchange has guaranteed the “clean” nature of its inventory or is otherwise contractually bound to provide only clean inventory. Where the source of the ad request is contractually bound to pay monetary penalties at each instance of providing bad inventory, the pass-back or rejection message from the exchange may serve to initiate such a payment.

Where the numerical data contained or associated with the ad request does not trigger a pass-back or rejection message, alphabetical data in the ad request may then be subjected to keyword analysis at step 1740. For example, alphabetical data contained or associated with the ad request may be searched for letters, words, and/or phrases indicative of malicious or undesirable content (e.g., “XXX,” “nude,” or “ad pumping”). In other embodiments, alphabetical information contained in the ad request may be cross-referenced against a database of known letters, character strings, words, or phrases that have previously been associated with malicious or undesirable web content. As described above, performing keyword searching on alphabetical information contained within the ad request quickly or early in the exchange's filtering process may save a considerable amount of time that would otherwise be spent processing or analyzing an ad request that should eventually be removed from the exchange.

In another aspect, ad requests found to be undesirable based, at least in part, on alphabetical data analysis may trigger a pass-back or rejection message at step 1730. The pass-back or rejection message may be substantially similar to the message described above with respect to the prioritized numerical analysis. In further embodiments, the pass-back or rejection message may contain information identifying one or more keywords contained in or associated with the ad request that led to the rejection.

In another aspect of the method depicted in FIG. 15, IP address activity associated with ad requests that have not been filtered out based on numerical and/or alphabetical data may be reviewed, interpreted, or otherwise analyzed at step 1750. For example, the ad request may contain cookies or other information indicative of online behavior exhibited at a client IP address or within a consumer's browser. In one embodiment, the number of webpages visited by a client device/browser within a predetermined period of time may be evaluated. In instances where the client device/browser has visited a number of websites over a predetermined threshold in a predetermined period of time, it may be presumed that the client/browser is actually operating under the control of a bot rather than a live person. In an alternative embodiment, rather than evaluating the number of websites an IP address or web browser has visited in a predetermined period of time, the number of advertisements viewed at the client/browser may in a predetermined period of time may be reviewed, evaluated, or analyzed. In instances where a client/browser has displayed a number of advertisements over a predetermined threshold within a predetermined period of time, it may be presumed that the client/browser is operating under the control of a bot rather than a live person.

Ad requests associated with IP activity indicative of bot control may trigger a pass-back or rejection message at step 1730. The pass-back or rejection message may be substantially similar to the messages described above with respect to previous steps. In further embodiments, the pass-back or rejection message may contain information explaining the activity that triggered the rejection.

At step 1760, the exchange may determine whether the client device that generated the ad request is connected to a monitor or whether light on the monitor of the client device has been detected. As discussed above with respect to FIG. 14, information regarding whether a monitor is connected to the client device may be contained in the ad request or information associated with the ad request may be cross-referenced or compared with data associated with past transactions in order to determine if the IP address or web browser associated with the ad request has ever been determined to lack a connected monitor. Regardless of when or how the absence of a monitor may be detected, once such a determination is made, it may be presumed that the client device is under the control of a bot rather than a live person.

Ad requests associated with client devices likely under the control of a bot may then trigger a pass-back or rejection message at step 1730. The pass-back or rejection message may be substantially similar to the messages described above with respect to previous steps. In further embodiments, the pass-back or rejection message may contain information explaining the reason or justification for the rejection.

At step 1770, iFrame detection may then be performed with respect to ad requests that have not been filtered out of the exchange at any of steps 1710-60. As described above, once inventory has been purchased from a publisher or SSP by the exchange or another party, the purchaser may gain additional access and details regarding the webpage in which the inventory is positioned. This can be accomplished by transmitting a link to code (as part or separate from an advertisement) that the publisher will use to insert content at the location of the inventory. The code, once placed at the location of the inventory, can then detect and transmit information about its location back to the purchaser of the inventory. Among the information that the code may detect and/or transmit back to the purchaser may be information indicating that the advertisement is positioned within an iFrame.

Further, at step 1772, where an ad request is determined to be associated with inventory within an iFrame, information pertaining to the parent HTML document (the document within which the iFrame is positioned) may also be identified, transmitted, and/or analyzed.

Next, at step 1774, the exchange may determine whether there is sufficient time to continue reviewing the ad request. As described above, the process of receiving, reviewing, filtering, and selling inventory associated with an ad request may need to be accomplished in as little as 150 ms. Of course, this time is exemplary only and may be less than or greater than 150 ms. Regardless, where a publisher has stacked multiple iFrames one within another, it may take time to perform the iterative process described with respect to FIG. 14 to ultimately identify the non-iFrame, parent HTML document. As a result, each time an iFrame is detected and its parent HTML document is identified, the exchange must determine if there is sufficient time to further analyze that parent HTML, determine whether it is an iFrame, and, if so, the identity of its parent HTML. Where the time that has lapsed from receipt of the ad request at the exchange exceeds a predetermined time threshold, a pass-back or rejection message may be triggered. The pass-back or rejection message may be substantially similar to the messages described above with respect to previous steps. In further embodiments, the pass-back or rejection message may contain information explaining that the ad request “timed out” due to use of one or more iFrames.

Alternatively, where the time that has lapsed from receipt of the ad request at the exchange is less than a predetermined time threshold, information associated with the newly identified parent HTML document may be reviewed or otherwise analyzed at iFrame detection step 1770. In instances where the parent document is determined to be an iFrame, steps 1772 and 1774 may repeat. In a further aspect, steps 1770-1774 may repeat until either the transaction times out or a non-iFrame, parent HTML document is identified.

Where a non-iFrame, parent HTML document is identified within the predetermined time constraints and, after any further analysis and/or review of the parent document is performed, the ad request may then be transmitted to a data management component described above with respect to other figures.

Of course, the filtering process depicted in FIG. 15 is exemplary only and, in alternative embodiments, may comprise fewer, additional, or alternative steps/processes. Moreover, though FIG. 15 depicts the various filtering steps being performed in a particular order, alternative embodiments may comprise substantially similar steps performed in a different order, simultaneously, and/or in an overlapping fashion.

### Waterfall Component

FIG. 16 depicts an exemplary embodiment of waterfall component 1800, which is substantially similar to waterfall component 1470 of FIG. 12. Waterfall component 1800 may comprise, in some embodiments, waterfall module 1810 and database 1820. As discussed above, where no bids are received on inventory from potential buyers (e.g., DSPs, advertisers, etc.) within an auction component 1830 or, alternatively, no satisfactory bids above a predetermined floor price are received, the inventory may be passed to waterfall component 1800.

In one aspect, waterfall module 1810 may be associated or in communication with database 1820. Database 1820 may store information pertaining to past purchase and/or bidding behavior of one or more DSPs, SSPs, ad agencies, and advertisers. Moreover, database 1820 may contain information useful in determining the identity of the DSPs, SSPs, ad agencies, or advertisers 1840 believed to be the most desirable purchaser of the inventory, i.e., most likely to purchase the inventory at the highest price. In one embodiment, only the most desirable purchaser may be identified. In other embodiments, a prioritized list of the most desirable purchasers may be compiled or generated where the most desirable purchaser is identified atop the list.

Once the most desirable potential buyer of the inventory is identified, waterfall component 1800 may generate an ad request and transmit the ad request to the potential buyer. The ad request may be substantially similar to the ad request described above with respect to FIG. 10, however, other types or forms of ad requests and/or ad requests comprising more, less, or different information may also be generated by waterfall component 1800. In one aspect, the ad request may comprise an offer price for the associated inventory rather than an invitation to submit a bid for the inventory in an auction environment. Moreover, the offer price may be based, at least in part, on information contained and/or analyzed within database 1820. For example, the offer price may be associated with a price the recipient has paid in the past for similar inventory and/or under similar circumstances (e.g., in a similar geographic region, at a similar time of day, and/or the same day of the week).

Where the recipient of the ad request (i.e., the first waterfall recipient) decides to purchase the inventory at the offer price, the first waterfall recipient may transmit a confirmation message to waterfall component 1800 comprising a link to the advertisement desired to be displayed at the location of the inventory. In instances where the first waterfall recipient decides not to purchase the unsold inventory, a pass-back or rejection message may be transmitted to waterfall component 1800. In embodiments where a prioritized list of desirable buyers has been compiled or generated, waterfall component 1800 may then transmit the ad request to a second waterfall recipient of the remaining potential buyers, the second waterfall recipient now being the most likely to purchase the unsold inventory at the highest price. In embodiments where no such prioritized list has been compiled or generated, the information within the database may be further reviewed or analyzed to determine the most desirable purchaser in light of the first waterfall recipient's refusal to purchase the inventory. The process of transmitting ad requests, receiving a confirmation or pass-back/rejection message, and determining the next most desirable buyer may then repeat until a buyer of the unsold inventory is found and the offer price within the ad request is accepted.

It should be noted, in some embodiments, the offer price associated with each ad request is not necessarily the same despite the fact that the ad requests may be associated with the same inventory. For example, where database 1820 contains information indicating that buyer A has purchased inventory similar to inventory X at a price of $1.00 CPM (as used herein, “CPM” stands for “cost per impression” and is represented in terms of the cost of one thousand impressions) and buyer B has purchased inventory similar to inventory X at a price of $0.90 CPM, then an ad request containing an offer price of $1.00 CPM may first be transmitted to buyer A and, if buyer A declines to purchase the inventory, an ad request may then be transmitted to buyer B containing an offer price of $0.90 CPM. Of course, this example is only exemplary and any suitable process for determining an offer price within an ad request may be used.

Once a buyer of the unsold inventory is found and a link to the advertisement desired to be displayed is received at waterfall component 1800, waterfall component 1800 may then transmit a message comprising the link to the SSP or publisher supplying the inventory. Alternatively, where an SSP or publisher is conducting its own auction for the inventory, waterfall component 1800 may transmit the link and a bid for the inventory based, at least in part, on the price agreed to by the buyer of the inventory. Where the bid is selected as the winning bid, the SSP or publisher may then transmit a confirmation message back to waterfall component 1800. Where the bid is not selected as the winning bid, the SSP or publisher may transmit a losing bid message to waterfall component 1800. Waterfall component 1800 may then generate and/or transmit a message to the buyer of the inventory indicative of a completed transaction or an unsuccessful bid.

FIG. 17 depicts exemplary embodiments of data contained within database 1820. In one aspect, the database may contain one or more tables 1910, 1940 comprising data (e.g., records in each row of one or more tables) associated with past transactions. In one embodiment, the data may be compiled from past transactions in which the exchange played a role. In other embodiments, the data may be purchased from a third party that collected or otherwise possesses the data. In further embodiments, the data contained in database 1820 may be a combination of third party data and data collected from transactions involving the exchange.

In one embodiment, table 1910 may comprise one or more of a transaction identification number 1912, a supplier identification number 1914, a buyer identification number 1916, a consumer identification number 1918, a transaction date 1920, a transaction time 1922, a transaction purchase price and/or bid amount 1924, a transaction inventory classification code 1926, and a location code 1928. Table 1910 may also contain information regarding the display at which inventory is to be displayed, such as device, size, and/or formatting information. In other embodiments, table 1910 may contain additional information regarding the particular consumer that generated the initial ad request (e.g., gender, age, past online purchase information, etc.). Table 1910 may also contain other information useful to the exchange when evaluating potential buyers of inventory and determining a most desirable buyer. The examples provided herein are only exemplary and should not be construed as exhaustive of the possibilities.

As shown in FIG. 17, information (e.g., records) contained in table 1910 may comprise a combination of one or more alphanumeric character strings, however, various suitable identifiers including one or more alphabetical characters or numerical characters may be used.

In another aspect, database 1820 may further comprise one or more records 1940 containing information associated with a particular consumer identification number. In one embodiment, table 1940 may comprise one or more of a location code 1942, an inventory classification code 1944, a publisher identification number 1946, a transaction date 1948, a transaction time 1950, a transaction purchase price or bid amount 1952, a gender identifier 1954, and an age identifier 1956. Record 1940 may contain alternative or additional information helpful to the exchange when evaluating potential buyers of inventory and determining a most desirable buyer. Again, the examples provided herein are only exemplary and should not be construed as exhaustive of the possibilities.

In another aspect, data contained in tables 1910, 1940 can be used by the exchange to determine the most desirable potential buyer of inventory. In some embodiments, the data may also be used to compile or generate a prioritized list of one or more potential buyers. Moreover, an offer price for the inventory transmitted to one or more potential buyers in the form of an ad request may be based, at least in part, on the data (e.g., records) contained in tables 1910, 1940.

Thus, when inventory passed from an auction component is received by waterfall component 1800, the inventory may be assigned an inventory classification based on the webpage on which the inventory resides and a location identifier based on IP address location of the consumer's CPU or browser. These assignments can be made within waterfall component 1800 or at some time before or after inventory is received at waterfall component 1800. Additionally, the originating supplier and consumer, as well as a date and time associated with the original ad request may be known and/or recorded. This information may then be cross-referenced against information contained in tables 1910 and/or 1940 in order to determine a most desirable buyer and/or compile a prioritized list of potential buyers.

For example, cross-referencing of tables 1910, 1940 may reveal that a buyer is particularly interested in purchasing inventory associated with one or more inventory classifications or inventory associated with a particular geographic location. Alternatively, cross-referencing of tables 1910, 1940 may reveal one or more buyers place relatively high bid amounts for inventory associated with a particular consumer or a consumer meeting certain demographic criteria. In other scenarios, it may be revealed that a buyer spends the bulk of its advertising dollars in particular time slots and in particular geographic regions. For instance, a buyer may pay relatively high CPMs for inventory between particular hours of the day for inventory associated with a particular geographic region, but pay relatively low CPMs for inventory at other times of the day or associated with other geographic regions. Such patterns may be revealed through a periodic analysis of data in the records.

In one embodiment, where the exchange compiles a prioritized list of buyers to contact for purchase of inventory, the records may be analyzed based on geographic region and every four hours in order to establish which buyer(s) to contact first with inventory passed through an auction component. Of course, such an embodiment is only exemplary and any other suitable algorithm for determining the most desirable purchaser of inventory may be used.

In FIG. 17, database 1820 is contained within waterfall component 1800 and the exchange may maintain and update its own records regarding past transaction data. For example, tables 1910, 1940 may be updated or supplemented with data collected from one or more components such as those depicted in FIGS. 4 and 5 (e.g., a filtering component, a data management component, an auction component, and a viewability component). In other embodiments, however, database 1820 may be maintained and updated by a third party. In still further embodiments, the exchange may grant one or more DSPs or other potential buyers of inventory access to records 1910, 1940 to facilitate buyers' determinations as to whether to purchase specific inventory. Such access may be provided free of charge or buyers may pay for a subscription to database 1820.

FIG. 18 depicts an exemplary embodiment of a method for selling inventory through a waterfall component. In one aspect, at step 2010, inventory that fails to receive a bid from potential buyers (e.g., DSPs, advertisers, etc.) within an auction component or, alternatively, receives no satisfactory bids above a predetermined floor price, may be passed to a waterfall component such as waterfall component 1800 described above.

At step 2020, upon receipt of information pertaining to specific inventory, waterfall component 1800 may analyze data contained in database 1820 in order to determine the most desirable potential buyer of the inventory, i.e., the buyer most likely to purchase the inventory at the highest price. In other embodiments, data contained in database 1820 may be analyzed to compile a prioritized list of potential buyers. As previously discussed, database 1820 may contain various information pertaining to past transactions and past purchase behavior exhibited by buyers in communication with the exchange.

Once the most desirable potential buyer of the inventory is identified, an ad request may be generated and transmitted to the potential buyer at step 2030. In one aspect, the ad request may comprise an offer price for the associated inventory. The offer price may be based, at least in part, on information contained and/or analyzed within database 1820. For example, the offer price may be based, at least in part, on price(s) the buyer has paid in the past for similar inventory and/or under similar circumstances (e.g., in a similar geographic region, at a similar time of day, and/or the same day of the week).

At step 2040, the recipient of the ad request (i.e., the first waterfall recipient) may decide to either purchase the inventory or reject the offer. Where the first waterfall recipient decides to purchase the inventory, the exchange may receive a confirmation message comprising a link to an advertisement desired to be displayed at the location of the inventory. On the other hand, where the first waterfall recipient rejects the inventory offer, the exchange may receive a pass-back or rejection message from the recipient.

In instances where the first waterfall recipient rejects the offer, the most desirable remaining buyer of the inventory may be determined at step 2020. Alternatively, at step 2020, where a prioritized list of potential buyers has been compiled, the identity of the next most desirable buyer, in light of the first recipient's rejection, may be determined. Steps 2020, 2030 and 2040 may then be repeated or looped until an offer is accepted by a buyer.

At step 2050, once a buyer of the unsold inventory is found and a link to the advertisement desired to be displayed is received at the exchange, a message comprising a link to the advertisement to be displayed at the location of the inventory may be transmitted to the SSP or publisher supplying the inventory. Alternatively, where an SSP or publisher is conducting its own auction for the inventory, the exchange may transmit the link and a bid for the inventory based, at least in part, on the price agreed to by the exchange's buyer of the inventory. Where the bid is selected as the winning bid, the SSP or publisher may then transmit a confirmation message back to the exchange. Where the bid is not selected as the winning bid, the SSP or publisher may transmit a losing bid message to the exchange. The exchange may then generate and/or transmit a message to the buyer of the inventory indicative of a completed transaction or an unsuccessful bid.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An exchange system for selling advertising space, the exchange system including:
a first server in communication with a first database, wherein the first server performs first stages including:
receiving a first request to bid on a first ad space for placement within content on a first user device, the request including a user characteristic;
determining that the user characteristic is not associated with a user identifier in the first database;
facilitating placement of an advertisement on the first user device;
receiving additional information about the first user device; and
creating a record in the first database that stores a user identity association with the user characteristic and the additional information;
a second server remote from the first server and in communication with a second database that is remote from the first database, wherein the second database receives the record from the first database, wherein the second server performs second stages including:
receiving a second request to bid on a second ad space for placement within second content on the first user device, wherein the second request includes the user characteristic;
receiving the user identity from the second database;
holding a real-time auction to sell the ad space in which the user identity to a first demand-side entity; and
determining to self-bid in the real-time auction based at least in part on the additional information associated with the user identity.

2. The exchange system of claim 1, wherein the second stages include supplying a second user identity to a second demand-side entity, wherein the database correlates the first and second user identities to the user device.

3. The exchange system of claim 1, wherein the determination to self-bid is further based at least in part on the plurality of demand-side entities not recognizing the user identity.

4. The exchange system of claim 1, wherein the second stages further include:
receiving an indication that the self-bid won the rights to the second ad space;
placing a self-monitoring ad tag on the first user device, the self-monitoring ad tag containing code that causes the user's computing device to contact the second server when an amount of the second ad space is in view;
programmatically reselling the ad space as in view; and
facilitating placement of an advertisement at the second ad space.

5. The exchange system of claim 4, wherein the code of the self-monitoring ad tag that is provided to the first user computing device further contains instructions that cause the first user computing device to monitor at least the following, any of which trigger contacting the second server:
whether a portion of the self-monitoring ad tag location is in view;
whether a time threshold has been exceeded; and
whether user activity meets a threshold for reselling the ad space.

6. The exchange system of claim 4, wherein the determination to self-bid is further based on determining the ad space will become in view, which includes checking a value in the second database associated with prior reports of viewability of the location that were sent to the first database.

7. The exchange system of claim 4, wherein the second stages further include sending a timing threshold parameter with the self-monitoring ad tag, wherein the timing threshold parameter is selected at least in part based on the user identity stored in the second database.

8. A computer-implemented method for causing a computing device to locally monitor whether to resell ad space, the method including steps comprising:
automatically purchasing, via a processor, ad space being programmatically sold by a supply-side entity for placement within first content on a first computing device, wherein the purchasing is based on the processor analyzing information in a first database that is remote from a second database, and wherein the information is based at least in part on a first report received at the second database regarding second content on the second computing device; and
causing, via the processor, the ad space to be filled with a self-monitoring ad tag for execution by the first computing device, wherein the self-monitoring ad tag contains code that causes the first computing device to perform stages comprising:
determining whether an elapsed time amount since the computing device began executing the self-monitoring ad tag exceeds a threshold;
determining whether a portion of the self-monitoring ad tag is located at a position that is in view on a display of the computing device; and
placing an ad call to a server specified in the code based on at least one of the determinations; and
facilitating placement of an advertisement at the computing device based on the ad call.

9. The computer-implemented method of claim 8, the method including further steps comprising locating, in the first database, at least one record representing an aggregation of past data for a user ID related to the first computing device, including past data stored in the second database.

10. The computer-implemented method of claim 8, the method including selecting, via the processor, a timing threshold parameter to provide with the self-monitoring ad tag to be provided to the computing device from amongst a plurality of timing parameters.

11. The computer-implemented method of claim 8, wherein the self-monitoring ad tag further causes the first computing device to send a second report to the second database that indicates whether the location of the self-monitoring ad tag is in view.

12. The computer-implemented method of claim 8, wherein the self-monitoring ad tag further includes a first embedded tag that reports to whichever one of the first and second databases is in communication with the server that issued the self-monitoring ad tag.

13. The computer-implemented method of claim 8, wherein facilitating placement of the advertisement includes selecting a second code from a plurality of options for third party data verification based on the advertising entity purchasing the ad space and providing the second code with the advertisement.

14. A non-transitory computer-readable medium containing instructions that, when executed by a processor, cause the processor to perform steps including:
receiving a first bid request for ad space associated with an ad space identifier stored in a first database that is in communication with a second database;
responding with a first self-bid based on a decision in the first database based at least in part on information about a user originally received at the second database;
facilitating placement of a self-monitoring ad tag at a location of the ad space within content being distributed to the remote computing device, wherein the self-monitoring ad tag comprises code that causes the remote computing device to monitor the position of the location relative to viewable screen space; and
receiving information from the remote computing device indicating whether the location is within the viewable screen space;
receiving a second bid request for the ad space associated with the ad space identifier and the user; and
placing a second self-bid on the ad space based at least in part on the first determination that the location is in view and second determination that the user of the computing device is a human being.

15. The system of claim 14, wherein, in response to receiving the first bid request, the processor further performs a real-time bidding auction for the ad space in which further steps are executed, including:
soliciting bids from demand-side entities;
determining an amount that the system will self-bid;
ending the real-time bidding auction after a predetermined amount of time; and
determining no bids in the real-time bidding auction are greater than the determined self-bid amount, and communicating the self-bid as the bid made by the processor for the ad space.

16. The system of claim 14, wherein the processor selects the amount of its self-bid to be equal to or lower than a default price for the ad space in a waterfall process that is executed by the processor.

17. The system of claim 14, wherein the first self-bid is less than the second self-bid.

18. The system of claim 14, wherein the second bid request includes information that allows the processor to identify a user id associated with the user within the database, and wherein the processor determines to place second self-bid based at least in part on one or more records in the database reflecting past history associated with the user id.

19. The system of claim 18, wherein facilitating access to the self-monitoring ad tag includes supplying a subtag that remains in place after the advertisement is placed, the subtag reporting the user id and indicating whether the advertisement is viewable.

20. The system of claim 14, wherein facilitating access to the self-monitoring ad tag includes supplying a time parameter representing a threshold amount of time that the self-monitoring ad tag will execute before placing an ad call.
